(19) United States
(12) Patent Application Publication
(10) Pub. No.: US 2025/0184677 A1
(43) Pub. Date: Jun. 5, 2025

(54) VARIED MAGNETIC RETENTION OF MEDICAL DEVICES

(71) Applicant: Cochlear Limited, Macquarie University (AU)

(72) Inventors: Johan GUSTAFSSON, Mölnlycke (SE); Oliver RIDLER, Cherrybrook (AU)

(21) Appl. No.: 19/042,434

(22) Filed: Jan. 31, 2025

Related U.S. Application Data
(63) Continuation-in-part of application No. 18/072,883, filed on Dec. 1, 2022, now abandoned.
Application No. 18/072,883 is a continuation of application No. 15/368,382, filed on Dec. 2, 2016, now Pat. No. 11,595,768.

(51) Int. Cl. H04R 25/00; H01F 7/02

(52) U.S. Cl. CPC H04R 25/606; H01F 7/0252; H04R 25/554; H04R 2225/021; H04R 2460/13

(57) ABSTRACT

An external component of a prosthesis, including a first module including a functional component and first structure including magnetic material. The first module is configured to be retained against skin via a magnetic field at least partially generated by a magnet implanted in a recipient that interacts with the magnetic material of the first structure, the first module including a skin interfacing surface configured to interact with skin of the recipient when the first module is retained against the skin of the recipient, a second module including a second structure including magnetic material configured to enhance magnetic retention of the external component to skin of a recipient, wherein the second module is removably attached to the first module and visible from an outside of the external component when the second module is attached to the first module and when viewed from a side opposite the skin interfacing side.

### CROSS-REFERENCE TO RELATED APPLICATIONS

This application is a Continuation-in-part of U.S. patent application Ser. No. 18/072,883, filed Dec. 1, 2022, which is a Continuation of U.S. patent application Ser. No. 15/368,382, filed Dec. 2, 2016, entitled RETENTION FORCE INCREASING COMPONENTS, naming Johan GUSTAFSSON as an inventor, the entire contents of each application being incorporated herein by reference in their entirety.

### BACKGROUND

Hearing loss, which may be due to many different causes, is generally of two types: conductive and sensorineural. Sensorineural hearing loss is due to the absence or destruction of the hair cells in the cochlea that transduce sound signals into nerve impulses. Various hearing prostheses are commercially available to provide individuals suffering from sensorineural hearing loss with the ability to perceive sound. For example, cochlear implants use an electrode array implanted in the cochlea of a recipient to bypass the mechanisms of the ear. More specifically, an electrical stimulus is provided via the electrode array to the auditory nerve, thereby causing a hearing percept.

Conductive hearing loss occurs when the normal mechanical pathways that provide sound to hair cells in the cochlea are impeded, for example, by damage to the ossicular chain or the ear canal. Individuals suffering from conductive hearing loss may retain some form of residual hearing because the hair cells in the cochlea may remain undamaged.

Individuals suffering from conductive hearing loss typically receive an acoustic hearing aid. Hearing aids rely on principles of air conduction to transmit acoustic signals to the cochlea. In particular, a hearing aid typically uses an arrangement positioned in the recipient's ear canal or on the outer ear to amplify a sound received by the outer ear of the recipient. This amplified sound reaches the cochlea causing motion of the perilymph and stimulation of the auditory nerve.

In contrast to hearing aids, which rely primarily on the principles of air conduction, certain types of hearing prostheses commonly referred to as bone conduction devices, convert a received sound into vibrations. The vibrations are transferred through the skull to the cochlea causing generation of nerve impulses, which result in the perception of the received sound. Bone conduction devices are suitable to treat a variety of types of hearing loss and may be suitable for individuals who cannot derive sufficient benefit from acoustic hearing aids, cochlear implants, etc., or for individuals who suffer from stuttering problems. Conversely, cochlear implants can have utilitarian value with respect to recipients where all of the inner hair inside the cochlea has been damaged or otherwise destroyed. Electrical impulses are provided to electrodes located inside the cochlea, which stimulate nerves of the recipient so as to evoke a hearing percept.

### SUMMARY

In accordance with one aspect, there is an external component of a prosthesis, comprising a first module including a functional component and first structure including magnetic material, wherein the first module is configured to be retained against skin of a recipient via a magnetic field at least partially generated by a permanent magnet implanted in a recipient that interacts with the magnetic material of the first structure, the first module including a skin interfacing surface configured to interact with skin of the recipient when the first module is retained against the skin of the recipient; and a second module including a second structure including magnetic material configured to enhance magnetic retention of the external component to skin of a recipient, wherein the second module is removably attached to the first module and visible from an outside of the external component when the second module is attached to the first module and when viewed from a side opposite the skin interfacing side.

In another exemplary embodiment, there is a button sound processor, comprising a first component including a first permanent magnet; and a second component including soft magnetic material, wherein the second component is configured to direct a magnetic flux at least partially generated by the first permanent magnet differently from that which would exist in the absence of the second component via the soft magnetic material.

In accordance with another aspect, there is a method, comprising: obtaining a first portion of a headpiece for a prosthesis, the first portion including electronic components of the prosthesis and a first permanent magnet; obtaining a second portion of the headpiece, the second portion including a magnetic material; attaching the second portion to the first portion; and attaching the combined first and second portions to a recipient having implanted therein a second permanent magnet such that the first portion and the second portion are magnetically retained to the skin of the recipient via interaction with the magnetic field generated by the second permanent magnet and component(s) of the headpiece, wherein the magnetic material alters the magnetic flux established by the second permanent magnet such that the magnetic flux is widened about a longitudinal axis between the second permanent magnet and the first portion relative to that which would be the case in the absence of the second portion.

In accordance with another aspect, there is a body piece configured for transcutaneous communication with an implanted component implanted in a recipient, comprising: an inductance coil; a first permanent magnet; and a second permanent magnet, wherein the first permanent magnet has a north-south polarity that is parallel to a longitudinal axis of the body piece, the second permanent magnet has a north-south polarity at an oblique angle relative to the north-south polarity of the first permanent magnet, and the body piece is configured such that the second permanent magnet is readily removably connected at least indirectly to the first permanent magnet.

### BRIEF DESCRIPTION OF THE DRAWINGS

Some embodiments are described below with reference to the attached drawings, in which:

FIG. 1 is a perspective view of an exemplary bone conduction device in which at least some embodiments can be implemented;

FIG. 2 is a perspective view of an exemplary cochlear implant in which at least some embodiments can be implemented;

FIG. 3 is a schematic diagram conceptually illustrating a passive transcutaneous bone conduction device;

FIG. 4 is a schematic diagram conceptually illustrating an active transcutaneous bone conduction device in accordance with at least some exemplary embodiments;

FIG. 5 is a schematic diagram conceptually illustrating another exemplary prosthesis to with the teachings herein are applicable in some embodiments;

FIG. 6 is a schematic diagram of a cross-section of an exemplary external component according to an exemplary embodiment;

FIG. 7 is a schematic diagram of a cross-section of another exemplary external component according to an exemplary embodiment;

FIG. 8 is a schematic diagram of a cross-section of another exemplary external component according to an exemplary embodiment;

FIGS. 9, 10 and 11 are schematic diagrams showing exemplary magnet(s) according to an exemplary embodiment;

FIG. 12 is a schematic diagram of a cross-section of an exemplary external assembly according to the exemplary embodiment of FIG. 6, with the addition of a module that increases magnetic retention force;

FIG. 13 is a schematic diagram of a cross-section of another exemplary external assembly;

FIG. 14 is a cross-sectional view of the module of FIG. 12;

FIG. 15 is a top view of a compilation of magnets according to an embodiment;

FIG. 16 depicts by way of conceptual illustration a magnetic flux that results from the utilization of the module of FIG. 12;

FIG. 17 and FIG. 18 depict top views of compilations of magnets according to an embodiment;

FIG. 19 depicts another exemplary embodiment of another module when utilized with the external component of FIG. 6;

FIGS. 20 and 21 and 22 and 23 and 24 depict yet other exemplary embodiments of other modules that are usable with at least some external components detailed herein by way of example;

FIGS. 25 and 28 and 29 and 30 and 34 show an exemplary magnet compilation with some componentry according to an exemplary embodiment;

FIGS. 26 and 27 provide exemplary magnet compilations with dimensional features according to an exemplary embodiments;

FIGS. 31 and 40 are top views depicting exemplary embodiments of alternate embodiments of modules that can be utilized with some external components according to some exemplary embodiments;

FIGS. 32 and 33 and 39 show exemplary magnetic field paths for some exemplary embodiment;

FIG. 35 shows an isometric view of a magnet compilation according to an exemplary embodiment;

FIGS. 36, 37 and 38 show some exemplary removable modules according to an exemplary embodiment;

FIG. 41 depicts a schematic of another exemplary module utilized with the external component of FIG. 6;

FIG. 42 depicts a cross-sectional view of the module depicted in FIG. 41;

FIG. 43 depicts by way of conceptual illustration and magnetic field that results from utilization of the module of FIG. 42;

FIG. 44 depicts a variation of the module of FIG. 41;

FIGS. 45, 46 and 47 depict alternate embodiments of respective modules having utilitarian value according to some embodiments;

FIGS. 48 and 49 and 56 present various features additional exemplary embodiments;

FIG. 50 and FIG. 51 and FIG. 52 and FIG. 53 show cross-sections of other exemplary embodiments;

FIGS. 54 and 55 present figures showing exemplary magnetic field patterns;

FIGS. 57-59 depict alternate concepts of utilizing an additional magnet to increase retention force, along with another exemplary embodiment of an external component that is different from that of FIG. 5 but which utilizes at least some of the same principles;

FIG. 60 depicts another exemplary embodiment that utilizes a component added to the external component of FIG. 6 to increase the retention force;

FIG. 61 depicts a cross-sectional view of the component of FIG. 60 that is added to the component of FIG. 6 to increase the retention force;

FIG. 62 depicts another exemplary embodiment that utilizes a structure that covers the interior of the removable component, which structure also increases the retention force;

FIG. 63 depicts a variation of the concept of FIG. 62;

FIG. 64 depicts another exemplary embodiment of a module that can be added to the external component of FIG. 6, along with a modified version of the external component of FIG. 6;

FIG. 65 depicts a flowchart for an exemplary method according to an exemplary embodiment;

FIG. 66 depicts an exemplary magnetic flux flow according to an exemplary embodiment;

FIG. 67 depicts another exemplary flowchart for an exemplary method according to an exemplary embodiment; and

FIG. 68 depicts yet another exemplary flowchart for an exemplary method according to an exemplary embodiment.

### DETAILED DESCRIPTION

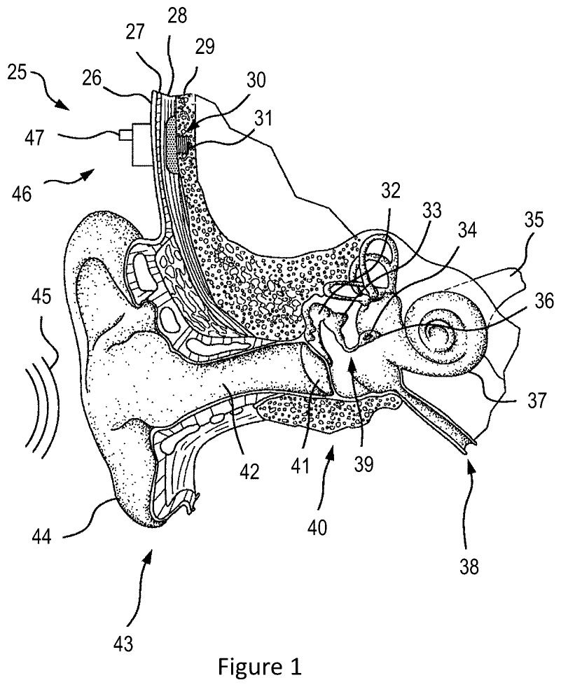

Embodiments herein are described primarily in terms of a bone conduction device, such as an active transcutaneous bone conduction device. However, it is noted that the teachings detailed herein and/or variations thereof are also applicable to a cochlear implant and/or a middle ear implant. Accordingly, any disclosure herein of teachings utilized with a bone conduction device also corresponds to a disclosure of utilizing those teachings with respect to a cochlear implant and utilizing those teachings with respect to a middle ear implant. Moreover, at least some exemplary embodiments of the teachings detailed herein are also applicable to an active and/or a passive transcutaneous bone conduction device. It is further noted that the teachings detailed herein can be applicable to other types of prostheses, such as by way of example only and not by way of limitation, a retinal implant. Indeed, the teachings detailed herein can be applicable to any component that is held against the body that utilizes an RF coil and/or an inductance coil or any type of communicative coil to communicate with a component implanted in the body. That said, the teachings detailed herein will be directed by way of example only and not by way of limitation towards a component that is held against the head of a recipient for purposes of the establishment of an external component of the hearing prosthesis. In view of this, FIG. 1 is a perspective view of a bone conduction device 25 in which embodiments may be implemented. As shown, the recipient has an outer ear 43, a middle ear 40, and an inner ear 37. Elements of outer ear 43, middle ear 40, and inner ear 37 are described below, followed by a description of bone conduction device 25.

Still, it is noted that in at least some exemplary embodiments, element 25 is instead a cochlear implant, where the RF inductance coil of the external component communicates with an RF inductance coil of the implanted component, which implanted RF inductance coil is in signal communication with a receiver/stimulator of a cochlear implant, which receiver/stimulator receives signals from the RF inductance coil and converts those signals into electrical signals applied to electrodes implanted in the cochlea to evoke a hearing percept via electrical stimulation. Note also that in at least some exemplary embodiments, element 25 is instead a so-called middle ear implant, where the RF inductance coil of the external component communicates with an RF inductance of the implanted component, which RF inductance coil is in signal communication with the receiver/stimulator of a middle ear implant. The receiver/stimulator receives signals from the RF inductance coil and converts those signals into electrical signals that are applied to an actuator to cause the actuator to actuate, and thus evoke a hearing percept via mechanical stimulation of components of the auditory system.

In a fully functional human hearing anatomy, outer ear 43 comprises an auricle 44 and an ear canal 42. A sound wave or acoustic pressure 45 is collected by auricle 44 and channeled into and through ear canal 42. Disposed across the distal end of ear canal 42 is a tympanic membrane 41 which vibrates in response to acoustic wave 45. This vibration is coupled to oval window or fenestra ovalis 36 through three bones of middle ear 40, collectively referred to as the ossicles 39 and comprising the malleus 32, the incus 33, and the stapes 34. The ossicles 39 of middle ear 40 serve to filter and amplify acoustic wave 45, causing oval window 36 to vibrate. Such vibration sets up waves of fluid motion within cochlea 37. Such fluid motion, in turn, activates hair cells (not shown) that line the inside of cochlea 37. Activation of the hair cells causes appropriate nerve impulses to be transferred through the spiral ganglion cells and auditory nerve 35 to the brain (not shown), where they are perceived as sound.

FIG. 1 also illustrates the positioning of bone conduction device 25 relative to outer ear 43, middle ear 40 and inner ear 37 of a recipient of device 25. Bone conduction device 25 comprises an external component 46 and implantable component 30. As shown, bone conduction device 25 is positioned behind outer ear 43 of the recipient and comprises a sound input element 47 to receive sound signals. Sound input element 47 may comprise, for example, a microphone. In an exemplary embodiment, sound input element 47 may be located, for example, on or in bone conduction device 25, or on a cable extending from bone conduction device 25.

More particularly, sound input device 47 (e.g., a microphone) converts received sound signals into electrical signals. These electrical signals are processed by the sound processor. The sound processor generates control signals which cause the actuator to vibrate. In other words, the actuator converts the electrical signals into mechanical motion to impart vibrations to the recipient's skull.

Alternatively, sound input element 47 may be subcutaneously implanted in the recipient, or positioned in the recipient's ear. Sound input element 47 may also be a component that receives an electronic signal indicative of sound, such as, for example, from an external audio device. For example, sound input element 47 may receive a sound signal in the form of an electrical signal from an MP3 player electronically connected to sound input element 47.

Bone conduction device 25 comprises a sound processor (not shown), an actuator (also not shown), and/or various other operational components. In operation, the sound processor converts received sounds into electrical signals. These electrical signals are utilized by the sound processor to generate control signals that cause the actuator to vibrate. In other words, the actuator converts the electrical signals into mechanical vibrations for delivery to the recipient's skull.

In accordance with some embodiments, a fixation system 31 may be used to secure implantable component 30 to skull 29. As described below, fixation system 31 may be a bone screw fixed to skull 29, and also attached to implantable component 30.

In one arrangement of FIG. 1, bone conduction device 25 can be a passive transcutaneous bone conduction device. That is, no active components, such as the actuator, are implanted beneath the recipient's skin 26. In such an arrangement, the active actuator is located in external component 46, and implantable component 30 includes a magnetic plate, as will be discussed in greater detail below. The magnetic plate of the implantable component 30 vibrates in response to vibration transmitted through the skin, mechanically and/or via a magnetic field, that is generated by an external magnetic plate.

In another arrangement of FIG. 1, bone conduction device 25 can be an active transcutaneous bone conduction device where at least one active component, such as the actuator, is implanted beneath the recipient's skin 26 and is thus part of the implantable component 30. As described below, in such an arrangement, external component 46 may comprise a sound processor and transmitter, while implantable component 30 may comprise a signal receiver and/or various other electronic circuits/devices.

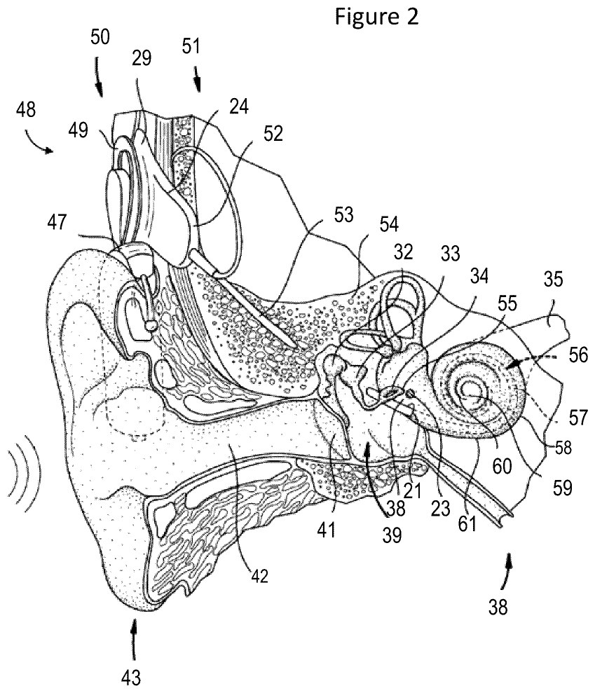

FIG. 2 is a perspective view of a cochlear implant 48, which includes an implantable portion 51, implanted in a recipient, to which some embodiments detailed herein and/or variations thereof are applicable. The cochlear implant implantable portion 51 is part of a cochlear implant 48 that can include external components in some embodiments, as will be detailed below. It is noted that the teachings detailed herein are applicable, in at least some embodiments, to partially implantable and/or totally implantable cochlear implants (i.e., with regard to the latter, such as those having an implanted microphone). It is further noted that the teachings detailed herein are also applicable to other stimulating devices that utilize an electrical current beyond cochlear implants (e.g., auditory brain stimulators, pacemakers, etc.). Additionally, it is noted that the teachings detailed herein are also applicable to other types of hearing prostheses, such as by way of example only and not by way of limitation, bone conduction devices, direct acoustic cochlear stimulators, middle ear implants, etc. Indeed, it is noted that the teachings detailed herein are also applicable to so-called hybrid devices. In an exemplary embodiment, these hybrid devices apply both electrical stimulation and acoustic stimulation to the recipient. Any type of hearing prosthesis to which the teachings detailed herein and/or variations thereof that can have utility can be used in some embodiments of the teachings detailed herein.

In view of the above, it is to be understood that at least some embodiments detailed herein and/or variations thereof are directed towards a body-worn sensory supplement medical device (e.g., the hearing prosthesis of FIG. 2, which supplements the hearing sense, even in instances where all natural hearing capabilities have been lost). It is noted that at least some exemplary embodiments of some sensory supplement medical devices are directed towards devices such as conventional hearing aids, which supplement the hearing sense in instances where some natural hearing capabilities have been retained, and visual prostheses (both those that are applicable to recipients having some natural vision capabilities remaining and to recipients having no natural vision capabilities remaining). Accordingly, the teachings detailed herein are applicable to any type of sensory supplement medical device to which the teachings detailed herein are enabled for use therein in a utilitarian manner. In this regard, the phrase sensory supplement medical device refers to any device that functions to provide sensation to a recipient irrespective of whether the applicable natural sense is only partially impaired or completely impaired.

As shown, cochlear implant implantable portion 51 comprises one or more components which are temporarily or permanently implanted in the recipient. Cochlear implant implantable portion 51 is shown in FIG. 2 with an external device 50, that is part of the implant 48 (along with cochlear implant implantable portion 51), which, as described below, is configured to provide power to the cochlear implant, and where the implanted cochlear implant includes a battery, that is recharged by the power provided from the external device 50.

In the illustrative arrangement of FIG. 2, external device 50 can comprise a power source (not shown) disposed in a Behind-The-Ear (BTE) unit 47. External device 50 also includes components of a transcutaneous energy transfer link, referred to as an external energy transfer assembly. The transcutaneous energy transfer link is used to transfer power and/or data to cochlear implant 51. Various types of energy transfer, such as infrared (IR), electromagnetic, capacitive and inductive transfer, may be used to transfer the power and/or data from external device 50 to cochlear implant implantable portion 51. In the illustrative embodiments of FIG. 2, the external energy transfer assembly comprises an external coil 49 that forms part of an inductive radio frequency (RF) communication link. External coil 49 is typically a wire antenna coil comprised of multiple turns of electrically insulated single-strand or multi-strand platinum or gold wire. External device 50 also includes a magnet (not shown) positioned within the turns of wire of external coil 49. It should be appreciated that the external device shown in FIG. 2 is merely illustrative, and other external devices may be used with embodiments of the present invention.

Cochlear implant implantable portion 51 comprises an internal energy transfer assembly 24 which can be positioned in a recess of the temporal bone adjacent the auricle of the recipient. As detailed below, internal energy transfer assembly 24 is a component of the transcutaneous energy transfer link and receives power and/or data from external device 50. In the illustrative embodiment, the energy transfer link comprises an inductive RF link, and internal energy transfer assembly 24 comprises a primary internal coil assembly 29. Internal coil assembly 29 typically includes a wire antenna coil comprised of multiple turns of electrically insulated single-strand or multi-strand platinum or gold wire, as will be described in greater detail below.

Cochlear implant implantable portion 51 further comprises a main implantable component 52 and an elongate electrode assembly 53. Collectively, the coil assembly 29, the main implantable component 52, and the electrode assembly 53 correspond to the implantable component of the system 48.

In some embodiments, internal energy transfer assembly 24 and main implantable component 52 are hermetically sealed within a biocompatible housing or within the device in general (the housing per se may not be hermetically sealed). In some embodiments, main implantable component 52 includes an implantable microphone assembly (not shown) and a sound processing unit (not shown) to convert the sound signals received by the implantable microphone or via internal energy transfer assembly 24 to data signals. That said, in some alternative embodiments, the implantable microphone assembly can be located in a separate implantable component (e.g., that has its own housing assembly, etc.) that is in signal communication with the main implantable component 52 (e.g., via leads or the like between the separate implantable component and the main implantable component 52). In at least some embodiments, the teachings detailed herein and/or variations thereof can be utilized with any type of implantable microphone arrangement.

Main implantable component 52 further includes a stimulator unit (also not shown in FIG. 2) which generates electrical stimulation signals based on the data signals. The electrical stimulation signals are delivered to the recipient via elongate electrode assembly 118.

Elongate electrode assembly 118 has a proximal end connected to main implantable component 52, and a distal end implanted in cochlea 58. Electrode assembly 118 extends from main implantable component 52 to cochlea 58 through the mastoid bone. In some embodiments electrode assembly 118 may be implanted at least in basal region 61, and sometimes further. For example, electrode assembly 118 may extend towards apical end of cochlea 58, referred to as cochlea apex 59. In certain circumstances, electrode assembly 118 may be inserted into cochlea 58 via a cochleostomy 21. In other circumstances, a cochleostomy may be formed through round window 23, oval window 55, the promontory 38, or through an apical turn 60 of cochlea 58.

Electrode assembly 118 comprises a longitudinally aligned and distally extending array 146 of electrodes 57, disposed along a length thereof. As noted, a stimulator unit generates stimulation signals which are applied by electrodes 57 to cochlea 58, thereby stimulating auditory nerve.

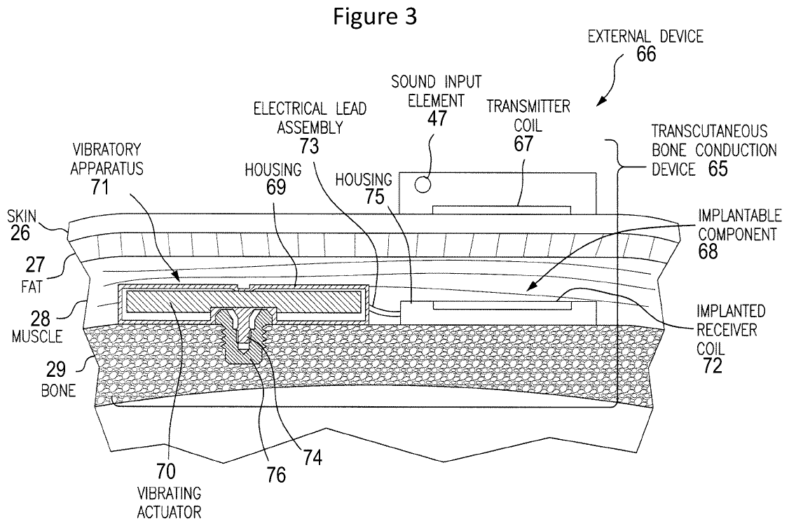

FIG. 3 depicts an exemplary embodiment of a transcutaneous bone conduction device 65 according to another embodiment that includes an external device 66 (corresponding to, for example, element 140B of FIG. 1) and an implantable component 68 (corresponding to, for example, element 30 of FIG. 1). The transcutaneous bone conduction device 65 of FIG. 3 is an active transcutaneous bone conduction device in that the vibrating electromagnetic actuator 70 is located in the implantable component 68. Specifically, a vibratory element in the form of vibrating electromagnetic actuator 70 is located in housing 454 of the implantable component 68 underneath skin 26, fat 27 and muscle 28. In an exemplary embodiment, much like the vibrating electromagnetic actuator 79 described above with respect to transcutaneous bone conduction device 77, the vibrating electromagnetic actuator 70 is a device that converts electrical signals into vibration.

External component 66 includes a sound input element 47 that converts sound into electrical signals. Specifically, the transcutaneous bone conduction device 65 provides these electrical signals to vibrating electromagnetic actuator 70, or to a sound processor (not shown) that processes the electrical signals, and then provides those processed signals to the implantable component 68 through the skin of the recipient via a magnetic inductance link. In this regard, a transmitter coil 67 of the external component 66 transmits these signals to implanted receiver coil 72 located in housing 458 of the implantable component 68. Components (not shown) in the housing 458, such as, for example, a signal generator or an implanted sound processor, then generate electrical signals to be delivered to vibrating electromagnetic actuator 70 via electrical lead assembly 73. The vibrating electromagnetic actuator 70 converts the electrical signals into vibrations.

The vibrating electromagnetic actuator 70 is mechanically coupled to the housing 69. Housing 69 and vibrating electromagnetic actuator 70 collectively form a vibratory apparatus 71. The housing 69 is substantially rigidly attached to bone fixture 76 by screw 74.

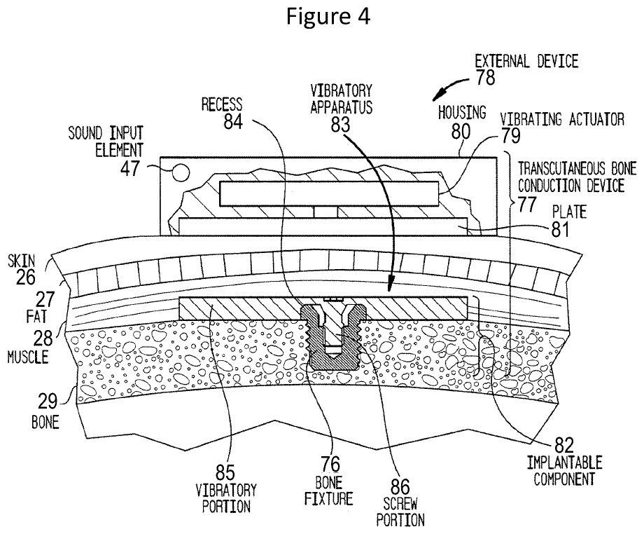

FIG. 4 depicts an exemplary transcutaneous bone conduction device 77 that includes an external device 78 (corresponding to, for example, element 46 of FIG. 1) and an implantable component 82 (corresponding to, for example, element 30 of FIG. 1). The transcutaneous bone conduction device 77 of FIG. 3 is a passive transcutaneous bone conduction device in that a vibrating electromagnetic actuator 79 is located in the external device 78. Vibrating electromagnetic actuator 79 is located in housing 80 of the external component, and is coupled to plate 81. Plate 81 may be in the form of a permanent magnet and/or in another form that generates and/or is reactive to a magnetic field, or otherwise permits the establishment of magnetic attraction between the external device 78 and the implantable component 82 sufficient to hold the external device 78 against the skin of the recipient.

In an exemplary embodiment, the vibrating electromagnetic actuator 79 is a device that converts electrical signals into vibration. In operation, sound input element 47 converts sound into electrical signals. Specifically, the transcutaneous bone conduction device 77 provides these electrical signals to vibrating electromagnetic actuator 79, or to a sound processor (not shown) that processes the electrical signals, and then provides those processed signals to vibrating electromagnetic actuator 79. The vibrating electromagnetic actuator 79 converts the electrical signals (processed or unprocessed) into vibrations. Because vibrating electromagnetic actuator 79 is mechanically coupled to plate 81, the vibrations are transferred from the vibrating electromagnetic actuator 79 to plate 81. Implanted plate assembly 83 is part of the implantable component 82, and is made of a ferromagnetic material that may be in the form of a permanent magnet, that generates and/or is reactive to a magnetic field, or otherwise permits the establishment of a magnetic attraction between the external device 78 and the implantable component 82 sufficient to hold the external device 78 against the skin of the recipient. Accordingly, vibrations produced by the vibrating electromagnetic actuator 79 of the external device 78 are transferred from plate 81 across the skin to plate 85 (vibratory portion) of plate assembly 83 (vibratory apparatus). This can be accomplished as a result of mechanical conduction of the vibrations through the skin, resulting from the external device 78 being in direct contact with the skin and/or from the magnetic field between the two plates. These vibrations are transferred without penetrating the skin with a solid object, such as an abutment, with respect to a percutaneous bone conduction device.

As may be seen, the implanted plate assembly 83 is substantially rigidly attached to a bone fixture 76 in this embodiment. Plate screw 86 is used to secure plate assembly 83 to bone fixture 76, which has a recess 354 to accept a top of the bone fixture 76. The portions of plate screw 86 that interface with the bone fixture 76 substantially correspond to an abutment screw discussed in some additional detail below, thus permitting plate screw 86 to readily fit into an existing bone fixture used in a percutaneous bone conduction device. In an exemplary embodiment, plate screw 86 is configured so that the same tools and procedures that are used to install and/or remove an abutment screw (described below) from bone fixture 76 can be used to install and/or remove plate screw 86 from the bone fixture 76 (and thus the plate assembly 83).

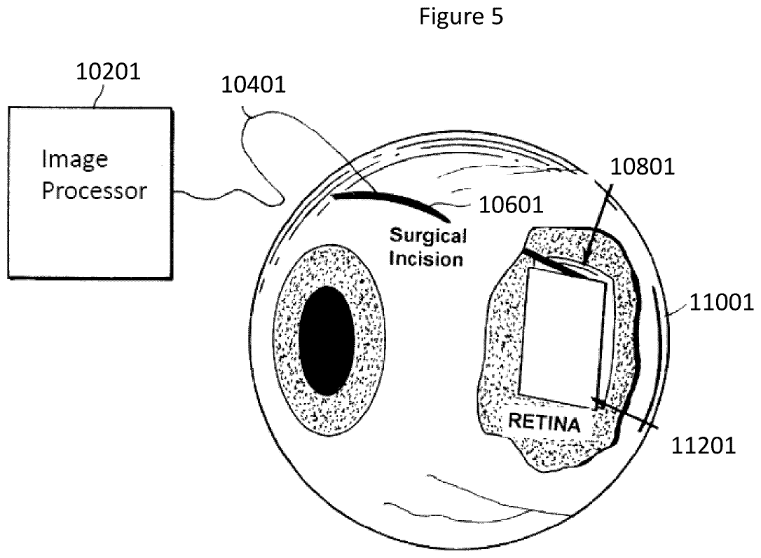

FIG. 5 presents an exemplary embodiment of a neural prosthesis in general, and a retinal prosthesis and an environment of use thereof, in particular, the components of which can be used in whole or in part, with some of the teachings herein. In some embodiments of a retinal prosthesis, a retinal prosthesis sensor-stimulator 10801 is positioned proximate the retina 11001. In an exemplary embodiment, photons entering the eye are absorbed by a microelectronic array of the sensor-stimulator 10801 that is hybridized to a glass piece 11201 containing, for example, an embedded array of microwires. The glass can have a curved surface that conforms to the inner radius of the retina. The sensor-stimulator 10801 can include a microelectronic imaging device that can be made of thin silicone containing integrated circuitry that convert the incident photons to an electronic charge.

An image processor 10201 is in signal communication with the sensor-stimulator 10801 via cable 10401 which extends through surgical incision 00601 through the eye wall (although in other embodiments, the image processor 10201 is in wireless communication with the sensor-stimulator 10801). The image processor 10201 processes the input into the sensor-stimulator 10801 and provides control signals back to the sensor-stimulator 10801 so the device can provide processed output to the optic nerve. That said, in an alternate embodiment, the processing is executed by a component proximate with or integrated with the sensor-stimulator 10801. The electric charge resulting from the conversion of the incident photons is converted to a proportional amount of electronic current which is input to a nearby retinal cell layer. The cells fire and a signal is sent to the optic nerve, thus inducing a sight perception.

The retinal prosthesis can include an external device disposed in a Behind-The-Ear (BTE) unit or in a pair of eyeglasses, or any other type of component that can have utilitarian value. The retinal prosthesis can include an external light/image capture device (e.g., located in/on a BTE device or a pair of glasses, etc.), while, as noted above, in some embodiments, the sensor-stimulator 10801 captures light/images, which sensor-stimulator is implanted in the recipient.

In the interests of compact disclosure, any disclosure herein of a microphone or sound capture device corresponds to an analogous disclosure of a light/image capture device, such as a charge-coupled device. Corollary to this is that any disclosure herein of a stimulator unit which generates electrical stimulation signals or otherwise imparts energy to tissue to evoke a hearing percept corresponds to an analogous disclosure of a stimulator device for a retinal prosthesis. Any disclosure herein of a sound processor or processing of captured sounds or the like corresponds to an analogous disclosure of a light processor/image processor that has analogous functionality for a retinal prosthesis, and the processing of captured images in an analogous manner. Indeed, any disclosure herein of a device for a hearing prosthesis corresponds to a disclosure of a device for a retinal prosthesis having analogous functionality for a retinal prosthesis. Any disclosure herein of fitting a hearing prosthesis corresponds to a disclosure of fitting a retinal prosthesis using analogous actions. Any disclosure herein of a method of using or operating or otherwise working with a hearing prosthesis herein corresponds to a disclosure of using or operating or otherwise working with a retinal prosthesis in an analogous manner.

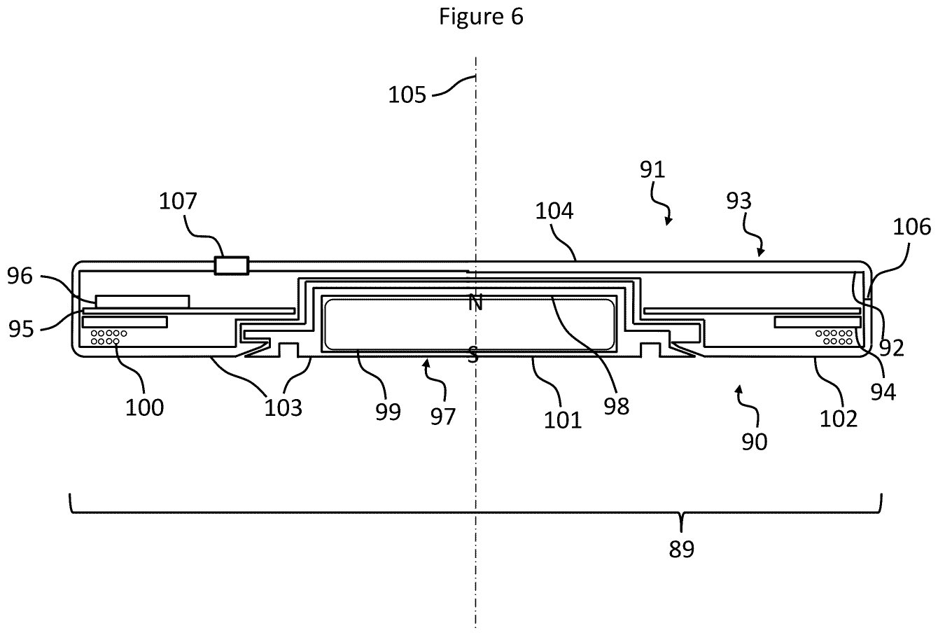

FIG. 6 depicts a cross-sectional view of an exemplary external component 89 corresponding to a device that can be used as external component 66 in the embodiment of FIG. 3 (or FIG. 2 in other embodiments). In an exemplary embodiment, external component 89 has all of the functionalities detailed above with respect to external component 66 or external component 50.

External component 89 comprises a first sub-component 93 and a second sub-component 97. It is briefly noted that back lines have been eliminated in some cases for purposes of ease of illustration (e.g., such as the line between sub-component 93 and sub-component 97-note that FIGS. 6 and 7 and 8 respectively depict these sub-components in isolation relative to the other component). It is further noted that unless otherwise stated, the components of FIG. 6 are rotationally symmetric about axis 105, although in other embodiments, such is not necessarily the case.

In an exemplary embodiment, external component 89 is a so-called button sound processor or off-the-ear (OTE) device/sound processor as detailed above. In this regard, in the exemplary embodiment of FIG. 6, the external component 89 includes a sound capture apparatus 107 (depicted located on the top of component 89, but in other embodiments, can be located on the side—in other embodiments, there is no sound capture apparatus button sound processor-instead, the sound capture apparatus is located remotely from the sound processor), which can correspond to the sound capture apparatuses 47 detailed above, and also includes a sound processor apparatus 96 which is in signal communication with, or located on or otherwise integrated into a printed circuit board 95. Further as can be seen in FIG. 6, an electromagnetic radiation interference shield 94 is interposed between the coil 100 and the PCB 94 and/or the sound processor 96. In an exemplary embodiment, the shield 94 is a ferrite shield. These components are housed in or otherwise supported by sub-component 93. Sub-component 93 further houses or otherwise supports RF coil 100. Coil 100 can correspond to the coil 67 detailed above. In an exemplary embodiment, sound captured by the sound capture apparatus 107 is provided to the sound processor 96, which converts the sound into a processed signal which is provided to the RF coil 100. In an exemplary embodiment, the RF coil 100 is an inductance coil. The inductance coil is energized by the signal provided from the processor 96. The energized coil produces an electromagnetic field that is received by an implanted coil in the implantable component 68, which is utilized by the implanted component 68 as a basis to evoke a hearing percept as detailed above.

The external component 89 further includes a magnet 99 which is housed in sub-component 97. Sub-component 97 is removably replaceable to/from sub-component 93. In the exemplary embodiment of FIG. 6 when utilized in conjunction with the embodiment of FIG. 3 (or FIG. 2), the magnet 99 forms a transcutaneous magnetic link with a ferromagnetic material implanted in the recipient (such as a magnet that is part of the implantable component 68, etc.). This transcutaneous magnetic link holds the external component 89 against the skin of the recipient. In this regard, the external component 89 includes a skin interface side 90, which skin interface side is configured to interface with skin of a recipient, and an opposite side 91 that is opposite the skin interface side 90. That is, when the external component 89 is held against the skin of the recipient via the magnetic link, such as when the external component 89 is held against the skin overlying the mastoid bone where the implantable component is located in or otherwise attached to the mastoid bone, side 91 is what a viewer who is looking at the recipient wearing the external component 89 can see (i.e., in a scenario where the external component 89 is held against the skin over the mastoid bone, and a viewer is looking at the side of the recipient's head, side 91 would be what the viewer sees of the external component 89).

Still with reference to FIG. 6, skin interface side 90 includes skin interface surfaces 101 and 102. Skin interface surface 101 corresponds to the bottom most surface of sub-component 97, and skin interface surface 102 corresponds to the bottom most surface of sub-component 93. Collectively, these surfaces establish surface assembly 103. Surface assembly 103 corresponds to the skin interface surfaces of the external component 89. It is briefly noted that in some exemplary embodiments, the arrangement of the external component 89 is such that the sub-component 97 can be placed into the sub-component 93 such that the bottom surface 101 is recessed relative to the bottom surface 102, and thus the surface 101 may not necessarily contact or otherwise interface with the recipient. It is further briefly noted that in some alternate exemplary embodiments, the arrangement of the external component 89 is reversed, where surface 102 does not contact the recipient because surface 101 remains proud of surface 102 after insertion of the sub-component 97 into the sub-component 93.

It is briefly noted that as used herein, the sub-component 93 is utilized as shorthand for the external component 89. That is, external component 89 exists irrespective of whether the sub-component 97 is located in the sub-component 93 or otherwise attached to sub-component 93.

In the embodiment of FIG. 6, the external component 93 is configured such that the sub-component 97, and thus the magnet 99 and the housing containing magnet 99 (housing 98), is installable into the external component 89 (i.e., from sub-component 93) from the skin interface side 90, and thus is installable into the housing 92 at the skin interface side. Also, in some embodiments, the sub-component 97 is removable from the external component 89. Turning sub-component 97 relative to sub-component 93 “locks” sub-component 97 to sub-component 93, and turning the other way “unlocks” sub-component 97 from sub-component 93, thus making the sub-components rotationally lockable to one another. However, it is briefly noted that the turn locking as detailed herein does not correspond to mere thread engagement, such as by way of example how a bolt is threaded onto a nut, or vice versa, because such does not result in locking of the components together. Some additional details of the arrangements utilized to obtain the aforementioned rotational locking are described in greater detail below. However, it is briefly noted that in some alternate embodiments, the sub-components are snap coupled or otherwise snap locked to one another without rotation. By way of example only and not by way of limitation, the housing sub-component containing the magnet can have a detent receptacle located on a side surface, where a male detent of the housing containing the RF coil or the like interfaces with the receptacle so as to lock the sub-components together. Any arrangement that can enable the retention of the sub-components one another can be utilized in at least some exemplary embodiments.

The sub-component 93 comprises a housing 92 that contains the RF coil 100, the sound processor apparatus 96, and, in some embodiments, a battery.

While the embodiment of FIG. 6 depicts the second sub-component 97 as being a separate component from sub-component 93 that is removable therefrom, in an alternate embodiment, sub-component 97 is not removable from sub-component 93. Moreover, in some exemplary embodiments, there is no sub-component 97. Instead, the magnet 99 is located within a housing structure that effectively corresponds to housing 92 where the bottom wall thereof extends from one side of the button sound processor to the other. Some additional details of these embodiments will be described below.

Due to variations in skin flap thickness (the distance between a top surface of the magnet implanted in the recipient and the outer surface of the skin), there can be utilitarian value with respect to varying the strength of the magnetic field generated by the magnet(s) of the external component 89. That is, in an exemplary embodiment, all things being equal, for a greater skin flap thickness, a stronger magnetic field should be generated by the external component to obtain the same or effectively same retention forces between the external component and implantable component. This is because the retention force decreases with increasing skin flap thickness, all things being equal. In at least some exemplary embodiments, the strength of the magnetic field generated by the external component 89 is varied by the use of exchangeable magnet models. For example, the second sub-component 97 could be replaced with a new sub-component 97 that has a stronger magnet 99/the magnet 99 located within the housing 98 of the second sub-component 97 generates a stronger magnetic field. It is noted that in at least some exemplary embodiments, it is the size of the magnet that results in a greater/stronger magnetic field. In at least some exemplary embodiments of these exemplary embodiments, this size is increased by making the magnet thicker (i.e., increasing the height of the magnet in the direction of the longitudinal axis 105). Thus, the height or thickness of the button sound processor is greater than that which would otherwise be the case so as to accommodate the thicker magnet. With respect to the embodiment of FIG. 6, while the magnet depicted in that figure effectively takes up the entire inner volume of the housing 98, this magnet can be considered to be the “strongest” magnet, where a weaker magnet would be not as thick as the magnet depicted in FIG. 6. However, it will be appreciated that so as to permit the first sub-component 93 to receive a second sub-component 97 having a stronger magnet 99 (where strength is increased by increasing the thickness of the magnet) the sub-component 93 must still be configured to receive this thicker magnet, and thus it is the thicker magnet that drives the overall design of the external component 89 in general, and the thickness of the external component in particular. Note also that this is the case with respect to embodiments where the magnet is movable within the external component 89 so as to adjust the resulting magnetic field between the magnet of the external component and the magnet of the implantable component—there still must be a given thickness of the external component to accommodate the movement of the magnet.

In view of the above, it can be understood that adjusting the retention force by managing features associated with the magnet 99 (thickness, position, etc.) drives a thicker (distance along the axis 105) external component than that which would otherwise be the case if a minimum thickness magnet can be utilized/the magnet need not be moved within the external component 89. According to at least some exemplary embodiments detailed herein, a thinner magnet is utilized as magnet 99 and/or the position of magnet 99 along the longitudinal axis 105 is such that the magnet is as close to the skin interfacing surface assembly 103 as possible, thus reducing and/or eliminating the impact of the magnet 99 with respect to driving the thickness of the external component. In an exemplary embodiment, the thickness and the positioning of the magnet is designed to accommodate the typical recipient. In an exemplary embodiment, the thickness and positioning of the magnet is designed to accommodate recipients where statistically lower retention force between the external component and the implantable component is needed to retain the external component to the recipient relative to other recipients. By way of example only and not by way of limitation, if a population of recipients is such that 75% have a skin flap thickness of X to Y and the remaining 25% have a skin flap thickness of Y+Z, the design of the external component vis-à-vis the magnet 99 (size and positioning) could be directed towards achieving utilitarian retention for the 75% of the population that have the skin flap thickness of X to Y, thus resulting in an external component that has a thickness that is less than that which would be the case if the design of the external component vis-à-vis the internal magnet 99 was to accommodate those of the 75 percentile and those of the remaining 25 percentile.

Note also that this concept can be extended to situations where a given percentile of a population almost never experiences accelerations above a certain level, and the remaining population sometimes experiences accelerations above a certain level. The design of the external component can be directed towards meeting the requirements of the former, thus reducing the thickness of the external component 89.

Still, such an embodiment (where the design is directed towards the population requiring a less-strong magnetic field generated by the internal magnet of the external component 89) can result in a situation where the retention force between the external component and implantable component is not as utilitarian as that which otherwise could be the case for a given population (e.g., the population having the skin flap thickness of Y+Z). Accordingly, there is utilitarian value with respect to being able to increasing the strength of the magnetic field used to hold the external component to the skin of the recipient for the “greater retention force need” populations.

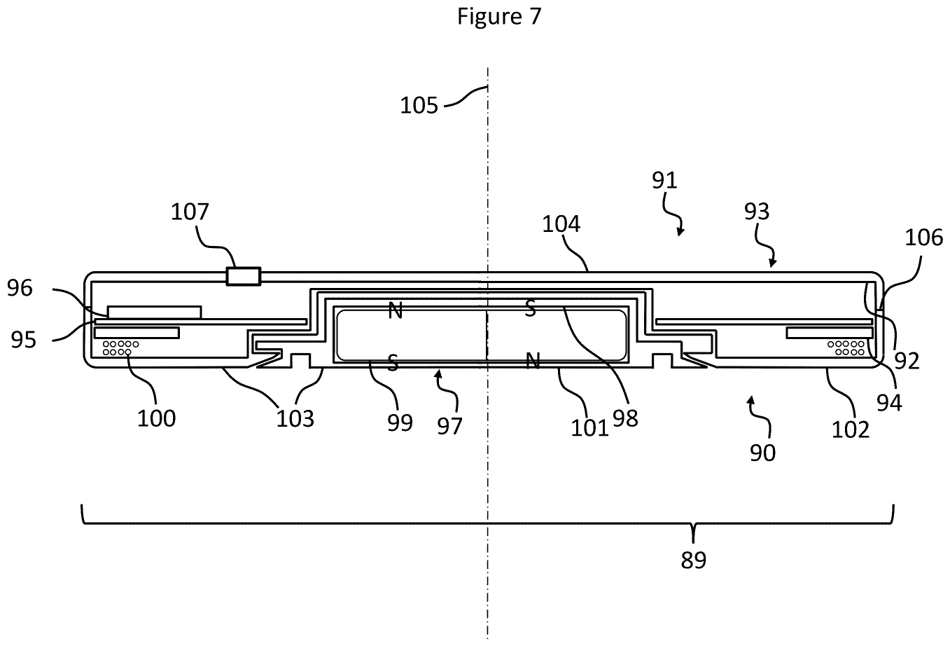

FIG. 7 shows another embodiment, where magnet 99 is a 4 pole magnet (as opposed to the magnet of FIG. 6, which is a two pole magnet). In this embodiment, the 4 pole magnet has two half circle magnet portions that are magnetized with two poles each. Here, the like poles of the portions are opposite one another (the portion on the left side has a north pole on the top and south pole on the bottom, and the portion on the right side has the reverse). In an embodiment, the two portions are separate components and are adhesively bonded to each other (or not—the case can be used to have the components held against each other) while in other embodiments the magnet is a monolithic body that is magnetized to have the 4 pole arrangement.

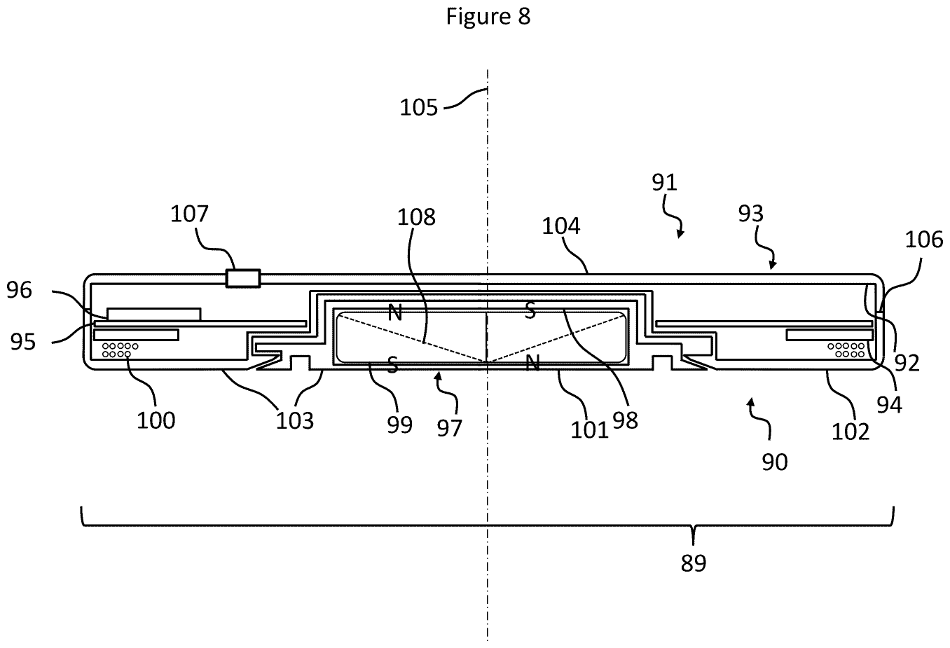

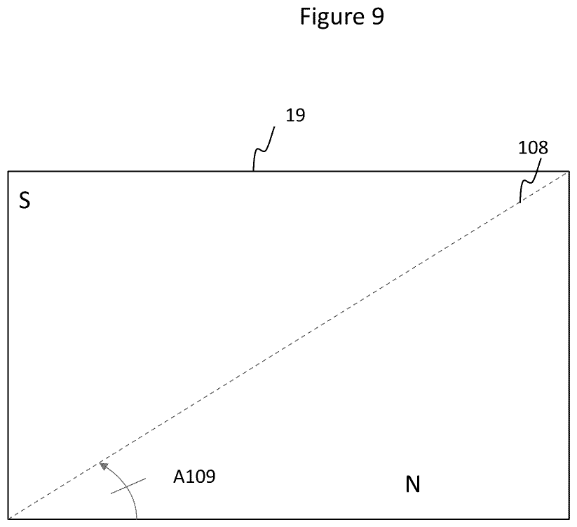

FIG. 8 shows another embodiment where the magnet 99 is a 4 pole magnet, except here, the poles are angled relative to the longitudinal axis 105. Shown in FIG. 8 are the theoretical pole's boundary line 108. This is the hypothetical line that divides the north pole from the south pole; everything on one side of the line is the hypothetical magnetic monopole north, and everything on the opposite side of the line is the hypothetical magnetic monopole south. In an embodiment, as seen, the angle of the theoretical boundary line of one of the magnet components mirrors that of the other magnet components. In this embodiment, the theoretical boundary line is equal and opposite that of the theoretical boundary line of the other magnet component/portion. In an alternative embodiment, this is not the case. Instead, the theoretical boundary lines are different from one another (not just opposite, but can have a different angle, more on this below). FIG. 9 presents a view of the right portion of magnet 99 (19) with an angle A109 superimposed thereon. This is the angle between the theoretical pole's boundary line 108 and the bottom surface of the magnet portion. In an exemplary embodiment, A109 can be any value of X, where X is 0, or less than, or greater than, or equal to 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or less than or equal to 90, or any value or range of values therebetween in 01.° increments (e.g., 22.2, 25.3, 20.4 to 44.4 degrees, etc.). If zero, the magnet is thus a non-angled 4 pole, at least this portion), and if 90 the magnet is diametrically magnetized. Note that the slant of the boundary 108 could be reversed (thus, angle A109 could be a negative value of those values—this would result in the “position” of the north and south sides being reversed—this would describe the boundary of the left side portion). In an embodiment, with respect to FIG. 9, south could be north and vice versa. And note that the magnetization axis/direction would be normal to the line 108.

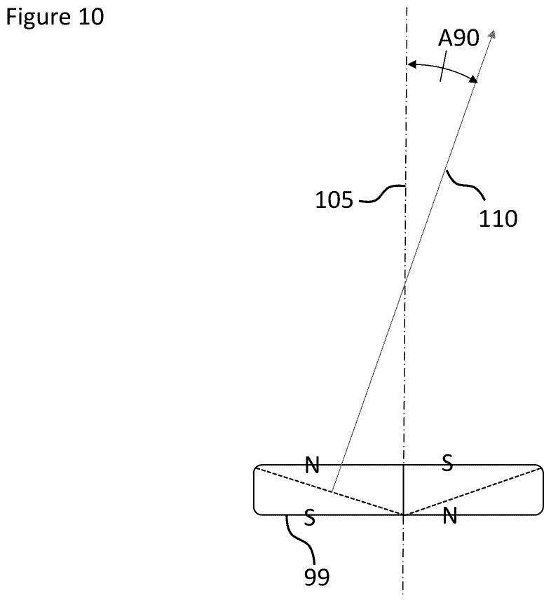

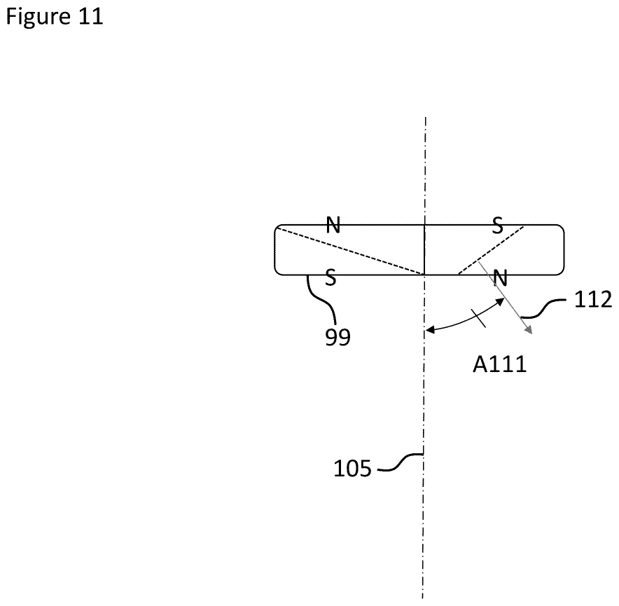

In this regard, FIG. 10 shows the concept of the poles, here, the north pole vector 110, as an angle A90 relative to the longitudinal axis 105 of the magnet 99, where the magnet 99 is a disk or cylindrical magnet. Angle A90 can be any of the values of X. The theoretical pole's boundary line is 90 degrees/normal to the vector 110. And again, south and north could be reversed—there is an angle A90 for the right portion and that could have the same absolute value of the angle for the left portion, but again, it could be different. This is shown in FIG. 11, where A111 is the angle of the north pole vector 112 from the axis 105 for the right portion. A111 can be any of the values of X noted above (positive or negative). As seen, the boundary line need not be bound to specific geometries of the magnet.

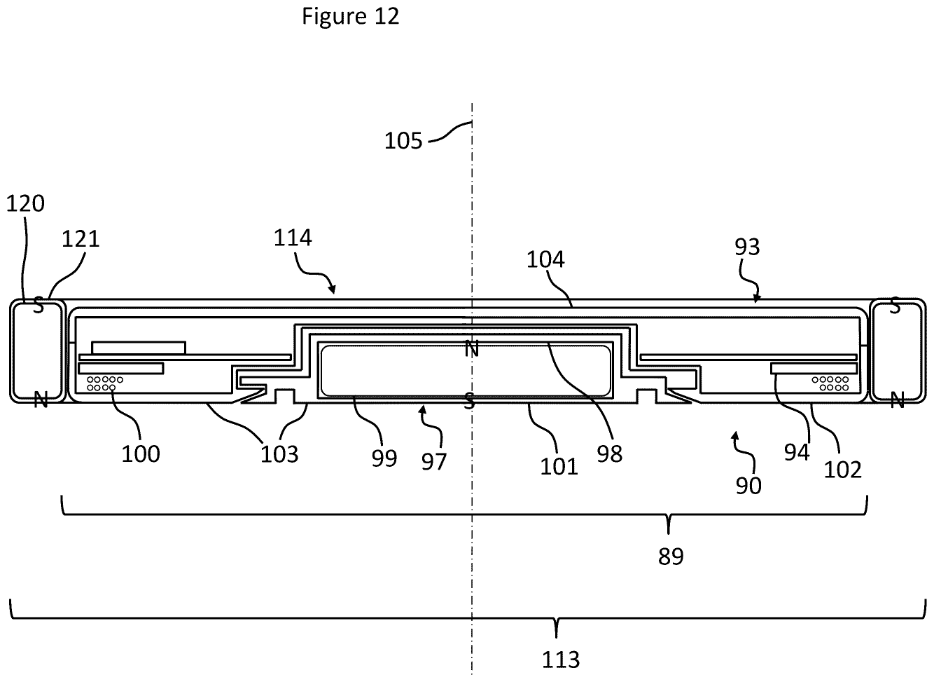

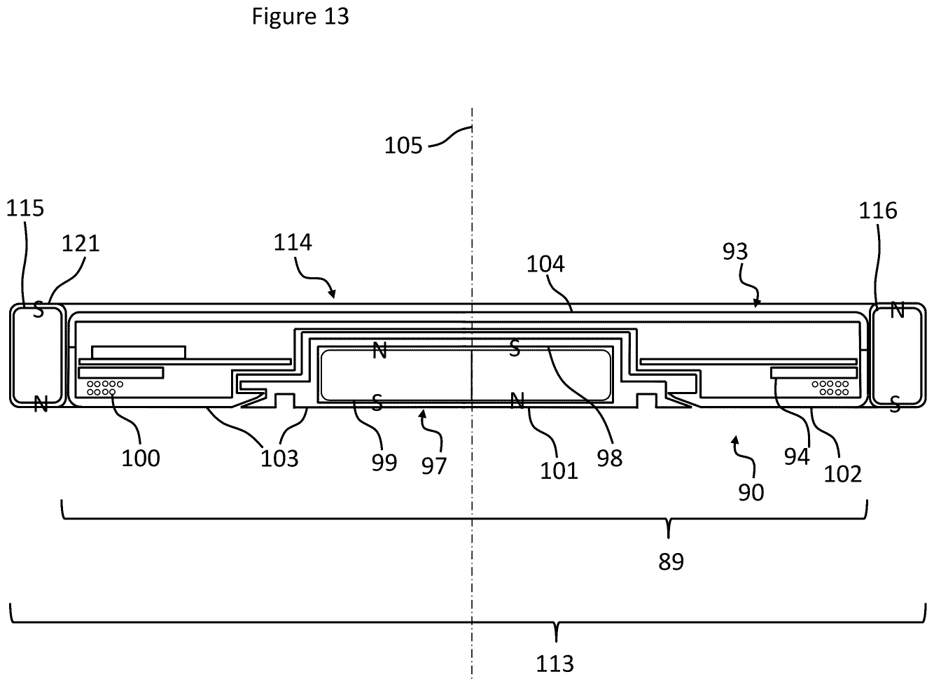

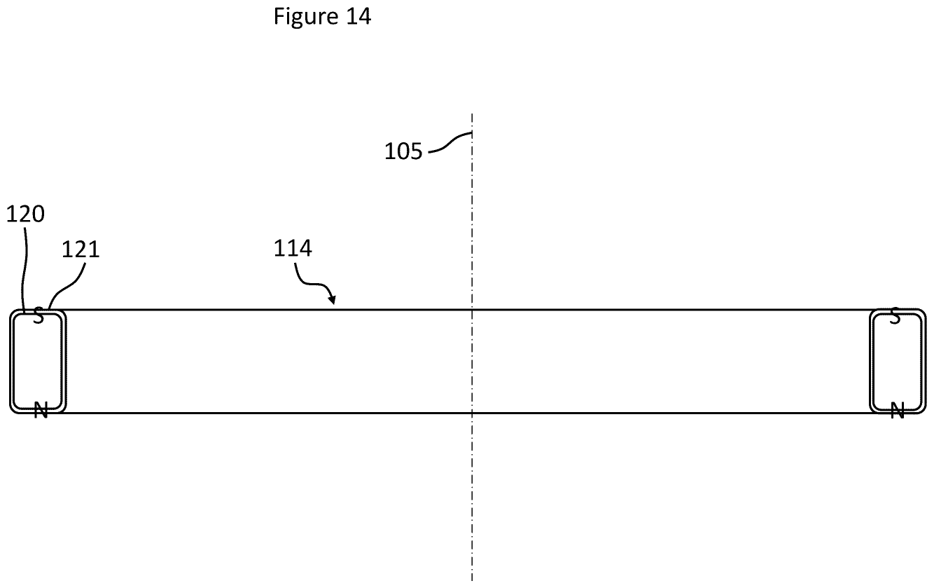

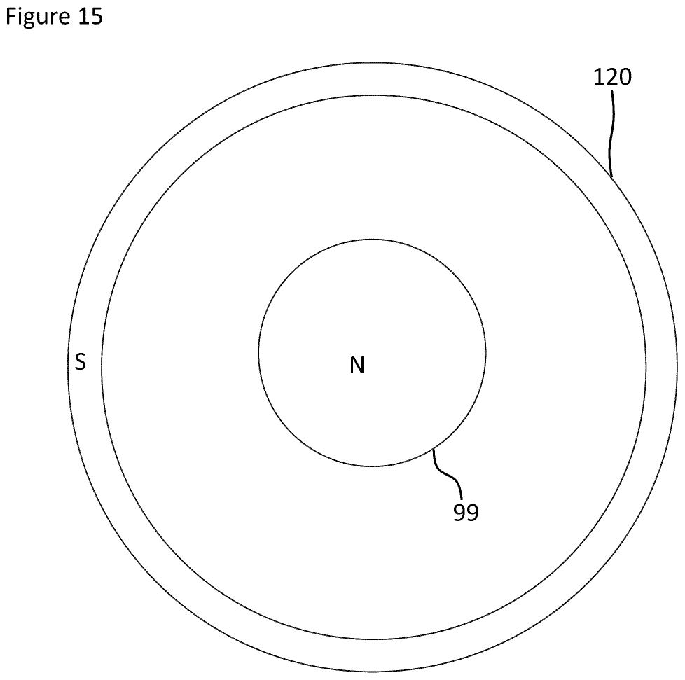

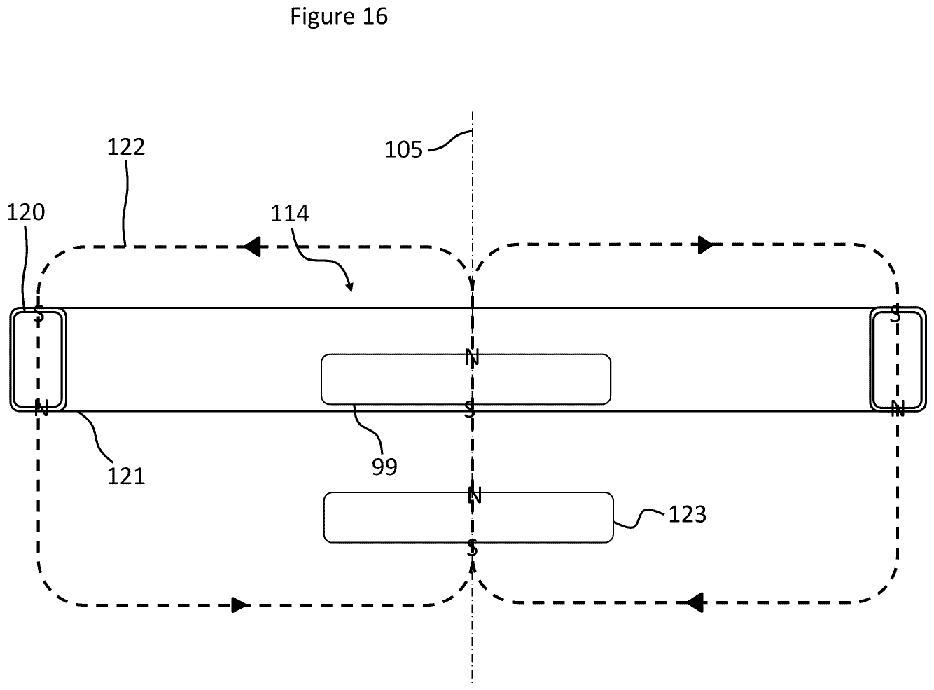

FIGS. 12, 13, 14 and 15 depict exemplary embodiments that enable increase in the retention force resulting from the magnetic field generated by the external componentry. Here, in this embodiment, a removable module 114 is removably attached to the external component 89, which attachment to component 89 results in an external component assembly 113. The removable module 114 includes, in the embodiment of FIG. 14, a permanent magnet 120 located in a housing 121. In an exemplary embodiment, housing 121 and magnet 120 are ring-shaped. These components extend about the longitudinal axis 105. In an exemplary embodiment, the inner circumference of the housing 121 is configured to match the outer circumference of the housing 92 of the first sub-component 93. In an exemplary embodiment, in a scenario where there is utilitarian value with respect to increasing the strength of the magnetic field generated by the external componentry, module 114 is placed around the first sub-component 93 and attached thereto. This results in a combined generated magnetic field (the field generated by magnet 99 plus magnet 120 that is stronger or otherwise results in a greater retention force between the external magnets (120 and 99) and the implanted magnet. FIG. 15 shows a top view of magnet 120 and magnet 99 (two pole magnet 99), with all other components removed, showing the concentric nature of the two magnets. FIG. 16 depicts a portion of the resulting magnetic field 122 when the external magnets in the implantable magnet interact with each other (for the embodiment of FIG. 12 (the embodiment of FIG. 13 would be different-more on this in a moment). Because of the addition of magnet 120, the resulting magnetic field creates a stronger retention force between the external component and implantable component.

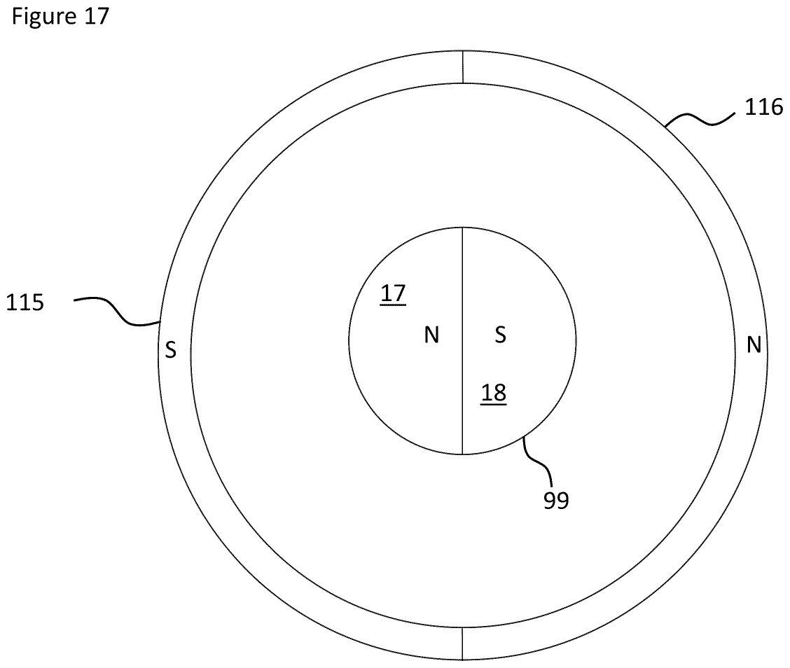

FIG. 13 shows a component 89 that includes a four pole magnet arrangement, where module 114 includes two separate magnets 115 and 116, which have polarities opposite one another to accommodate the 4 pole magnet 99. FIG. 17 shows a top view of the magnets of external component 113 with the four pole magnet arrangement, where the two half circle (outer surface) components 17 and 18 collectively form a collective magnet 99 (a disk made of two parts), concentric with two half circle magnets 115 and 116 (although in an another embodiment, this can be a monolithic magnet with separate portions magnetized to have the polarities shown—the polarities shown are those that are present on top (when looking from the top down in the embodiment of FIG. 13). While the embodiments of FIGS. 15 and 17 show the magnets being concentric, this may be different in other embodiments. Also, while the magnet components are shown as being in direct contact with each other, in other embodiments, the magnet components can be spaced away from each other by way of example.

In any event, it can be seen that in some embodiments, the module 114 can include one or more magnets that have the polarities the same with respect to radial location about the axis 105, while in other embodiments, the module 114 can include one or more magnets that have the polarities that are different with respect to radial location about the axis 105. In an exemplary embodiment, with respect to a view looking downward, the polarity of the outer magnet(s) can alternate with radial location about axis 105. In an exemplary embodiment, there can be 2, 3, 4, 5, 6, 7, 8, 9, 10, 11, 12, 13, 14, 15, 16, 17, 18, 19 or 20 or more or any value or range of values therebetween in one increment discrete different polarities over 360° about the axis relative to an adjacent polarity (this could be north, south, north, south, north, south for six (6) discrete different polarities, or could be north (parallel to axis 105), north (10 degrees off of axis 105), south, north, south and north), etc.

Returning back to FIGS. 13 and 14, the module 114 is readily attachable to the external component 89. In an exemplary embodiment, the module 114 and the external component 89 are configured such that once the module 114 is attached to the component 89, the module 114 cannot be removed. In this regard, such an embodiment can be directed towards a scenario where the external component 89 is to be customized to a given recipient, and because the external component 89 will not be used by another recipient, the customization can be achieved in a semi-permanent matter. That said, in an alternate embodiment, the module 114 is readily removable after attachments to the external component 89. In an exemplary embodiment, such can be achieved by a snap fit or an interference that between the external component 89 and the module 114. Still further, in an exemplary embodiment, the outer circumference of the external component 89 and the internal circumference of the module 114 can be threaded so that the module 114 can be screwed on to the external component 89. Any device, system, and/or method of achieving the attachment of the module 114 to the external component 89, and, in some embodiments, any device, system, and/or method of achieving the subsequent removal of the module 114 to the external component 89 (with respect to those embodiments where the module 114 is removable) can be utilized in at least some exemplary embodiments.

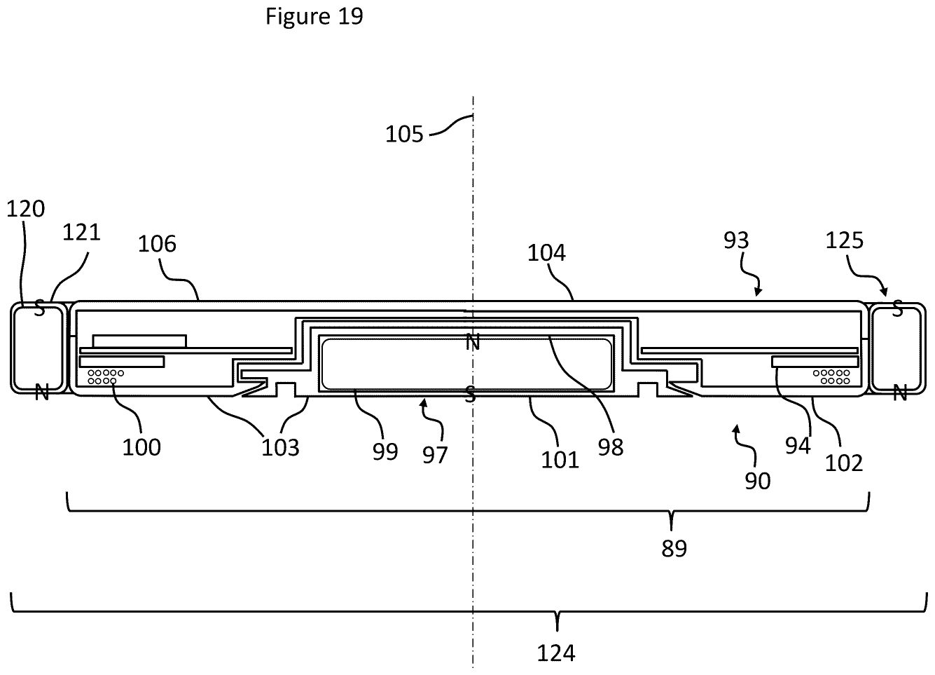

Briefly, it is noted that the geometries of the module 114 can be different than that depicted in FIG. 12 or in FIG. 13. In this regard, the embodiment depicted in FIGS. 12 and 13 are such that the bottom surface of the module 114 in general, and the housing 121 in particular, further establishes a skin interfacing surface that is parallel with and on the same level as the skin interfacing assembly 103. In this regard, the bottom surface of the housing 121 becomes part of the skin interfacing assembly 103. Note further that in the embodiment depicted in FIGS. 12 and 13, the module 114 extends above the top surface of the housing of the external component 89/the surface of the housing of the external component 89 opposite the skin interfacing side 90. This is done so as to increase the thickness of the magnet 120, and thus increase the strength of the resulting magnetic field. Conversely, FIG. 19 depicts an exemplary embodiment where the thickness of the module 125 is such that it has a value that is less than the thickness of the external component 89, as can be seen. That is, when module 125, which corresponds to module 114 detailed above, save for the differences in thickness, is attached to the external component 89 to establish external component assembly 124, the top surface and the bottom surface of module 125 is respectively located below and above the top surface and the bottom surface of the external component 89. That said, in an exemplary embodiment, the bottom surface of the module 125 can be located flush with the skin interfacing surface of the external component 89. Alternatively, and/or in addition to this, the top surface of the module 125 can be located flush with the top surface of the external component 89 (the side opposite the skin interfacing side).

Also, again, while the embodiments of FIGS. 14 and 19 depict a module 114/125 having only one magnet, in alternative embodiments, two or more magnets can be located in the module. Note also that while the embodiment of FIGS. 12 and 19, etc., depict only a single module located about the external component 89, in an alternate embodiment, two or more modules can be utilized. In some embodiments, the modules can be such that they lie one on top of the other with respect to position along the longitudinal axis 105. In some embodiments, the modules can be concentric with each other such that one module envelops the other module. Combinations of these can be utilized as well. Such embodiments can have utilitarian value with respect to providing a system that enables the resulting magnetic force generated by the external componentry to be “fine-tuned” by adding additional modules. That is, instead of having one module that increases the retention force by a given value, a plurality of modules can be utilized to increase the retention force in increments. Note also that even in embodiments that utilize a single module, in an exemplary embodiment, a plurality of different modules can be provided, one of which is selected so as to “fine-tune” the retention force.

In view of the above, there is an external component of a prosthesis (e.g., the assembly of 113 or 124), comprising, a first module (e.g., the external component 89) including a functional component (e.g., the processor therein and first structure including magnetic material (e.g., magnet 99, although in other embodiments, the magnetic material is a ferromagnetic material that is not a magnet (e.g., instead a soft magnetic material-more on this below)). The first module is configured to be retained against skin of a recipient via a magnetic field at least partially generated by a permanent magnet implanted in a recipient (e.g., magnet 123) that interacts with the magnetic material of the first structure, the first module including a skin interfacing surface configured to interact with skin of the recipient when the first module is retained against the skin of the recipient. This external component further includes a second module (e.g., module 114 or 125) including a second structure including magnetic material (magnet 120, although in other embodiments, the magnetic material is a ferromagnetic material that is not a magnet (e.g., instead a soft magnetic material-more on this below)) configured to enhance magnetic retention of the external component to skin of a recipient. In some embodiments, the second module is removably attached to the first module and visible from an outside of the external component when the second module is attached to the first module and when viewed from a side opposite the skin interfacing side (e.g., when looking downward along the longitudinal axis 105 in FIG. 12, etc.). This as opposed to placement of the module on the side of the external component 89 at a location where the module cannot be seen. In this regard, this embodiment covers the annular ring-shaped module 114, and embodiments where a module or the like is located on the top surface (side 91). In an exemplary embodiment, there is no module located on side 90 or beneath (relative to the longitudinal axis 105) surface 101 and/or surface 102. It is noted that in an exemplary embodiment, not including the surfaces of the module that face the external component (e.g., the inner circumference of the housing of the module 125), at least about 20%, 25%, 30%, 35%, 40%, 45%, 50%, 55% or 60% or 70% or more of the surface area of the module can be seen when viewed from the side opposite the skin interfacing side and/or when looking downward along the longitudinal axis 105. In an exemplary embodiment, at least about 20%, 25%, 30%, 35%, 40%, 45%, 50%, 55%, 60%, 65%, 70%, 75%, 80%, 85%, 90%, 95% or 100% of the module 114 or 125 with respect to location along the longitudinal axis is above the skin interfacing surface of the external component (e.g., in FIG. 12, 100% of the module 114 is located above the skin interfacing surface). This as opposed to a module that is located on the skin interfacing side.

In an exemplary embodiment, the second module extends about a majority of the first module (in the embodiment of FIG. 12, for example, all the way around, although in other embodiments, second module can be a “C” shaped) with magnets spaced symmetrically about the longitudinal axis, where embodiments can include more than one magnet in the second module such that the symmetry can be obtained without a housing or structure that extends completely about the external component. To be clear, the second module can be a ring-shaped module extending about the first module. In the exemplary embodiment of FIGS. 12 and 19, etc., the second module has an inner circumference that is concentric with an outer circumference of the first module.

The ring (whatever embodiment) can include a single annular magnet, can include a plurality of annular magnets, can include a plurality of magnets that are arrayed about the longitudinal axis 105 in a symmetrical manner (while in other embodiments, in a non-symmetrical manner). Any arrangement or configuration of magnet(s) that can enable the teachings detailed herein can be utilized in at least some exemplary embodiments.

Note also that the second module can extend over the first module. Some additional features of such will be described below. However, it is noted that while the embodiment depicted in FIGS. 12 and 19, etc., are such that the housing 121 extends about the longitudinal axis/around the outer circumference of the external component 89, in some alternative embodiments (or in addition to this), the structure of the second module can extend across the top of the external component so as to position the magnet(s) on the lateral sides of the external component 89.

In an exemplary embodiment, the thickness (height-distance along the longitudinal axis) of the magnet 99 is no more than about 4, 5, 6, 7, 8, 9, 10, 11 12, 13, 14, 15 mm or any value or range of values therebetween in about 0.1 mm increments. In an exemplary embodiment, the maximum space inside the external component 89, with respect to distance along the longitudinal axis, is about 5, 6, 7, 8, 9, 10, 11, 12, 13, 14, 15, 16 mm or any value or range of values therebetween in about 0.1 mm increments. In an exemplary embodiment, the maximum diameter of magnet 99 is about 10, 11, 12, 13, 14, 15, 16, 17, 18, 19, 20, 21, 22, 23, 24, 25, 26, 27, 28, 29 mm or any value or range of values therebetween in about 0.1 mm increments.

It is also noted that in an exemplary embodiment, an outer circumference of the first sub-component 93 in particular, and the external component 89 in general, has a diameter about 20, 21, 22, 23, 24, 25, 26, 27, 28, 29, 30, 31, 32, 33, 34, 35, 36, 37, 38, 39 or 40 mm or any value or range of values therebetween in about 0.1 mm increments, and the addition of module 114 increases the respective diameter by 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.25, 3.5, 3.75, 4.0, 4.25, 4.5, 4.75, 5, 5.25, 5.5, 5.75, 6.0, 6.25, 6.5, 6.75, 7.0, 7.25, 7.5, 7.75, 8.0, 8.5, 9.0, 9.5, 10, 10.5, 11, 12, 13, 14, 15 mm or more or any value or range of values therebetween in about 0.1 mm increments. Note that these values could be the maximum diameter, the minimum diameter (all on planes normal to the longitudinal axis), a mean diameter, a median diameter and/or a modal diameter.

It is noted that while the embodiments detailed above have been described in terms of an assembly of multiple components (a housing, a magnet, etc.), in an alternate embodiment, a “raw” magnet can extend about the external component 89 without a housing thereabout, perhaps painted or the like.

It is noted that in some embodiments, the module 114 or 125, etc., by way of example, is such that the permanent magnet thereof, when used with the external component 89, is configured such that the permanent magnet of the module is misaligned with the implanted magnet 123 when the external component interacts with the magnetic field of the implanted magnet. That is, the magnet of the module 114 or 125 does not mirror the implant magnet. Some additional details of this are described below.

Also, as can be seen, the magnets of the modules 114 and 125 are positioned such that the longitudinal axis 105 of the button sound processor does not extend therethrough, but does extend through the magnet of the component 89. In an exemplary embodiment, the magnet of the module is the farthest component of the assembly away from the longitudinal axis, save for a housing containing the magnet (in embodiments that utilize such). In an exemplary embodiment, the longitudinal axis 105 extends through no portion of the module 114 or 125.

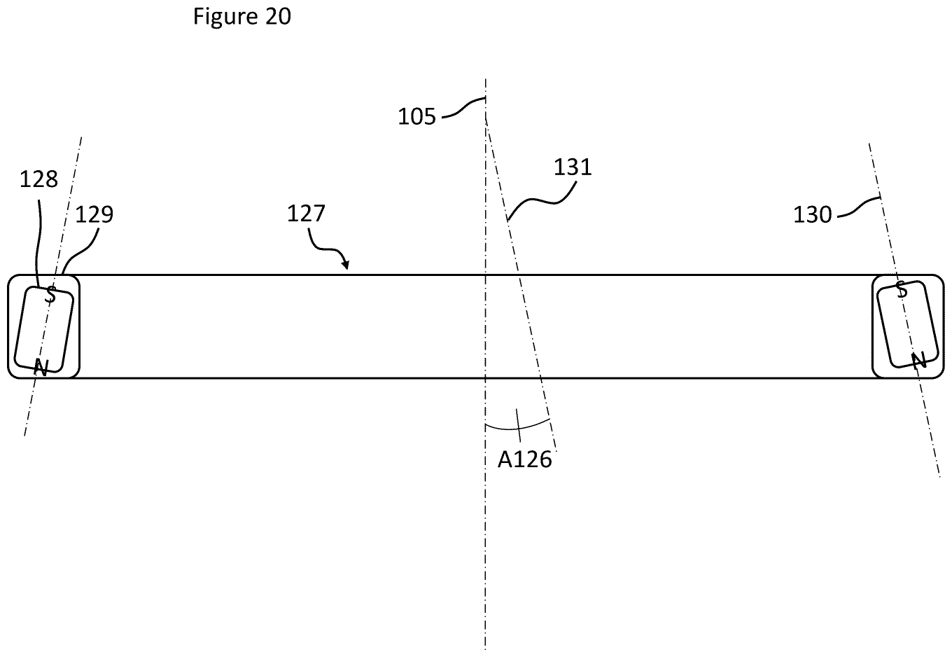

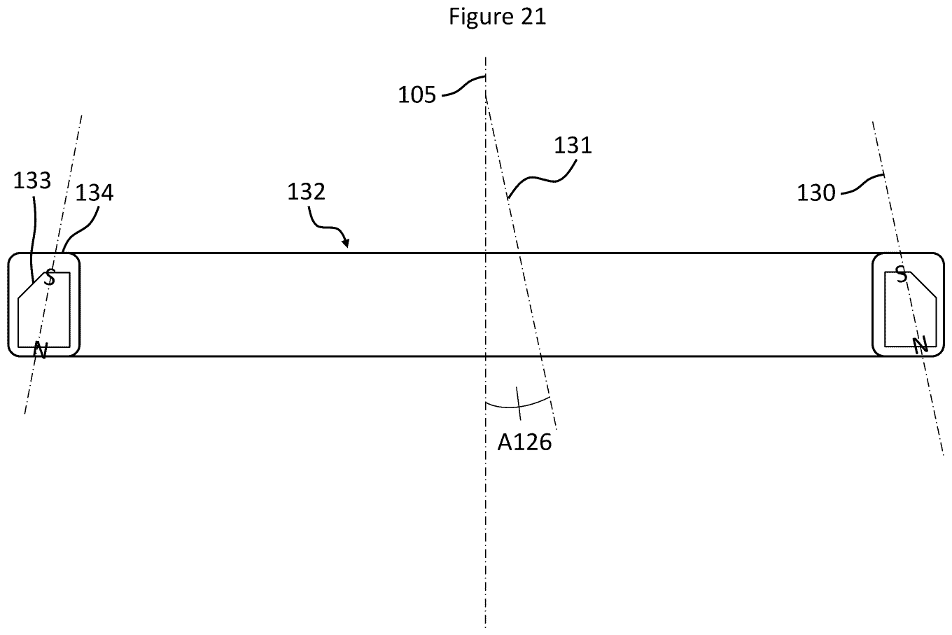

FIG. 20 presents an alternate embodiment of a module 127 that can be used in some embodiments with the external component 89 (for example) to increase the retention force between the external component and implantable component. Here, module 127 includes a magnet 128 that is canted, or, more accurately, has a north-south pole that is canted relative to the longitudinal axis 105. In the embodiment depicted in FIG. 20, the magnet 128 is a ring magnet that extends completely about the longitudinal axis 105, and is housed in a housing 129, which housing presents an interface between the magnet and the outer circumference of the external component 89. In some embodiments, a plurality of magnets 128 is arrayed about axis 105. In the embodiment depicted in FIG. 20, the angle of the north-south pole of the magnet(s) relative to the longitudinal axis 105 is about 30 degrees. FIG. 21 depicts a module 132 that also shows angle A126 superimposed thereon, which is an angle between the longitudinal axis 105 and a line 131, which is a proxy for the local north-south axis (i.e., the axis 130 is parallel to and lying on the same plane as the angle 131). In an exemplary embodiment, A126 is about 1, 2, 3, 4, 5, 6, 7, 8, 9, 10, 15, 20, 25, 30, 35, 40, 45, 50, 55, 60, 65, 70, 75, or 80 degrees, or any value or range of values therebetween in about 0.1 degree increments (e.g., about 20.4 degrees to about 44.2 degrees, about 30.5 degrees, etc.). A126 can be any value of X detailed above.

In an exemplary embodiment, the increase in retention force by utilizing the oblique angle is increased by about 1%, 2%, 3%, 4%, 5%, 6%, 7%, 8%, 9%, 10%, 11%, 12%, 15%, 20%, 25%, 30%, 35%, 40% or more or any value or range of values therebetween in 0.1% increments, all things being equal.

While the embodiment of FIG. 20 depicts a magnet having a local outer cross-section that is generally symmetric about the north-south pole, in other embodiments, such as that depicted in FIG. 21, where the magnet(s) 133 of the module 132 has a local outer cross-section that is asymmetrical, which asymmetry cants the north-south axis relative to the longitudinal axis 105 as can be seen. Housing 134 provides an interface between the magnet 892 and the outer circumference of the external component 89.

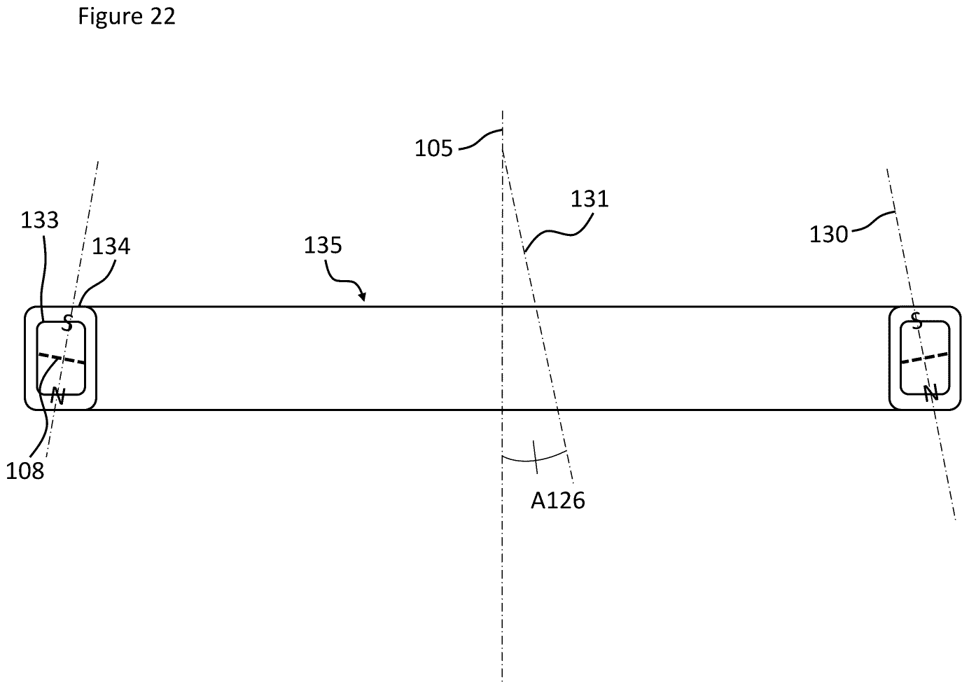

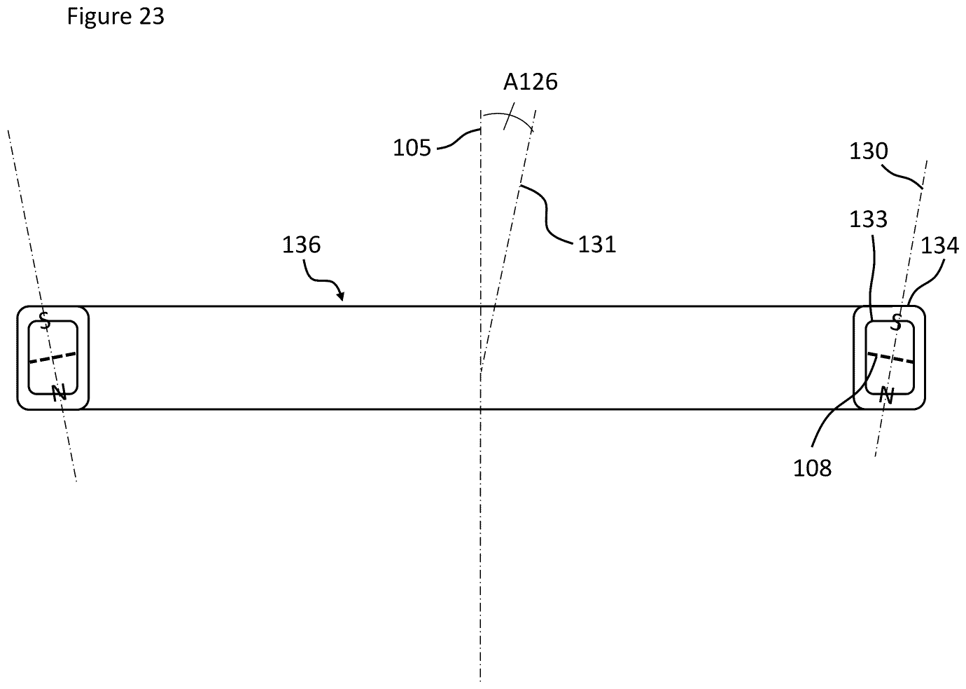

FIGS. 22 and 23 show another exemplary embodiment of the removable module (second module if the component 89 is considered a first module), module 135 and 136 respectively, where magnet(s) 133 are not canted (the bodies are not canted), and have symmetrical cross-sections, and the bodies are not angled relative to the longitudinal axis 105. However, the magnetic axes are angled as shown. Here, the magnets are magnetized to have a magnetic axis that is offset/angled from the longitudinal axis, as compared to the arrangement of FIG. 20. As seen, magnets 133 have theoretical pole boundary lines 108, and the magnetic axes are normal thereto, concomitant with the teachings above.

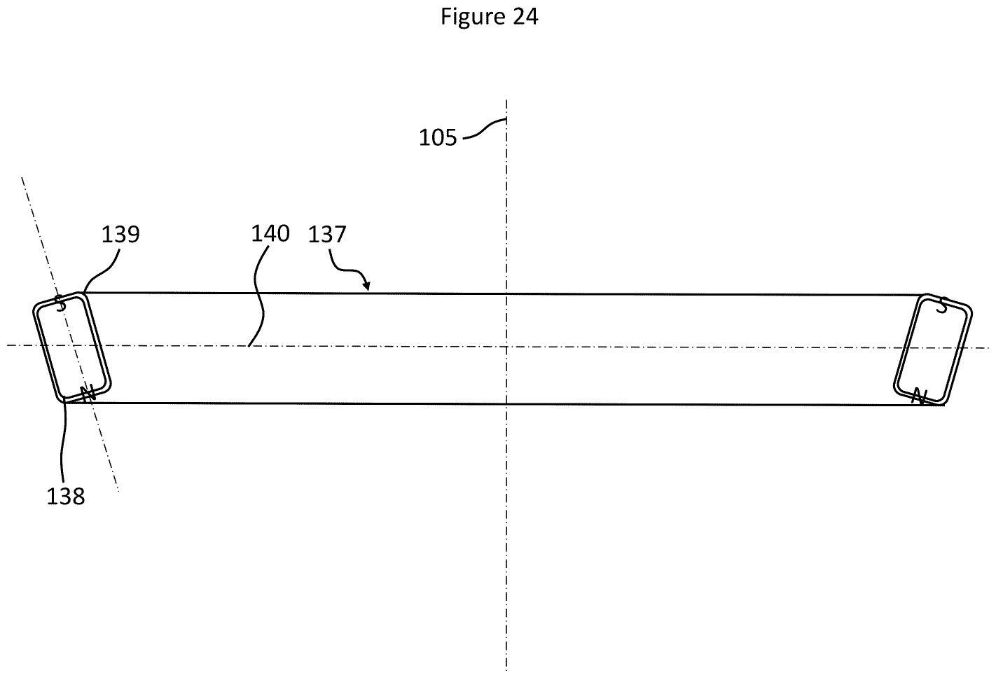

FIG. 24 presents an alternate embodiment utilizing oblique angled polarity. Here, there is a module 137 that includes a housing 139, in which is located a magnet 138. Here, the polarity of the magnet 138 is oblique relative to axis 105, and in an opposite direction from the embodiment of FIG. 20. Also, this embodiment has a canted housing 139, as opposed to the embodiment of FIG. 20. That said, in an alternate embodiment, the non-canted housing can be used, and the magnet 138 can be canted in the housing, concomitant with the scope of the disclosure that any feature of any embodiment disclosed herein can be combined with any other feature of any other embodiment disclosed herein, unless otherwise noted, providing that the art enables such. Also, any feature of any embodiment disclosed herein can be explicitly excluded from use with any other feature of any other embodiment disclosed herein, unless otherwise noted, providing that the art enables such. The canted housings can have utilitarian value with respect to conforming to an external component that has a non-cylindrical outer periphery. Indeed, in an embodiment, the housings are canted in the other direction, and the external component has an outer boundary that is conical (with decreasing outer diameter with distance from the skin side for at least a portion thereof), and thus when the module 137 is fit over the external component, the module 137 pushes the rest of the external component towards the skin (or is pulled towards the skin) owing to the magnetic attraction. Owing to the angling of the housing and the outer periphery of the external component (at least when the angling is inboard with respect to location upward), embodiments using the module 137 may not have an affirmative connection to the external component 89 (the shapes will hold everything in place if there is magnetic attraction towards the skin), although other embodiments can include such affirmative connection (e.g., a snap fit).

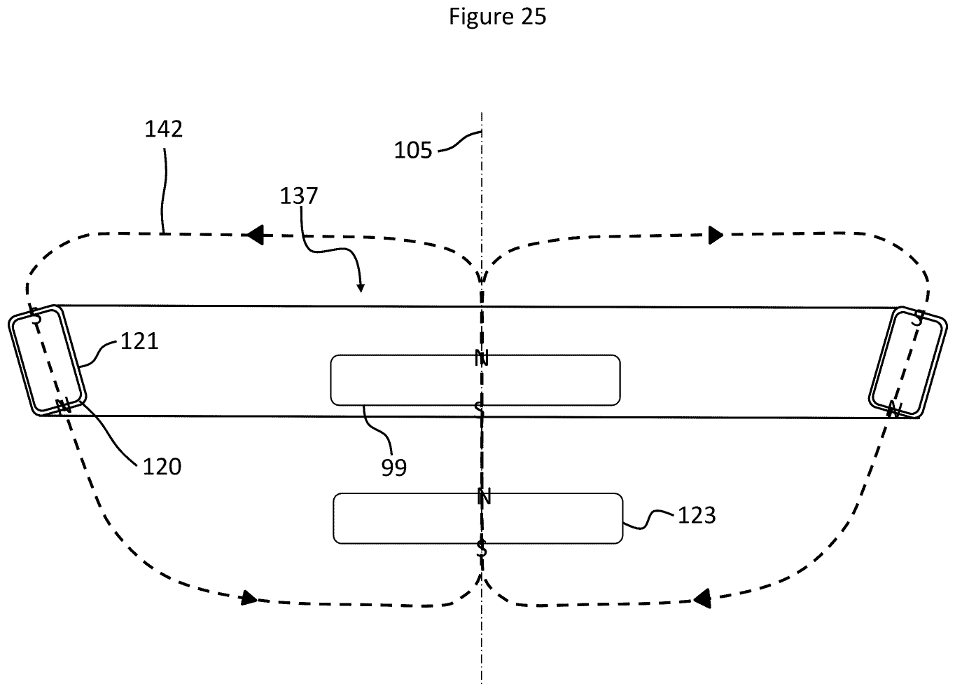

FIG. 25 depicts a portion of the resulting magnetic field 142 when the external magnets in the implantable magnet interact with each other (for the embodiment of FIG. 24 when used with the embodiment of FIG. 6—the magnetic field would be different if the embodiment of FIG. 24 is used with the embodiment of FIG. 7 or 8, for example). Because of the addition of magnet 138, the resulting magnetic field creates a stronger retention force between the external component and implantable component.

Any arrangement that enables the north-south axis of the magnet to be oblique relative to the longitudinal axis 105 can be utilized in at least some exemplary embodiments. Some additional arrangements are described below.

In view of the above, it can be seen that in an exemplary embodiment, there is a body piece configured for transcutaneous communication with an implanted component implanted in a recipient, comprising an inductance coil, a first permanent magnet, and a second permanent magnet. In some embodiments, the first permanent magnet (e.g., magnet 99) has a north-south polarity that is parallel to a longitudinal axis (105) of the body piece. The second permanent magnet (e.g., 128 or 133) has a north-south polarity at an oblique angle relative to the north-south polarity of the first permanent magnet. The body piece is configured such that the second permanent magnet is readily removably connected at least indirectly to the first permanent magnet. In some embodiments, the body piece includes a first housing directly or indirectly supporting the first permanent magnet and directly or indirectly supporting the inductance coil (this is the first sub-component 93, or more accurately, the housing of the first sub-component 93, which supports the permanent magnet and the inductance coil). The body piece includes a second housing containing the second permanent magnet, the second housing being removably connected to the first housing at an outside thereof.

In the embodiment of FIGS. 20, 21 and 24, the magnet 128 or 133 or 138 can be a ring magnet that encircles the first permanent magnet, and a cross-section of the body piece lying on a plane lying on the longitudinal axis (e.g., the plane of FIGS. 20, 21 and 24) such that the north-south pole of the second permanent magnet has an equal and opposite angle on either side of the longitudinal axis relative to the longitudinal axis (i.e., angle A126 is the same but opposite, as can be understood from FIGS. 20, 21 and 24). That said, in an exemplary embodiment, there are a plurality of permanent magnets in/a part of the module that is attached to the external component 89, wherein respective north-south polarities of the second permanent magnets are such that the angle between the longitudinal axis and the respective north-south axis of the second permanent magnets is at least about the same with respect to normalized location about the longitudinal axis. In this regard, while the embodiment of FIG. 20 is depicted as a ring magnet that extends completely about the longitudinal axis 105, alternatively, the magnet can be segmented, with gaps between each segment (or with the segments directly abutting one another). If the cross-section on the left of the axis 105 represented one segment and the cross-section on the right of axis 105 represented another segment, the angle between the longitudinal axis of the respective north-south axis would be the same with respect to normalized location about the longitudinal axis (i.e., with respect to position about the longitudinal axis—in a scenario where there were four magnets each subtending an angle of exactly 90°, and the cross-sectional views of FIGS. 20 and 21 constituted cross-sections through the exact center of two of those four magnets, the normalized locations about the longitudinal axis of the other two would be the plane extending normal to the page of FIGS. 20 and 21).

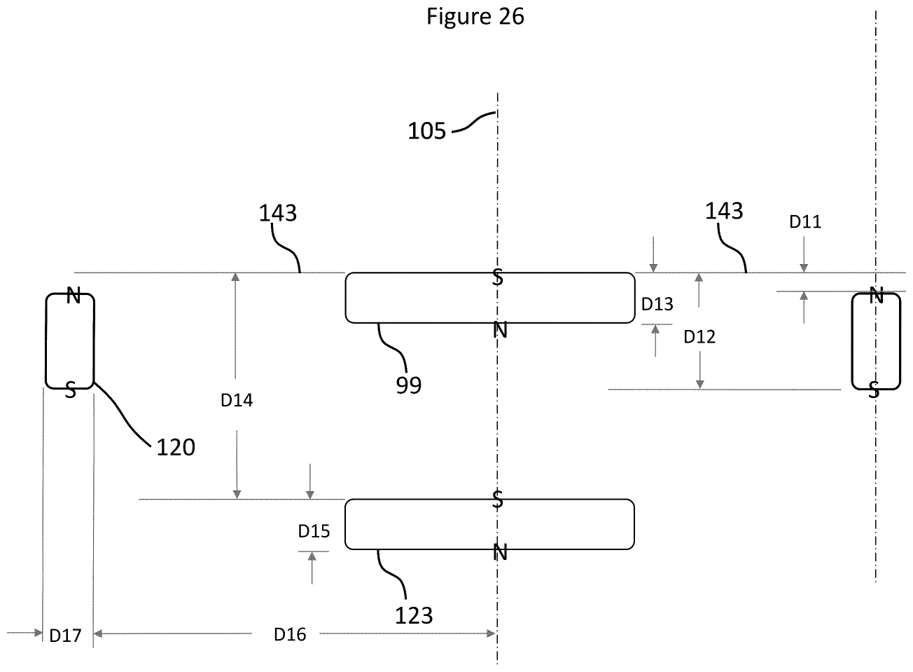

FIG. 26 provides dimensions of the various magnets when the medical device of FIG. 6 (modified to have different magnet pole orientations) is used with a second module. It is noted that these dimensions are applicable to any device detailed herein unless otherwise noted. In this regard, many of the measurements are taken from the top surface of magnet 99. Here, magnet 99 is a disk magnet (whether monolithic or made from a plurality of magnets to establish a disk shape (but can be other types of magnets or otherwise magnets of other shapes in other embodiments, such as, for example, an oval shaped magnet or a rectangular shaped magnet). The top surface of magnet 99 is flat. Accordingly, the reference lines 143 indicate the top surface. However, if the top of the magnet 99 has a nonplanar or non-level shape, or otherwise is not orthogonal to the longitudinal axis 105, the mean, median, and/or mode location of the top of the magnet can be utilized as the reference point for reference lines 143. In an embodiment, the reference line 143 extends from the topmost portion or otherwise the highest portion of magnet 99. This concept is applicable to any of the magnets detailed herein and will not be repeated in the interest of textual economy (e.g., the top of magnet 120 could be cone shaped, and thus the refence line for dimension D11 could extend from the top, the mean, median and/or mode, etc., but this will not be repeated). In any event, distance D11 indicates the distance from reference line 143 to the pertinent feature of magnet 120 (or whatever magnet(s) are present, such as for embodiments that utilize two or more magnets in the second module, and note that the dimensions D11 need not be the same for all such magnets—the values of D11 can be the same for each magnet and can be different for all or some of the magnets depending on the embodiment). In an exemplary embodiment, the value of D11 is less than, greater than and/or equal to 0, 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, or 15 mm, or any value or range of values therebetween in 0.1 mm increments), and this could be a negative number (e.g., the top of magnet 120 is above the top of magnet 99). It is briefly noted that the statements “less than, greater than and/or equal to” are utilized for the interest of textual economy, and it will be understood that in some instances some of these qualifiers may not be able to exist (such as less than zero, although in this instance, because the values can be negative, that could be the case). Also as seen, there is the bottom of magnet 120, and reference D12 can be less than, greater than, and/or equal to Y, where Y is 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, or 23 mm, or any value or range of values therebetween in 0.1 mm increments. As seen, the value of D12 will always be larger than the value of D11, unless we are in the realm of negative numbers for D11 for example, and thus while the just detailed numbers overlap, these numbers are presented in terms of textual economy and it is to be understood that D11 cannot equal 3 while D12 equals 2 for example. To round things out, the value of D13 can be less than, greater than, and/or equal to 0.25, 0.5, 0.75, 1, 1.25, 1.5, 1.75, 2, 2.25, 2.5, 2.75, 3, 3.5, 4, 4.5, 5, 5.5, 6, 6.5, 7, 8, 9, 10, 11, 12, 13, 14, 15, 16, 17, 18, 19, 20, 21, 22, 23, 24, 25, 26, or 27 mm, or any value or range of values therebetween in 0.05 mm increments, and the value of D17 can also be any of those (and the values need not be the same), but likely smaller than the values for D13 in many embodiments. The outer diameter of the magnet 99 as measured on a plane normal to axis 105 can be less than, greater than and/or equal to 3, 3.5, 4, 4.5, 5, 5.5, 6, 6.5, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mm, or any value or range of values therebetween in 0.05 mm increments and the values can also be the case for the magnet 123, and the values need not be the same. D15 can be any of the values of D13 just noted, and the values need not be the same.

And this leads to the distance between magnet 99 and magnet 123, D14, which can be less than, greater than and/or equal to 5, 5.5, 6, 6.5, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45 mm, or any value or range of values therebetween in 0.05 mm increments (depending on the medical device at issue-embodiments include utilizing the teachings herein for medical devices located in other parts of the body, and thus the separation between magnets might be larger for example).

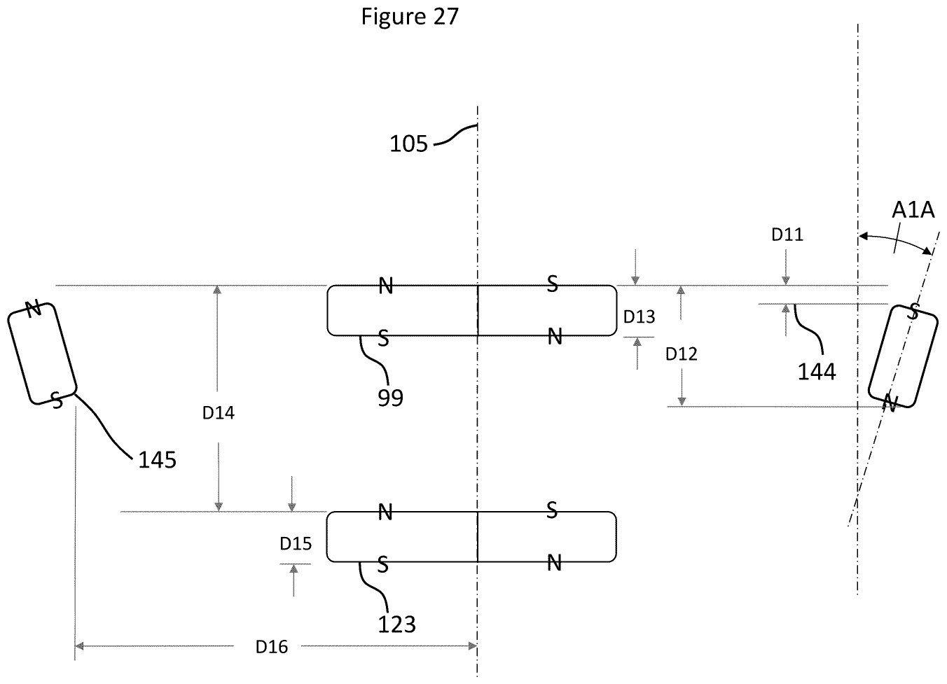

FIG. 27 presents an embodiment using the component 89 of FIG. 13with a variation of the second module of FIG. 24 (here, the magnets of the module have reversed polarities). The dimensions here comport with those of FIG. 26 and will not be elaborated upon, except to briefly indicate that the reference line 144 is measured from the highest part of magnet 145 (and D12 is measured to the lowest part of that magnet-again by way of example, and the mean, median and/or mode can be used if so desired). In the interests of textual economy, the values detailed above can be those for FIG. 27 (and need not be the same), and can have an additional 0.25, 0.5, 0.75, 1, 1.5, 2, 2.5, 3, 3.5, 4, 4.5, or 5 mm, or an amount subtracted therefrom. Note that the value of D16 can be less than, greater than, and/or equal to 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, or 63 mm, or any value or range of values therebetween in 0.1 mm increments, especially depending on the application of the medical device (e.g., abdomen or hip, where the distance between magnet 123 and the external component can be larger than medical devices used with/in the head of a human—and note that the teachings herein are not limited to a human—the teachings herein can be applied to other types of mammals or avians for that matter).

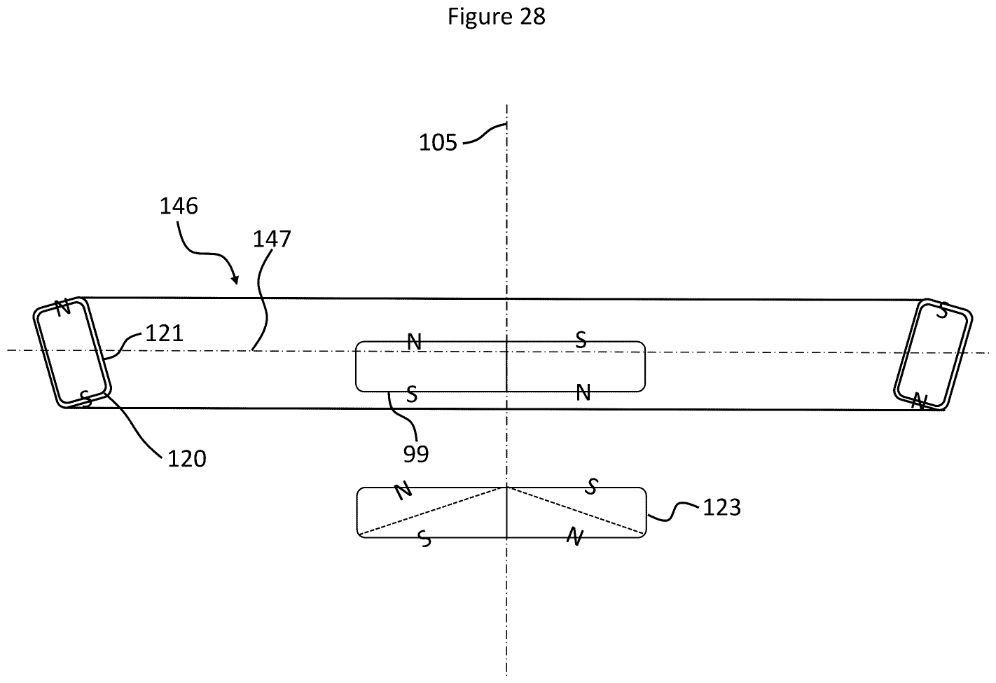

FIG. 28 presents another exemplary embodiment where the external componentry of FIG. 27 is utilized with an implant that is different, with a removable module 146 (where the polarity of the magnets is reversed relative to removable module 137 of FIG. 24).

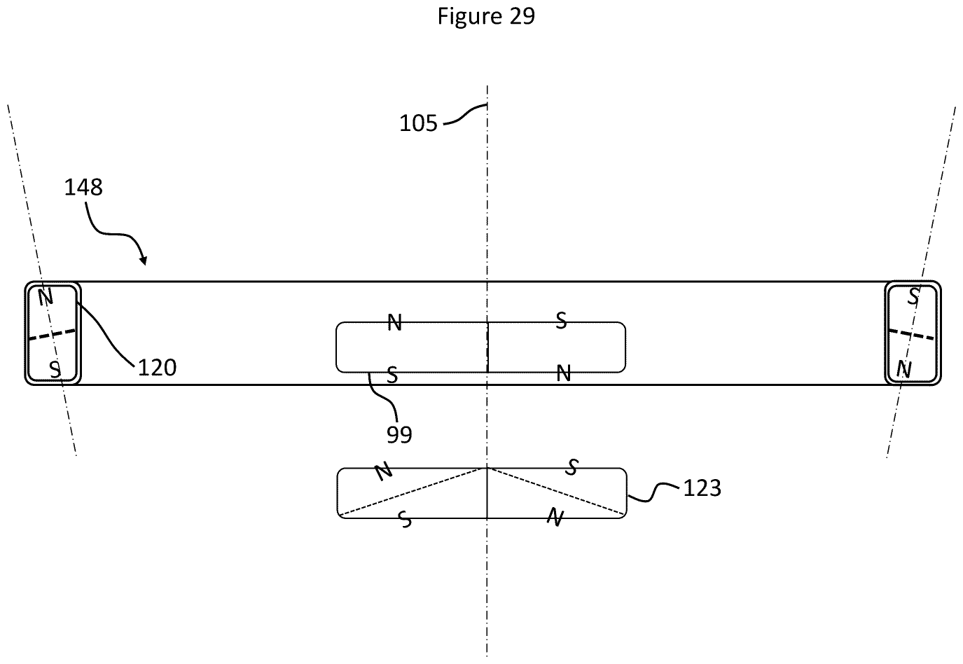

FIG. 29 presents another exemplary embodiment where the second module is different from that of FIG. 27, where a second module 148 uses magnet body(s) that is not canted, but the North-South polarity is canted.

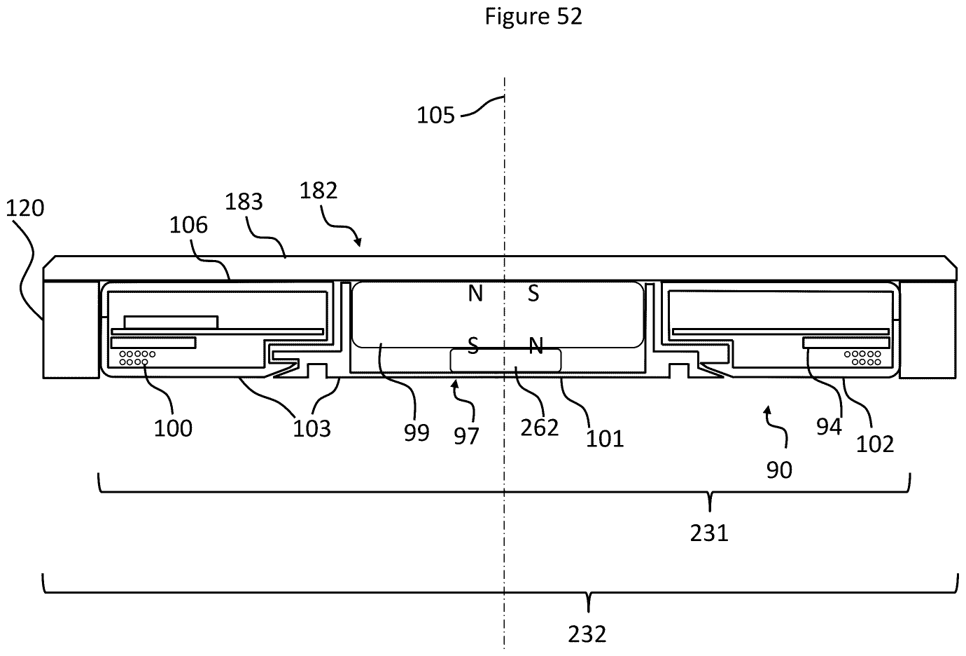

In view of the above, by way of example only and not by way of limitation, there is an apparatus, such as by way of example, the external component assembly 113 of FIG. 13, with the combination of, by way of example, external component 89 of FIG. 7 when used with removable module 114 of FIG. 14, or for example the assembly 232 of FIG. 52. But other removable components 114 can be utilized such as by way of example only and not by way of limitation, the removable module 146 of FIG. 28 by way of example, or the removable component 148 of FIG. 29 by way of example. As seen, there includes a first permanent magnet arrangement, which can include by way of example only and not by way of limitation, magnet arrangement 99, which can be a single monolithic magnet body or can be a compilation of magnets held together by adhesive or by a housing or some other structure by way of example. The apparatus can also include a second permanent magnet arrangement, as can be seen, which permanent magnet arrangement can be the magnet(s) of the removable module 148 by way of example. This magnet arrangement can be a single monolithic magnet or can be a plurality of magnets held together by the housing of the removable component, if present. In an exemplary embodiment, the first permanent magnet arrangement is a four pole magnet arrangement, and the second permanent magnet arrangement is a permanent magnet that has a north-south axis that is canted relative to a longitudinal axis of the first permanent magnet arrangement.

Concomitant with the teachings above, the apparatus is an external component of a hearing prosthesis, but this can be a retinal implant, for example, in an alternate embodiment, or another type of prosthesis, such as a muscle stimulator, for example.

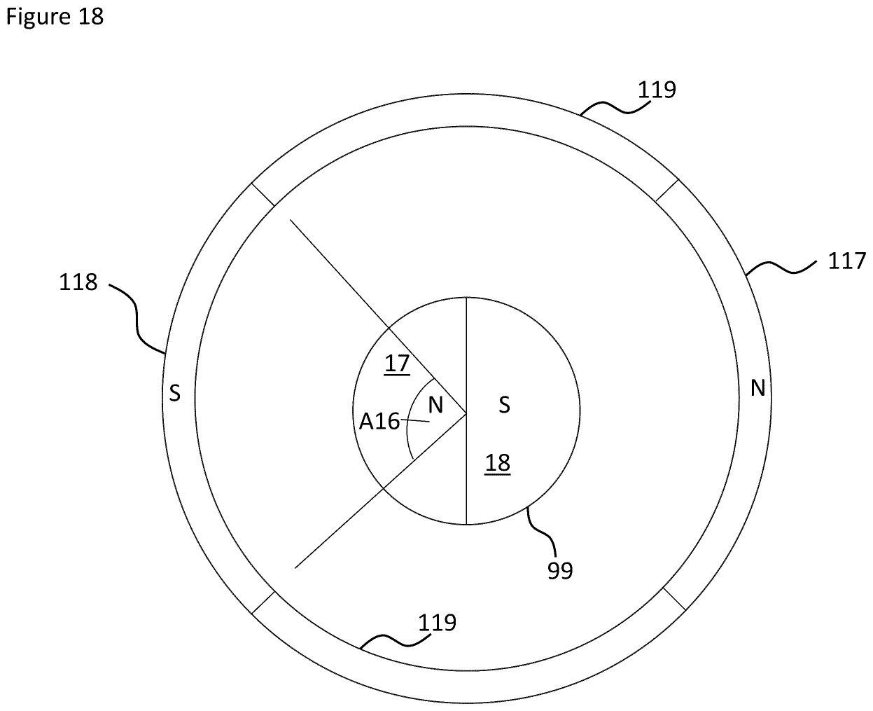

In an embodiment, with respect to the apparatus under construction, the apparatus further includes a third permanent magnet arrangement that has a north-south axis that is canted relative to the longitudinal axis. In this regard, the second permanent magnet arrangement can correspond to the magnet 120 of FIG. 29 on the left side of axis 105, and the third permanent magnet arrangement corresponds to the magnet 120 on the right side of axis 105 of FIG. 29, all by way of example. By way of example only and not by way of limitation, the second permanent magnet arrangement can correspond to a C-shaped or half circle shape magnet body that is monolithic and the third permanent magnet arrangement can correspond to a C-shaped or half circle shape magnet body that is also monolithic. In this exemplary embodiment, the removable module is such that when the removable module is placed around the external component 89, the second and third permanent magnet arrangements collectively completely surround the external component 89. That said, in an exemplary embodiment, the second and third magnet arrangement only partially surround the external component 89 in some other embodiments, such as that shown in FIG. 18, by way of example, which shows a top view of the magnets of external component 113 with the four pole magnet arrangement, where the two half circle (outer surface) components 17 and 18 collectively form a collective magnet 99 (a disk made of two parts), concentric with two part-circular magnets 118 and 117. A spacer 119 is present between the two magnets, by way of example. In an embodiment, the spacer 119 is not present. That said, in an embodiment, where there is no housing, the spacer 119 holds the two magnets 118 and 117 together in an assembly that can correspond to the complete removable module in an embodiment. As seen by way of example, the magnet arrangement(s) can extend an angle A16 about the longitudinal axis 105, which angle A16 can be less than, greater than and/or equal to 2, 3, 4, 5, 6, 7, 8, 9, 10, 15, 20, 25, 30, 35, 40, 45, 50, 55, 60, 70, 80, 90, 100, 110, 120, 130, 140, 150, 160, 170, or 180 degrees, or any value or range of values therebetween in 0.1 degree increments.

But returning to the embodiment where the north-south axis is canted relative to the longitudinal axis of the first permanent magnet arrangement, the north-south axis extends at an angle that is less than, greater than and/or equal to 1, 2, 3, 4, 5, 6, 7, 8, 9, 10, 15, 20, 25, 30, 35, 40, 45, 50, 55, 60, 70, 80, 90, 100, 110, 120, 130, 140, 150, 155, 156, 157, 158, 159, 160, 161, 162, 163, 164, 165, 166, 167, 168, 169, 170, 171, 172, 173, 174, 175, 176, 177, 178, or 179 degrees, or any value or range of values therebetween in 0.1 degree increments, such as between 55 and 75 degrees, by way of example. And these values can be the case for the third magnet arrangement, or a fourth, fifth, 6^{th}, 7^{th}, etc., magnet arrangement of the removable module (again, the removable module/second sub-component can have any of the number of magnet arrangements detailed herein).

In an embodiment, the polarity of the third permanent magnet arrangement is reversed relative to the polarity of the second permanent magnet arrangement. By reversed, this does not mean that the angles of the axes are opposite one another. Indeed, in an exemplary embodiment, the angle of the north-south axis of the third permanent magnet arrangement can have an absolute value that is different from that of the north-south axis of the second permanent magnet. But the north pole of the third permanent magnet arrangement would be on the bottom if the north pole of the second permanent magnet arrangement was on the top. By way of example, the magnets 128 of the embodiment of FIG. 20 and the magnets 133 of FIG. 23 have polarities that are not reversed, whereas the magnets 120 of FIG. 28 have polarities that are reversed.

In an embodiment, the four pole magnet arrangement of the first permanent magnet arrangement is non-angled, concomitant with the embodiment of FIG. 7. In an embodiment, the four pole magnet arrangement of the first permanent magnet arrangement is angled/not straight, concomitant with the embodiment of FIG. 8.

As noted above, in an embodiment, the external components can be used with an implantable component. Thus, in an embodiment, there is a system, comprising the apparatus under discussion, in any of its permutations, and an implantable component, wherein the implantable component includes a straight or angled four-pole magnet arrangement (or both in some embodiments). In an embodiment, the north-south axes of the angled four-pole magnet arrangement of the implantable component extends at an angle that has any of the values detailed herein for the magnet of the external component (and the values need not be the same) or the implantable component, such as for example, between 55 and 75 degrees from a longitudinal axis of the magnet arrangement of the implantable component.

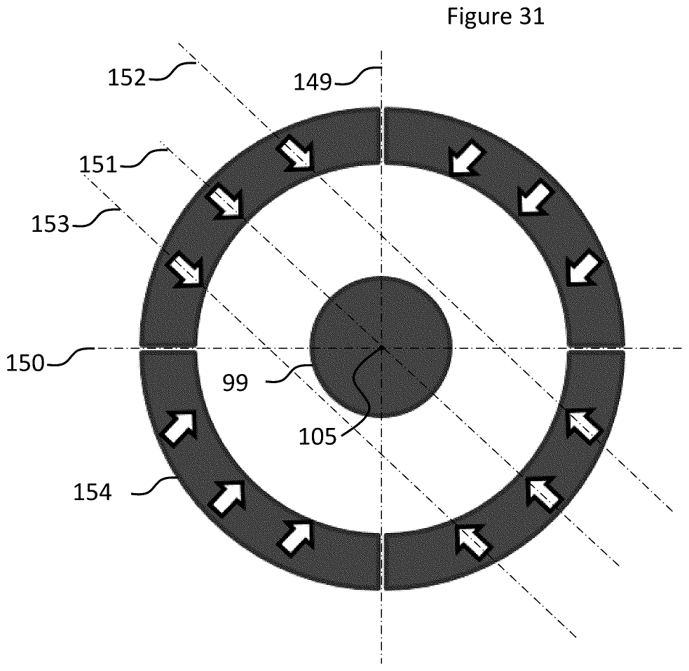

FIG. 31 depicts an embodiment with a segmented magnet assembly of the second module (where here, it is probable that the magnets would be housed in a housing (not shown), although in some embodiments, the magnets could be held together in a different manner without a housing). As can be seen, there are four (4) magnets 154 that collectively extend about the longitudinal axis 105 (which is represented by the dot at the intersection of axis 149 and 150, each of which is 90° offset from each other) and magnet 99 of the external component 89. In this embodiment, it is noted that the magnetic field of each of the magnet segments 154 is such that the respective north-south polarity of the magnets is such that the polarity is not always “focused” on the longitudinal axis 105, but instead is such that the north-south polarities lie on respective planes that are parallel to one another. This is represented by the arrows of FIG. 31, and the lines 151, 152 and 153, each of which are lines on planes that are parallel to the longitudinal axis 105 and parallel to one another. That is, FIG. 31 depicts a plurality of permanent magnets 154 in/a part of the module that is attached to the external component 89, wherein respective north-south polarities of the second permanent magnets are such that the average angle between the longitudinal axis and the respective north-south axis of the respective second permanent magnets is at least about the same with respect to normalized location about the longitudinal axis from magnet to magnet.

In view of FIGS. 20 and 21, when such is utilized with the embodiment of FIG. 6 for example, it can be seen that in some embodiments, with respect to respective cross-sections of the first permanent magnet and the second permanent magnet lying on a plane on the longitudinal axis, the outer shapes of the respective cross-sections are at least one of different (e.g., one is rectangular shaped and the other is not rectangular shaped) or rotated relative to one another (as in FIG. 20, for example)).

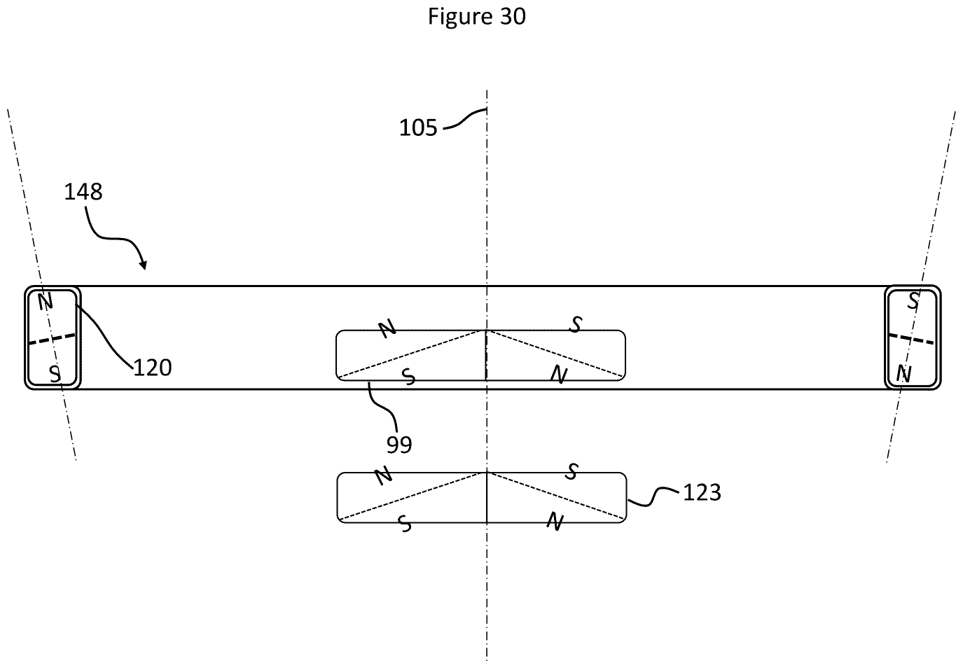

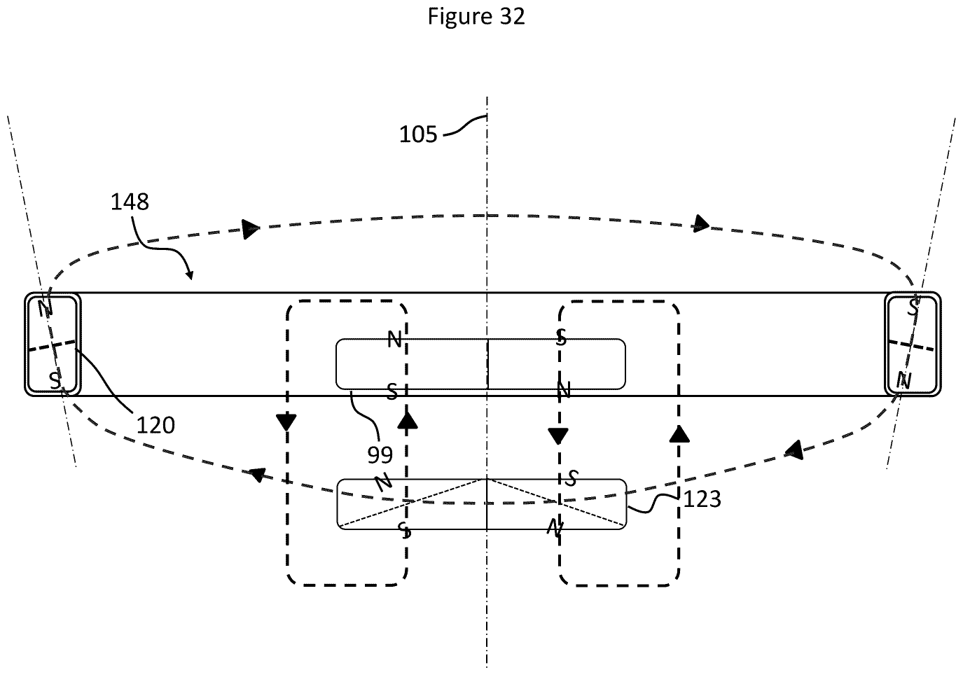

Returning back to FIG. 28, it can be seen that the implant magnet 123 is an angled four pole magnet, as opposed to prior embodiments. The polarity axes can be any of those detailed above in the interests of textual economy, providing that the art enables such, unless otherwise noted, and the angles need not be the same as that of the external component. And note that in an embodiment, the external component can have the angled four pole magnet as well, along with the implant magnet, as seen in FIG. 30. In any event, FIG. 32 shows an exemplary embodiment, in a scenario where there is utilitarian value with respect to increasing the strength of the magnetic field generated by the external componentry, module 148 is placed around the first sub-component 93 (not shown other than the magnet thereof) and attached thereto. This results in a combined generated magnetic field (the field generated by magnet 99 plus magnet 120 that is stronger or otherwise results in a greater retention force between the external magnets (120 and 99) and the implanted magnet, by way of rough example. The magnetic field is generally and conceptually represented by the dashed lines of FIG. 32, and is expanded upon below in greater detail. Note that this is not the exact magnetic field, but presents a conceptual one for purposes of discussion. That is, FIG. 32 depicts a portion of the resulting magnetic field when the external magnets and the implantable magnet interact with each other in a conceptual manner. Here, for purposes of discussion with respect to the concept of the magnetic field that relates to magnet 120 is presented separately from the magnetic field that relates to magnet 99. That is, these magnetic fields are presented as if the other magnet of the external component is not present (i.e., magnet(s) 120 and magnet(s) 123 are present but not magnet(s) 99, and then magnet(s) 99 and magnet(s) 123 are present but not magnet(s) 120). Note also that the magnetic field (also flux-any disclosure herein of a flux corresponds to a field, and vis-a-versa, unless otherwise noted, providing that such is enabled by the art—this in the interests of textual economy and otherwise in view of the fact that the words are sometimes used interchangeability in the art) between magnet(s) 99 and 123 would not be as symmetrical as shown (the field would exit and enter magnet 123 at an angle from the vertical-more on this below). Because of the addition of magnet 120, the resulting magnetic field creates a stronger retention force between the external component and implantable component. Also, because of the angled north-south polarity, a different (in some embodiments, stronger) magnetic field is created, at least with respect to embodiments that utilize an angled four pole implant magnet 123, as shown in FIG. 32.

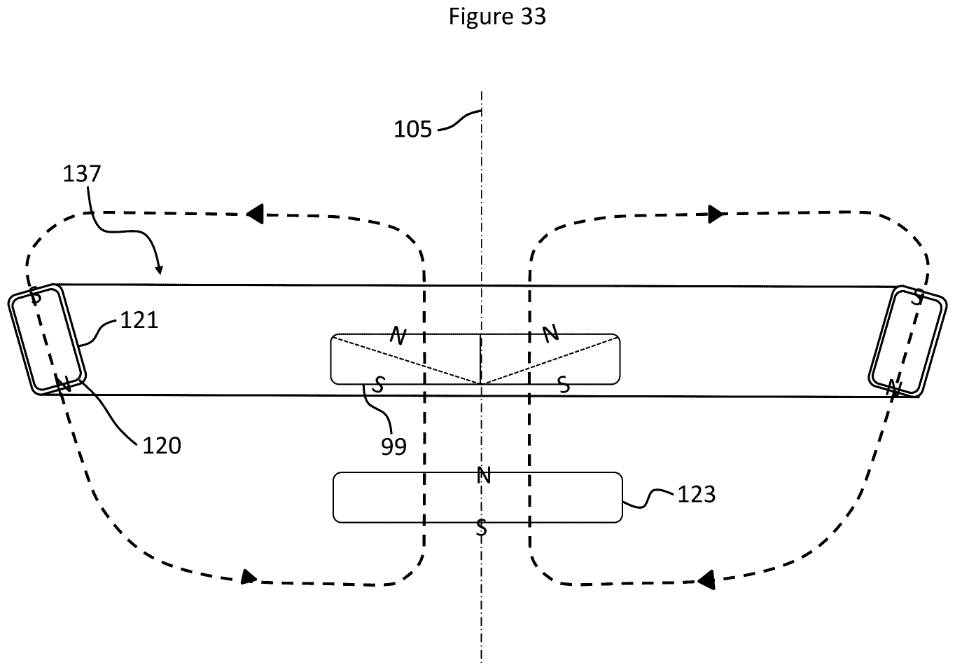

FIG. 33 shows another exemplary embodiment using a straight two pole magnet (non-angled) 123 in the implant and an angled 4-pole magnet 99 in the external component, along with the external component using the second module/second component 137. The magnetic field is conceptual, and note that the field would be a bit different vis-à-vis the angled magnet 99 than shown. (The field on the left would enter and exit magnet 99 at a positive sloping angle, and the field on the right would enter and exit at a negative sloping angle, for example.)

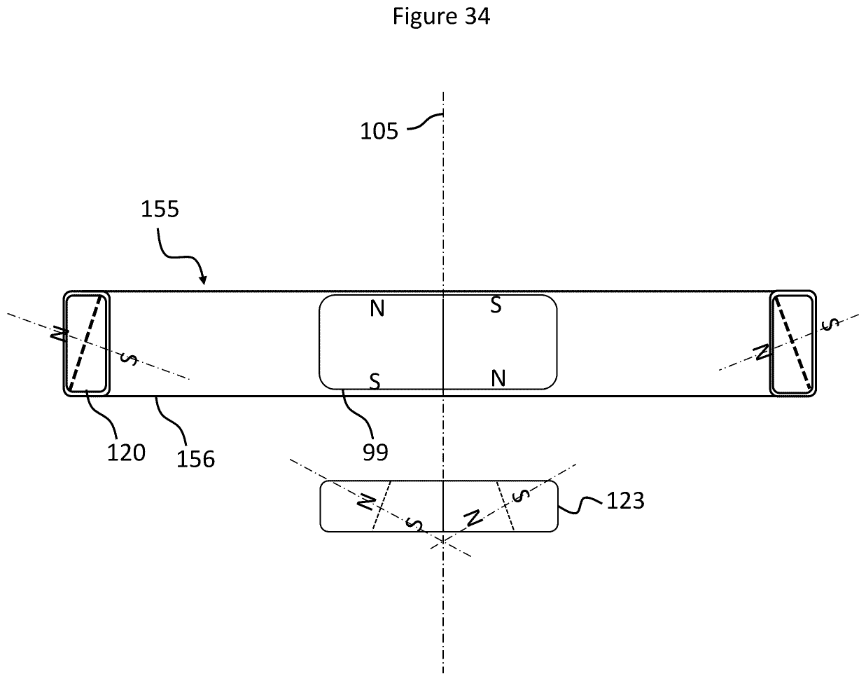

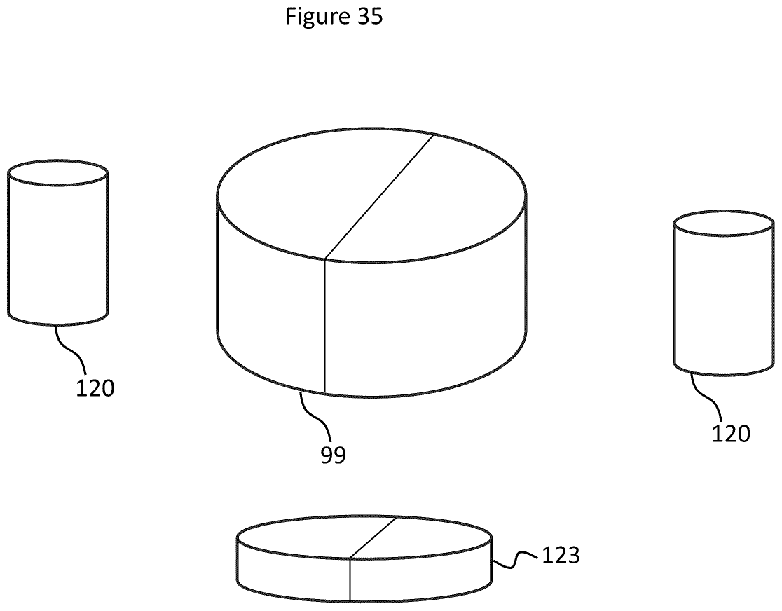

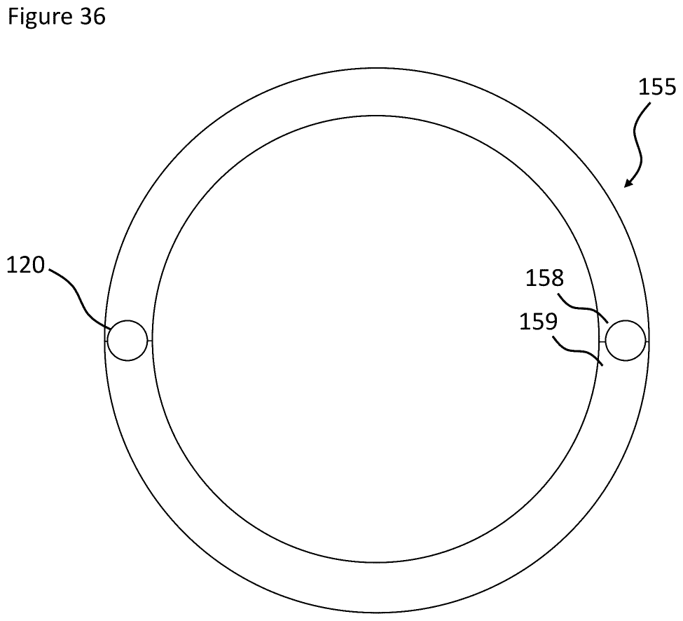

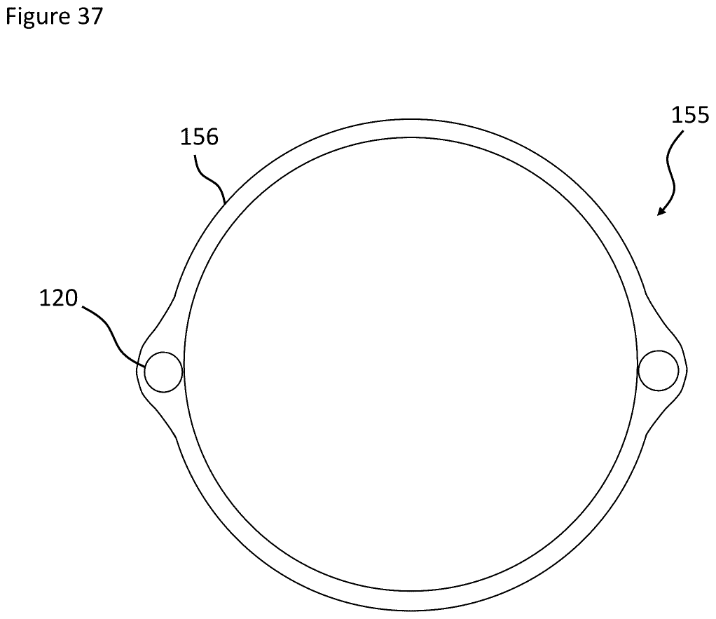

FIG. 34 shows yet another example of an exemplary embodiment. Here, the angles of the canted magnetic poles are more aggressively angled away from the vertical direction than those of the embodiments above (as depicted, for purposes of conveyance of the pertinent teachings) and the magnet 99 is taller than those depicted above (as depicted). But there is more. The magnets on the side (magnets 120) are cylindrical magnets, as seen FIG. 35, which shows in an isometric view only the magnets of the system. Here, the magnets 99 and 123 are respectively a compilation of separate magnets adhered together or held together (e.g., by a housing), but could be respective magnets that are magnetized to have the four poles (angled or straight). Here, the housing 156 that holds the magnets 120 together can be injection molded about the magnets 120, as can be the case with respect to the housing detailed above that hold the outer magnets in place/holders magnets relative to one another. That said, the housing 156 could have pockets therein shaped especially for the cylindrical magnets so that the magnets can be inserted (e.g., through holes in the top, which could result in an interference fit or an adhesive can be utilized to hold the magnets therein, or the magnets could be retained by snapping two halves of the housing 156 together to trap the magnets in the housing at the location where the two parts connect to each other (such as that shown in the embodiment of FIG. 36, which shows a first housing component 158 snapped to a second housing component 159, trapping magnets 120 therebetween), etc.—note that this can be the case with the housing detailed above for the outer magnets as well, as modified for those magnets). Thus, the housing 156 can be a ring that extends about the external component that includes magnet 99 and can fit thereon in a manner consistent with the teachings above, or in a different manner if there is utilitarian value of such. FIG. 37 shows an alternate embodiment of a housing 156 that uses cavities into which are fitted the magnets 120, where the overall outer diameter of the housing is minimized relative to that of FIG. 36, except for the two locations of the magnets 120. This can provide for a less conspicuous module assembly where such as desired.

Thus, in an embodiment, referring to the apparatus that includes a first permanent magnet arrangement, a second permanent magnet arrangement (and a third in some embodiments, or more for that matter), the second permanent magnet arrangement (and the third permanent magnet arrangement in some embodiments) is a monolithic cylinder magnet, wherein the first permanent magnet arrangement is a cylinder magnet, and wherein the first permanent magnet arrangement is centrally located in the external component with respect to lateral location, and wherein the second permanent magnet arrangement is offset from the first permanent magnet with respect to lateral location. In an embodiment, the magnets can be disk magnets.

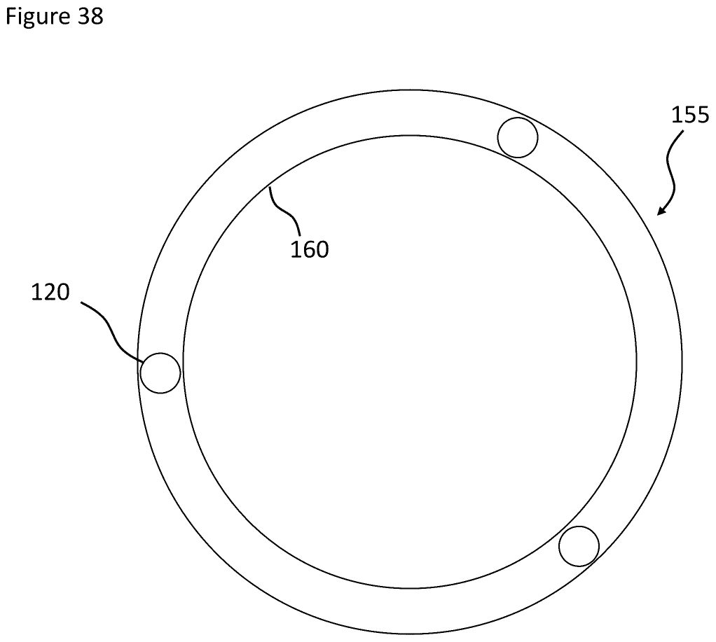

And briefly, while many embodiments herein are disclosed in terms of the second module having two magnets, FIG. 38 shows an embodiment where the module 155 includes three magnets 120, symmetrically spaced about the longitudinal axis (although in other embodiments, this is not the case). Here, the housing 156 is a monolithic component injection moulded around the magnets 120.

In an embodiment, by way of example only and not by way of limitation, the arrangement of FIG. 34 can provide a “lighter” second module and/or can focus the magnetic field in a manner different than the utilization of a ring magnet or half ring magnets for example as is the case with the embodiments above.

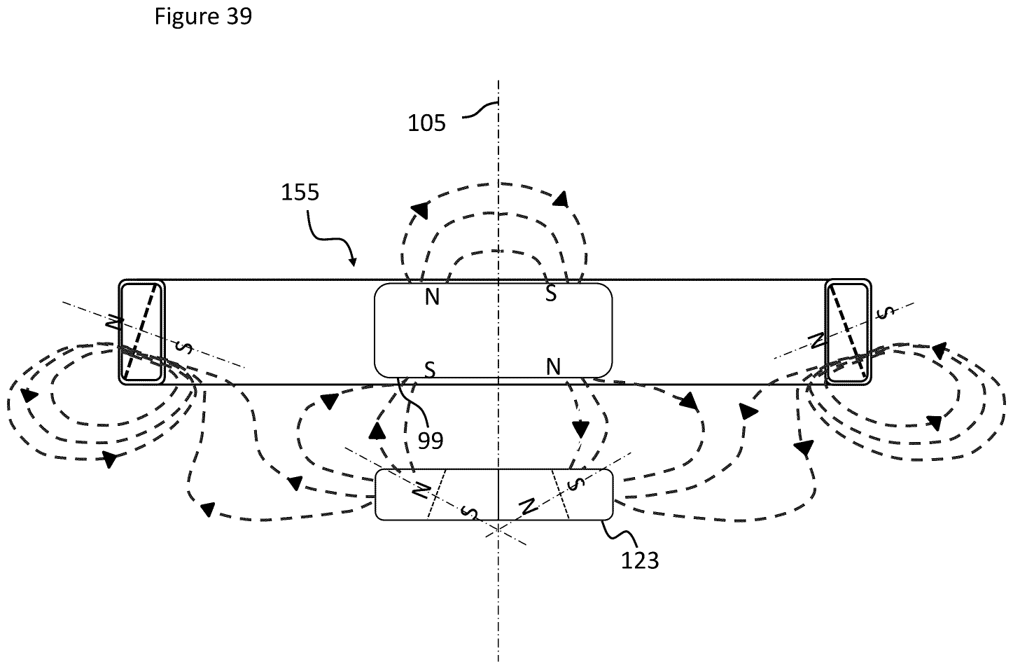

FIG. 39 shows an exemplary magnetic field for the embodiment of FIGS. 34 and 35. This is the field that would lie on a plane passing through the centers of the magnets when the magnets are perfectly aligned with each other (e.g., the external magnet is concentric with the implanted magnet and the outer magnets are exactly 180° opposite each other relative to axis 105 and the polar axes of all of the magnets lie on that plane/the same plane-note that this can be the case with all of the embodiments detailed herein). There is of course a field that is present on either side of the plane. This field would be contoured accordingly.

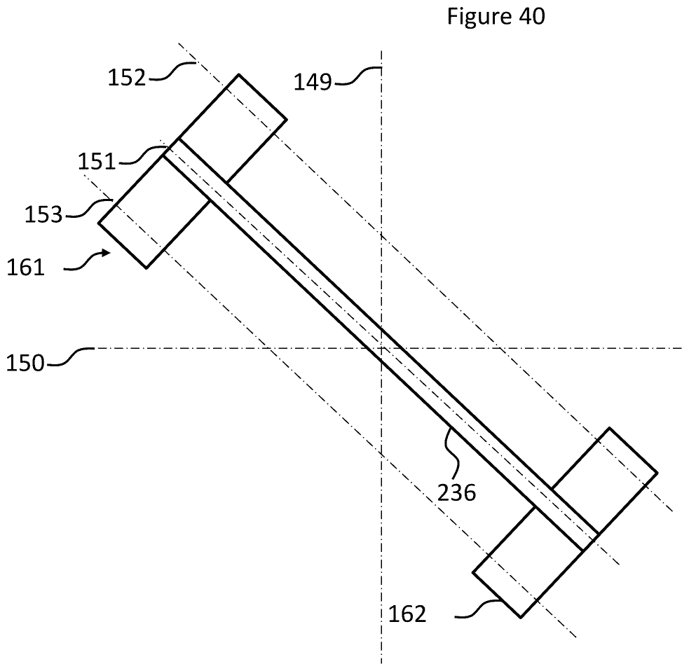

It is briefly noted that while the embodiments detailed above have focused on curved magnets, where the inner circumference of the magnets generally has the same distance from the longitudinal axis 105 with location thereabout, in some alternate embodiments, the magnets can be bar magnets that are not curved, an example of this is depicted in FIG. 40, along with a crossbeam used to hold the magnets relative to one another, instead of a circular structure (note this can be used with the curved magnets as well). That is, straight, non-curved magnets 162 can be utilized in at least some exemplary embodiments. It is noted that while the embodiment of FIG. 40 depicts two magnets, in an alternate embodiment, three or more magnets can be utilized. Moreover, in an exemplary embodiment, a plurality of modules 161 can be utilized in combination with one another, where the crossmembers 236 are configured to interface with one another or otherwise avoid interfering with one another. That is, in an exemplary embodiment, a first module 161 can be applied and if the resulting retention force is not sufficient, a second module can be applied to increase the resulting retention force.

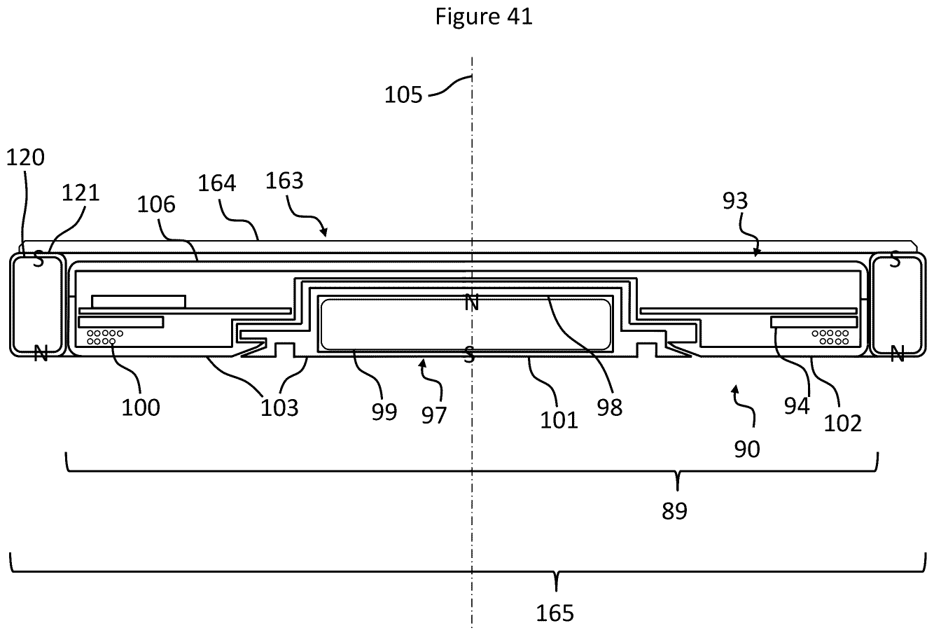

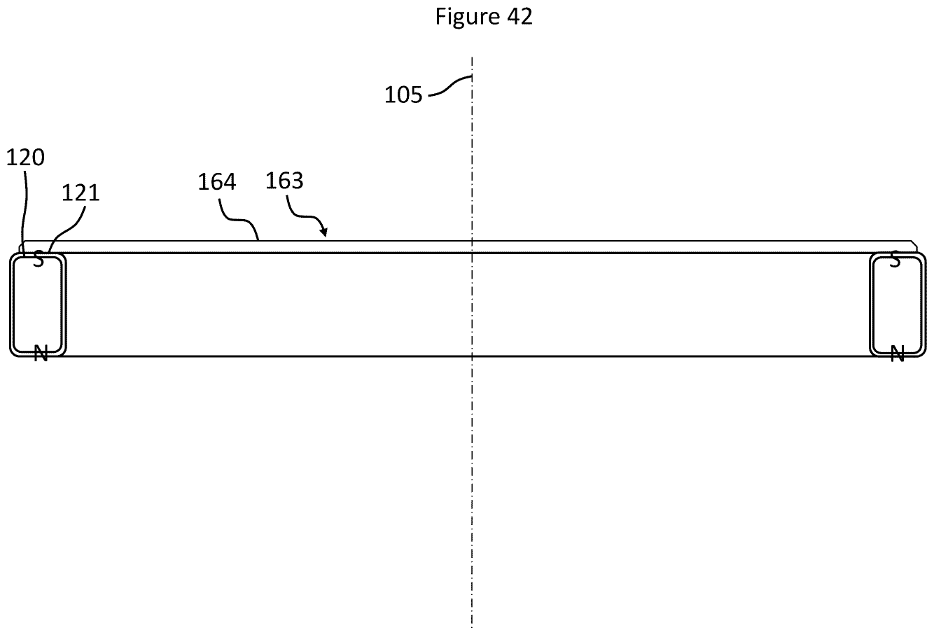

FIGS. 41 and 42 depict an alternate embodiment of a module 163 that fits around the external component 89 (for example) to establish an assembly 165. Here, the module 163 includes the components of module 114, with the addition of cross-connection 164. In an exemplary embodiment, cross connection 164 is utilized to hold separate magnets 120 located in separate housings 121 in place. In an exemplary embodiment, a connection can be established between crossmember 164 and the housing of the external component 89. In an exemplary embodiment, crossmember 164 is a plastic beam that extends from one side of the module 163 to the other side of the module 163. In the embodiment depicted in FIG. 41, there are two magnets 120 symmetrically spaced about the longitudinal axis 105. In an alternate embodiment, there are four magnets 120 symmetrically spaced about the longitudinal axis 105. Indeed, in an exemplary embodiment, these magnets can correspond to magnets 154 of FIG. 31, and crossmember 164 can take the form of a “+” shaped structure when viewed from the frame of reference of FIG. 31. In still alternate embodiments, crossmember 164 can be a plate, such as a circular plate, that extends in all directions about axis 105. Such can be utilized in the case of a ring magnet that contiguously extends about axis 105. That said, such a circular plate can be utilized with respect to the segmented magnets. Still further, such a circular plate can be utilized with respect to segmented magnets, such as the close-pack arrangement of FIG. 31, and a more spread-out arrangement (e.g., 2 magnets, 3 magnets, 4 magnets, 5, 6, 7, 8 or more, that are symmetrically arranged about the longitudinal axis, each subtending an angle of about 10, 15, 20, 25, 30, 35, 40, 45, 50, 55, 60, 65, 70, 75 or more degrees, etc.). Corollary to this is that the cross beam concept can be utilized with the ring magnet that contiguously extends about the longitudinal axis. Any combination can be utilized with any other combination providing that such can be enabled.

Moreover, in an exemplary embodiment, modules 163 can be utilized that have different size magnets/different magnetic fields generated by the magnets, and a given module can be selected depending on the desired/needed retention force.

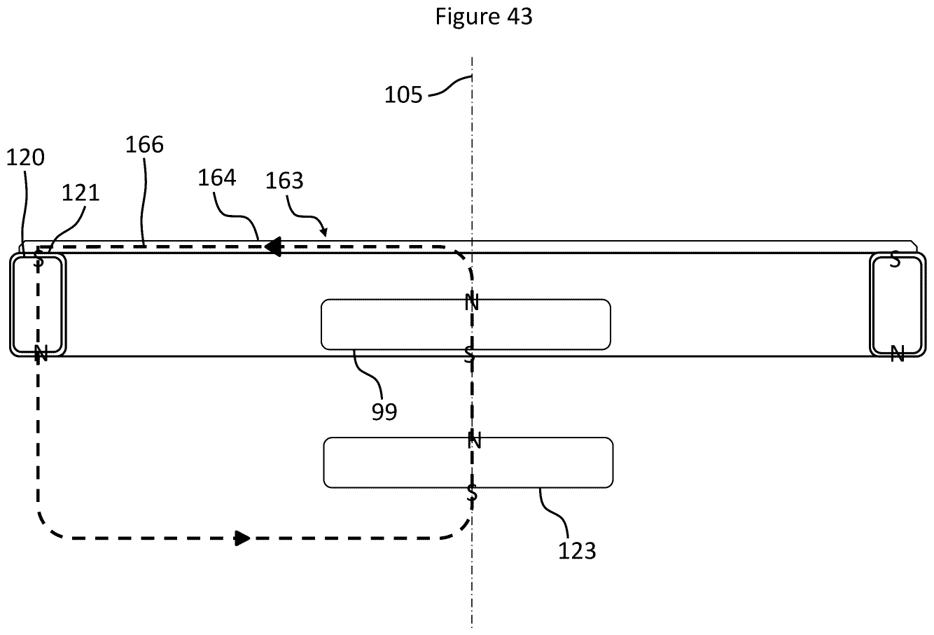

It is noted in an at least some exemplary embodiments, crossmember 164 can be made of a magnetic material that conducts the flux generated by the magnets in a manner different from that which would otherwise be the case if crossmember 164 was made of a non-magnetic material (e.g., such as plastic). It is noted that in an exemplary embodiment, crossmember 164 can comprise a housing made of nonmagnetic material in which is housed a component made of magnetic material. In an exemplary embodiment, soft iron is utilized. Any type of material that will channel the magnetic field generated by the magnets can be utilized. FIG. 43 depicts a portion of an exemplary magnetic field 166 that results from the utilization of the module 163 when attached to an external component 89 when the combination of the two is placed against skin of the recipient. Any type of material that can conduct a magnetic flux in a manner that achieves higher retention force, all other things being equal, can be utilized (along with such that is the case without all other things being equal).

As can be seen in FIG. 43, the upper portions of the resulting magnetic flux 166 are for the most part contained in the crossmember 164, owing to the soft iron in housing 164. The magnetic field is channeled to the pole of the magnet 120. This is as opposed to the scenario seen in FIG. 16, where the magnetic field extends upward a greater distance, or at least the magnetic flux is not as concentrated as is the case in FIG. 43. In an embodiment, element 164 is not a housing, but instead made entirely of soft iron (for example).

Thus, in view of the above, with respect to FIG. 43, in an exemplary embodiment, there is a button sound processor, comprising a first component including a first permanent magnet (e.g., the external component 89 with magnet 99) and second component including soft magnetic material, (e.g., module 163 with crossmember 164), wherein the second component is configured to direct a magnetic flux at least partially generated by the first permanent magnet (and/or the implanted magnet) differently from that which would exist in the absence of the second component via the soft magnetic material. As can be seen, the second component includes a second permanent magnet 120. In an exemplary embodiment, the button sound processor is such that the second component is configured such that when the second component is connected to the first component, the poles of the first permanent magnet are parallel with the poles of the second permanent magnet and the soft magnetic plate channels the magnetic field at least partially generated by the first permanent magnet and the second permanent magnet outboard from the first component. However, as will be detailed below, in an exemplary embodiment where the teachings detailed above with respect to the magnets having a canted polarity are utilized, the poles of the second permanent magnet(s) are not parallel.

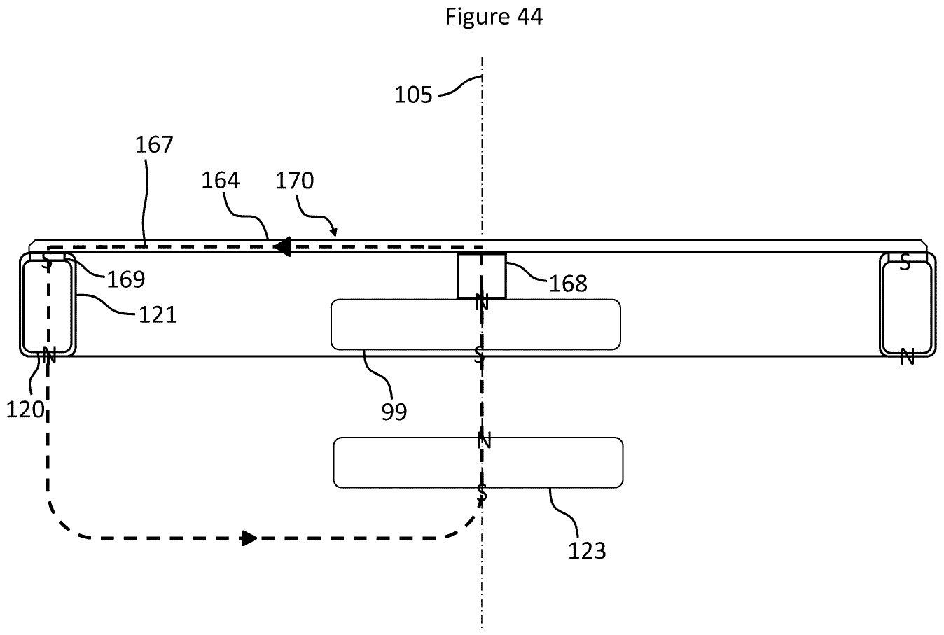

The embodiment of FIG. 43 depicts the crossmember 164 being spaced away from the magnets 99 and 120 with respect to structure that is conducive to channeling or otherwise conducting magnetic flux in a manner different from that which results from structure that creates an air gap. That is, in the embodiment of FIG. 43, there are gaps between the crossmember 164 and the magnets 120 and 99. Referring now to FIG. 44, there is presented an exemplary module 170 that utilizes crossmember 164 in addition to magnetic flux conductors 169 and 168 (which can be in the form of soft iron cylinders or plates, etc.). Here, in an exemplary embodiment where the crossmember 164 is completely made of a magnetic material (or, in an alternate embodiment, where the structure 164 is covered or otherwise sheathed in a nonmagnetic material structure, thus establishing a housing about the structure 164), the magnetic material of structure 164, 168 and 169 is in direct contact with the magnets of the external assembly. That is, there is no air gap between the permanent magnets and the magnetic structure of the module 163. In this regard, in an exemplary embodiment, the housing of the first sub-component 93 and the housing of the second sub-component 97 can have an opening through which structure 168 can pass to reach magnet 99. That said, in an alternative embodiment, there can be air gaps between the magnetic structure and the permanent magnets. By way of example only and not by way of limitation, a housing of the second sub-component 97 can be located between structure 168 and magnet 99. Still further by way of example only and not by way of limitation, a housing wall of the first sub-component 93 can be located between structure 168 and magnet 99. By way of example only and not by way of limitation, an opening can be present in the top of the first sub-component 93 that extends towards the permanent magnet 99 in which is received structure 168. It is also noted that air gaps can exist between the outboard magnets and the crossmember 164, such as may be the case when the outboard magnets are located in a housing of plastic or the like, where the crossmember 164 directly contact the plastic and there is no through structure 169 of magnetic material. Any arrangement that can enable the teachings detailed herein can be utilized in at least some exemplary embodiments.

Thus, in an exemplary embodiment, there is a module that includes the second structure detailed above, where the second structure is a conductor made of soft magnetic material extending from a first side of the first module to a second side of the first module opposite the first side (as seen in FIG. 44), wherein the soft magnetic conductor conducts magnetic flux 167 flowing through a center of the first module to locations outboard of the first module and/or vice versa (depending on the direction of the magnetic flux—in some embodiments, the magnet 99 has a polarity that is reversed from that shown in FIG. 44 as is also the case with magnet 123, and thus the polarity of magnet 120 would also be reversed from that shown in FIG. 44). As seen in FIG. 44 in view of FIG. 6, the second module includes a permanent magnet located at an end of the conductor at an outboard location relative to the first module. Thus, in some embodiments, the module that is attached to the external component 89 has a structure in the form of a high saturation soft magnetic component that concentrates a magnetic flux from the permanent magnet of the second module (which is the case irrespective of the alignment of the north-south pole (north on top or north on bottom).

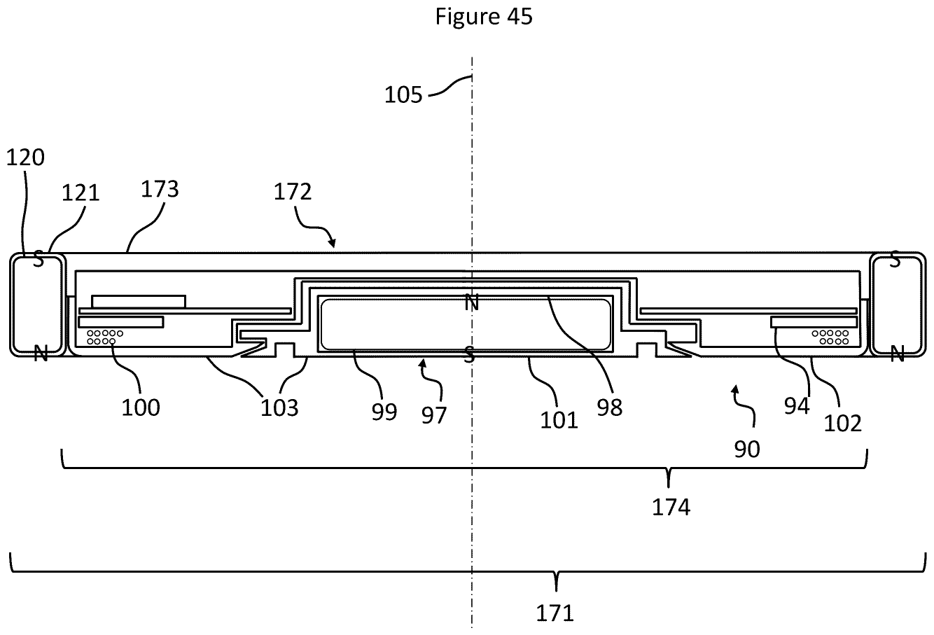

Note also that in some embodiments, the component that includes magnets 120 (or non-permanent magnet magnetic material—more on this below) is a replacement cover for the first sub-component 93. That is, in an exemplary embodiment, the top of the housing of the first sub-component 93 (e.g., the portion of the housing above seam 106) can be removed and replaced with the module 163, where structure 164 is a circular plate that covers the now open housing, thus shielding the internal components in a manner concomitant with the portion of the housing that was removed. FIG. 45 depicts an exemplary embodiment of an external component 171 where the top portion of the housing of the first sub-component 93 removed, thus resulting in external component 174, and replaced with module 172, that includes structure 173 that replaces the housing wall that was removed, which structure connects to the housing 121 including the magnet 120. Indeed, in an exemplary embodiment, module 163 can include the exact same connection components that were utilized with the portion of the housing that was removed to connect that portion of the housing to the bottom portion of the housing of sub-component 93. Thus, in an exemplary embodiment, the soft magnetic plate is a cover of the external component facing away from a skin interfacing side of the external component. That is, in an exemplary embodiment, internal components, such as the electronics of the button sound processor, the processor, a printed circuit board, etc., housed in the housing of the external component, now directly face, without any obstruction or intervening components, the structure of the module 163, whereas previously, these components instead faced the portion of the housing above seam 106 that is now removed. Such can have utilitarian value with respect to enabling the structure 168 to be placed closer to the magnet 99/reducing the width of any air gap that is located between structure 168 and magnet 99, and/or reducing the height/projection away from the skin of the external component. Indeed, even without structure 168, where instead there is only a plate of magnetic material 164 which now establishes the top of the housing, because there is no intervening housing wall, and the plate of magnetic material 164 can now be located where that housing wall was previously located, the width of the air gap is thus reduced (the gap between the plate 164 and the magnet 99). While the embodiment of FIG. 45 depicts a different type of housing wall than that which was present in FIG. 6, in some exemplary embodiments, the module 163 is a combination of the top portion of the housing of the first sub-component 93 (the portion above seam 106), albeit made of a magnetic material that is conducive to channeling the magnetic flux, and the magnets 120 (although in some embodiments, as will be described in greater detail below, the magnets 120 are not present, and, instead, the second component/the module attached to the remaining portion of sub-component 93 is devoid of any permanent magnets). Note also that in some embodiments, the concept of utilizing the module as a cover for the components in first sub-component 93 can be applied without the utilization of a magnetic material to channel the magnetic flux. In this regard, with respect to FIG. 6, the top portion of the housing can be permanently connected to the housing 121 such that removal of the top portion of the housing from the bottom portion of the housing also removes the housing 121, and thus the magnet 120 therein. Additional details of the concept of using the module as a cover will be described below.

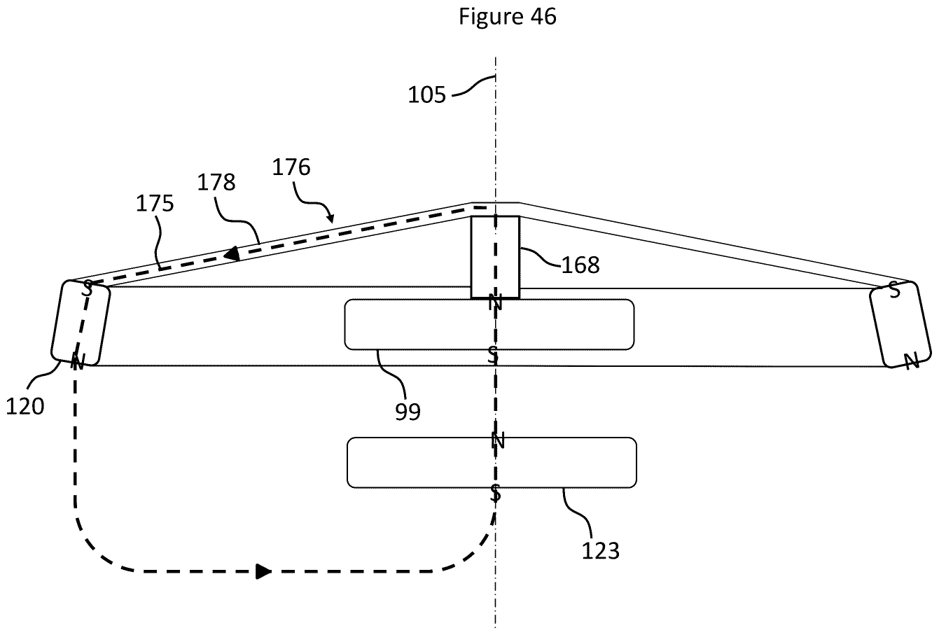

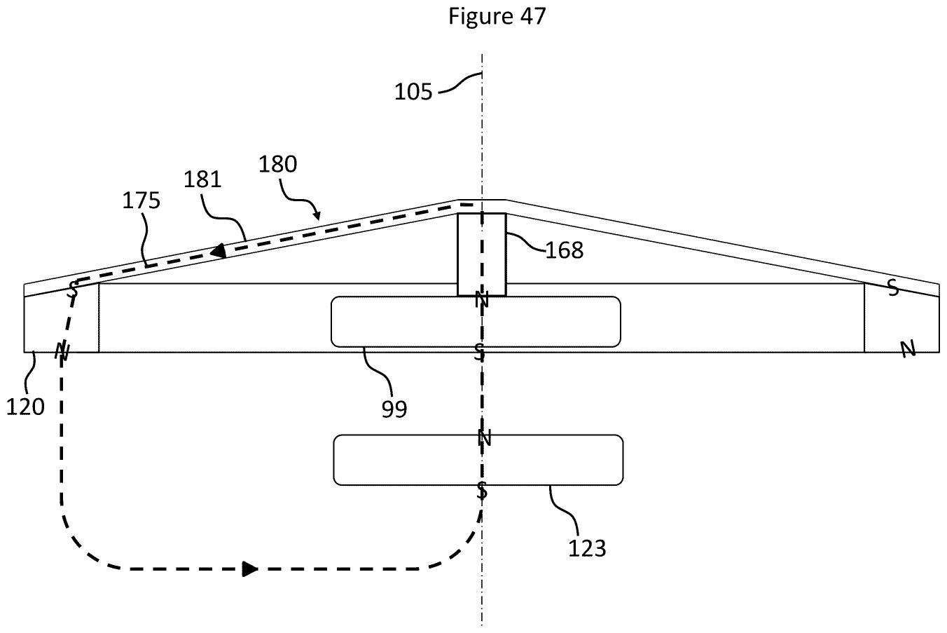

Still further in view of the above, it is again noted that the soft magnetic material can be in the form of a plate extending outboard from the first permanent magnet. In an exemplary embodiment, where the features of the embodiment of FIG. 12 or FIG. 13 are combined with the features of the embodiments of FIGS. 20 and 21, the second permanent magnet has a north-south pole canted relative to a north-south pole of the first permanent magnet. This is seen in FIG. 46, where module 176 includes structure 178 that channels the magnetic flux 175 as is depicted by way of example only and not by way of limitation. In the embodiment of FIG. 46, structure 178 is a thin structure extending outboard from the first permanent magnet 99 to the second permanent magnet 120. In this regard, in an exemplary embodiment, structure 178 is in the form of a shallow truncated cone that directs the magnetic field at least partially generated by the first permanent magnet to the second permanent magnet. (It is noted that the structure 178 also directs the magnetic field at least partially generated by the magnet 123 and the magnets 120, as those collectively establish the magnetic field 175.) FIG. 47 is another embodiment of a module, module 180, where the structure 181 extends downward from component 168, where component 168 is a magnetic component that channels the magnetic flux, and where the structure 181 is also a magnetic component the channels the magnetic flux (thus component 168 channels the magnetic flux to structure 178). Structure 179 channels the magnetic flux to magnet 120 which is canted (or, more accurately, the poles are canted) relative to the longitudinal axis 105. FIG. 47 depicts a similar concept as that of FIG. 46.

It is noted that in some embodiments, component 168 can also be a permanent magnet, as is also the case with component 169. Indeed, in an exemplary embodiment, any structure detailed herein that is disclosed as a magnetic material can be a permanent magnet. It is also noted that in at least some embodiments, any disclosure herein of a permanent magnet constitutes a disclosure of instead a magnetic material that is not a permanent magnet, such as one that conducts magnetic flux, such as a highly permeable soft magnetic material.

In view of the above, it can be seen that in at least some exemplary embodiments, there is a body piece that includes a structure made up of soft magnetic material (entirely or partially) extending between a first permanent magnet and a second permanent magnet (e.g., the crossmember 164 of FIG. 41). In an exemplary embodiment, a portion of the structure between the first permanent magnet and the second permanent magnet can be angled relative to the longitudinal axis at an oblique angle. Still further, an angle between the portion of the structure between the first permanent magnet and the second permanent magnet and the north-south axis of the second permanent magnet can be oblique.

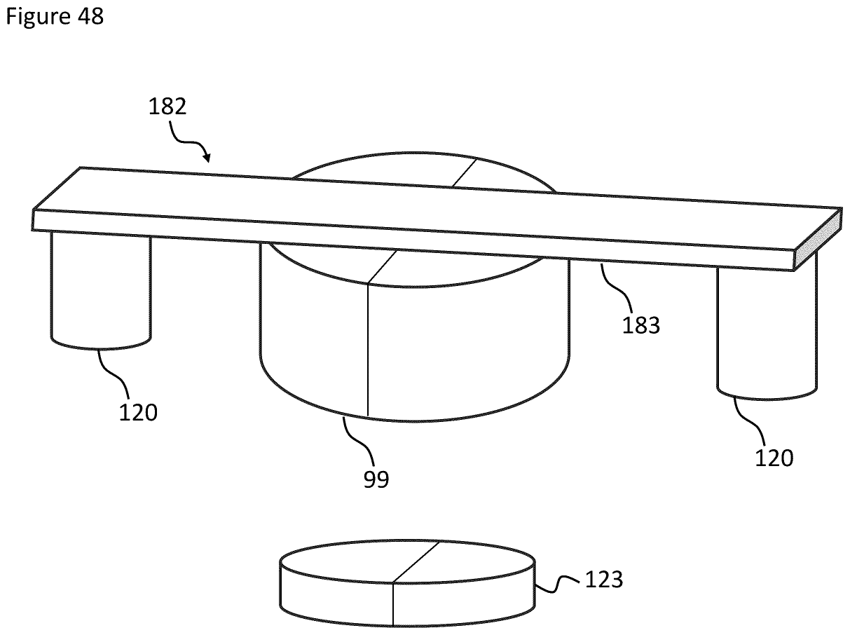

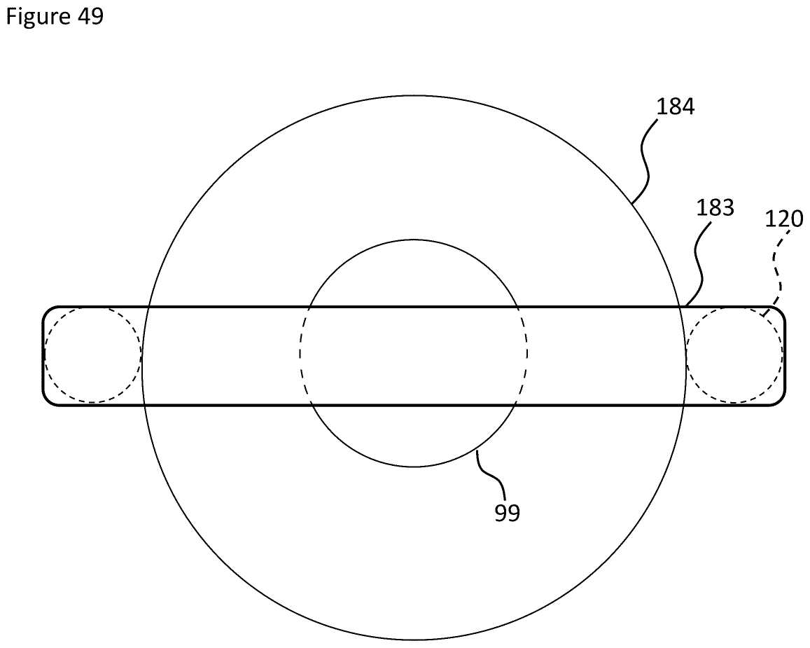

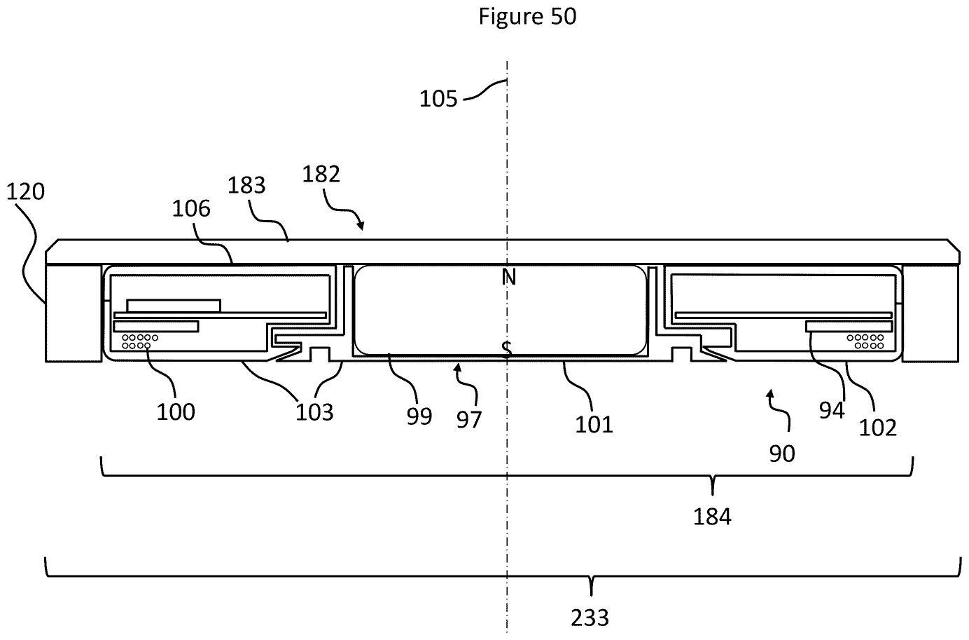

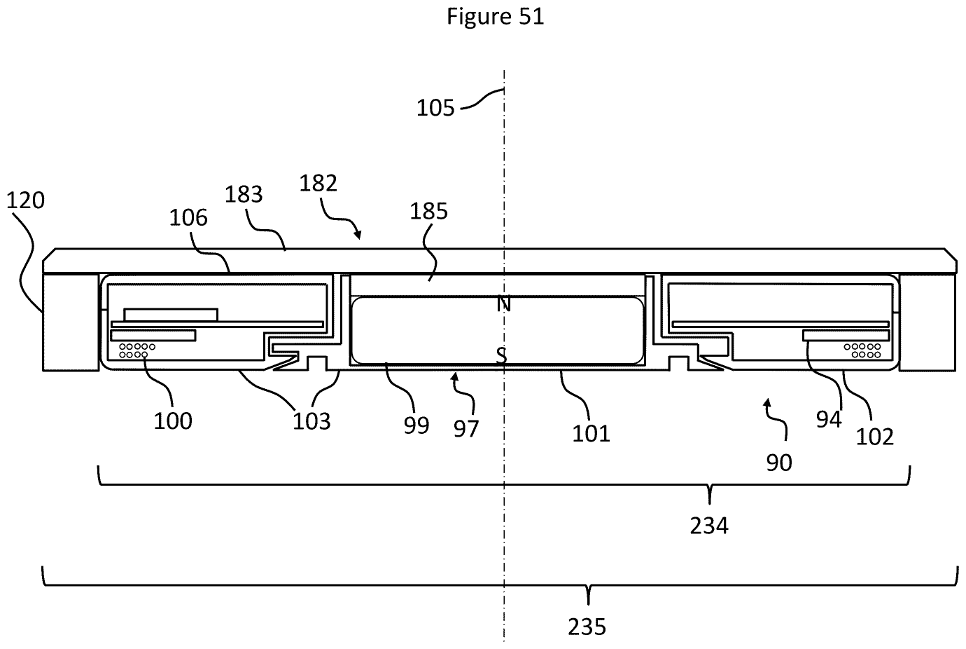

FIG. 48 shows an embodiment of a removable module 182 and the magnets of the external component and the implant, respectively, that utilizes the magnet arrangement of FIG. 35, with the addition of crossbar 183. FIG. 49 shows a top view of the removable module 182 when used with an exemplary external component 184, additional details of which will be described below. Here, crossbar 183 can be made entirely of a magnetic material, such as soft iron, or can be a composite structure where the soft iron or other magnetic material is fully encased or partially encased in a housing made of nonmagnetic material, such as, for example, a polymer. The magnetic material of element 183 can be painted or otherwise provided with a thin coating that does not interfere with magnetic induction or otherwise does not create any significant air gaps between the magnets of the external component. In this regard, in an exemplary embodiment, the magnetic material of crossbar 183 is directly against the magnets of the external component. In an exemplary embodiment where crossbar 183 is a composite component, there could be openings in the housing so that the magnets can directly contact the magnetic material of crossbar 183 and otherwise eliminate any air gaps between the components. By way of example only and not by way of limitation, polymer material can be located on three longitudinal sides of a rectangular beam of magnetic material, and the fourth side could be left polymer free, or at least a portion of the fourth side. Note further that in an embodiment, the side of the external component facing away from the skin side thereof could be open so that the magnet 99 can extend all the way to the magnetic material of crossbar 183. In this regard, for example, if the second module is removed from the first module of the external component, magnet 99 can be seen from the outside of the external component when looking at the recipient. This can be seen in FIG. 50, which shows an exemplary assembly 233 that includes an external component 184 to which is attached the module 182. As seen, magnet 99 extends all the way to contact the crossbeam 183. In an embodiment, a cover or plug could be placed over the magnet 99 for aesthetics so as to “hide” the magnet 99. Thus, in an embodiment, magnet 99 would be taller relative to the other magnets detailed above. That said, in an embodiment, magnet 99 can be of a strength where the bottom surface of the magnet can be located further away from the skin relative to the other embodiments detailed above, the strength compensating for the additional distance of magnet 99 from the implanted magnet. Alternatively, and/or in addition to this, in an exemplary embodiment, a yoke or otherwise a second portion of magnetic material could extend downward away from the exemplary rectangular component of magnetic material of crossbar 183 so that the yoke 185 eliminates an air gap between the magnet and the magnetic material of crossbar 183, as seen in FIG. 51 (more on this in a moment). This would still require a hole in the side of the external component away from the skin facing side so as to enable the yoke to fit into the external component to reach the magnet 99. Again, a plug could be utilized to fill the hole for aesthetic purposes when the crossbar is not being utilized. Also, the crossbar could include a portion that extends outboard of the outermost boundaries of the magnet 99, and otherwise the hole in the external component so as to “hide” the yoke and/or the magnet so that these components cannot be readily seen from the outside of the external component when looking at the recipient when the external component is worn by the recipient.

Note further that in an exemplary embodiment, the magnetic material yoke can be a permanent fixture of the external component, and can be a spacer that is located above the magnet 99 even when the second module is not being utilized. In the exterior of the external component on the side facing away from the skin can be designed and configured so that the spacer sticks through the housing. The point is that in at least some exemplary embodiments, there is no airgap.

But in some embodiments, there is an airgap, albeit filled with a nonmagnetic material, such as seen in FIG. 51, between the magnet 99 and the magnetic material of the crossbar. In this regard, FIG. 51 shows an assembly 235 which includes an external component 234 that includes the permanent magnet 99 of the external component 234, above which is located spacer 185, which is made of a polymer material and otherwise establishes an airgap between magnet 99 and the crossbar 183 or otherwise the magnetic material of crossbar 183 (but in an alternate embodiment, where an airgap is not desired, element 185 could be magnetic material). This can serve as a spacer for the magnet 99 that otherwise holds the magnet 99 in place with respect to the longitudinal direction. In an embodiment, the spacer 185 can provide an aesthetic feature to cover the hole for the magnet 99. Also, the spacer 185 could be removable if a larger magnet is desired for example, and thus a different spacer 185 could be utilized, or no spacer could be utilized, such as where the magnet 99 contacts the crossbar.

FIG. 52 shows another exemplary embodiment where a spacer between the magnet 99 and the bottom of the housing for the magnet, where the magnet 99 abuts the magnetic material of the crossbar. In this regard, FIG. 52 shows an assembly 232 which includes an external component 231 that includes the permanent magnet 99 of the external component 231, below which is located spacer 262, which is made of a polymer material. But in an alternate embodiment, element 262 could be magnetic material so as to channel the magnetic flux in a manner desired. As seen, the spacer (or yoke) 4545 need not have a width that is the same as that of the magnet 99. If a polymer spacer is used, size is based on structural need. If a magnetic material spacer, size is based on both structural and magnetic permeability need (in embodiments, there is sufficient magnetic material to avoid magnetic saturation).

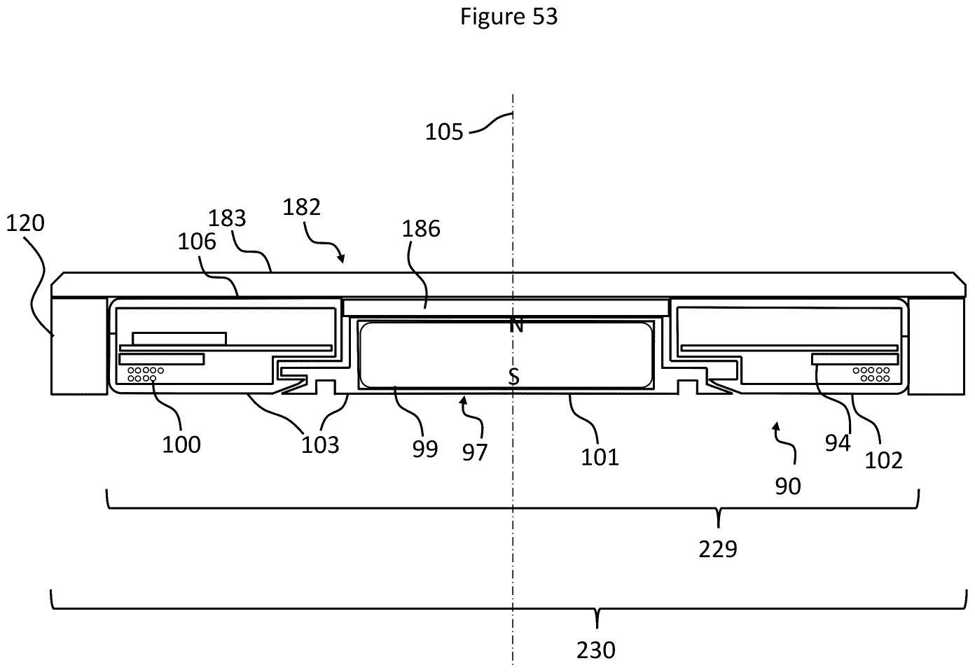

FIG. 53 shows another exemplary embodiment of an assembly 230 that includes an external component 229 to which is attached module 182. Here, the housing that houses the magnet 99 completely encases the magnet, and thus completely prevents the magnet 99 from contacting the magnetic material of the crossbeam 183 or any part of the crossbeam 183 for that matter. Shown is a spacer 186 that is located across the opening so as to aesthetically cover the opening in a manner concomitant with the spacer detailed above. This likewise establishes an airgap, albeit an airgap that includes two separate components between the magnetic material of the crossbeam in the magnet, which two separate components are nonmagnetic. But note that in an embodiment, the spacer 186 or the spacer 4545, or what have you, could be magnetic material or could be a magnet if additional retention forces desired. This can reduce the airgap accordingly.

In an exemplary embodiment, the flanking magnets have dimensions of a cylinder of a height of less than, greater than, and/or equal to 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, or 19 mm, or any values or range of values therebetween in 0.05 mm increments. The radius of the cylinder can be less than, greater than and/or equal to 0.25, 0.5, 0.75, 1, 1.25, 1.5, 1.75, 2, 2.25, 2.5, 2.75 3, 3.5, 4, 4.5, 5, 5.5, 6, 6.5, 7, 7.5 8 mm, or any values or range of values therebetween in 0.05 mm increments. The spatial locations of the cylinder magnets can be those detailed above with respect to the other embodiments for purposes of textual economy. However, in an embodiment, as measured from the longitudinal axes of the flanking magnets, the magnets are less than, greater than and/or equal to 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 28, 29, 30, 31, 32, 33, 34, 35, 36, 37, 38, 39, 40, 41, 42, 43, 44, 45, 46, 27, 48, 49, 50, 51, 52, 53, or 54 mm, or any values or range of values therebetween in 0.05 mm increments. The polar axes of the magnets can be any of those detailed above by way of reference.

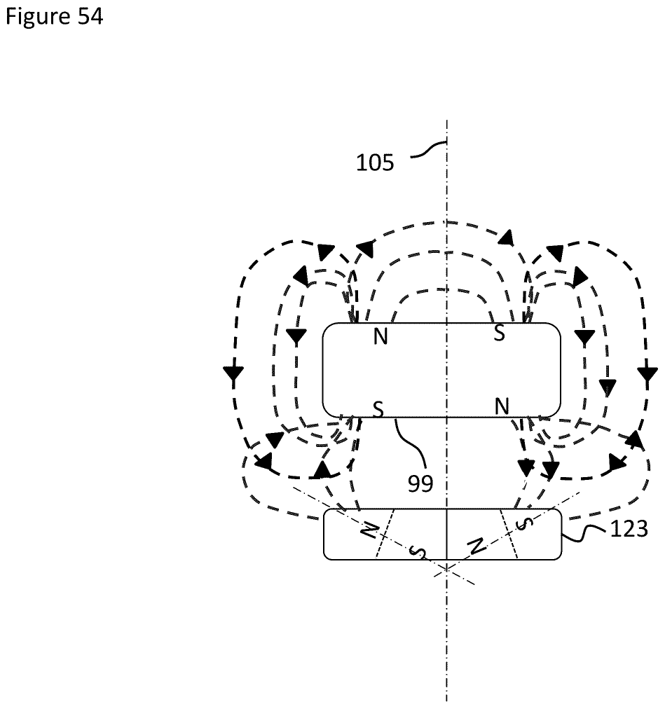

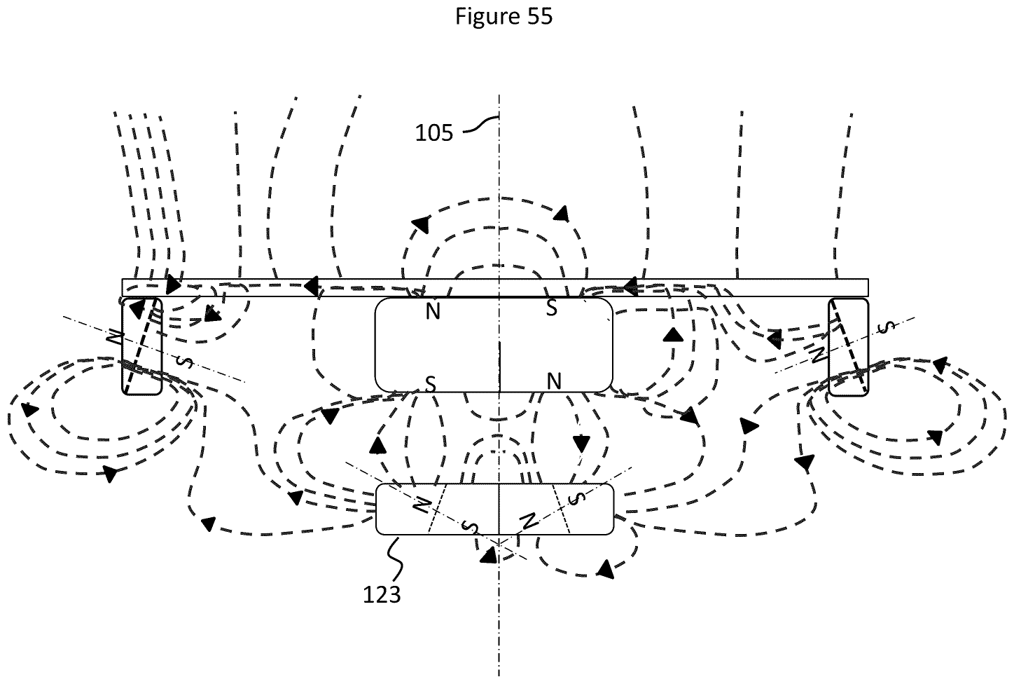

FIG. 54 shows, by way of example and not by way of limitation, the paths of the magnetic flux/field that result from the embodiment of FIG. 50, when the component 184 for example is used without the module/component 182. The field is presented as lying on a plane that is through the center of the magnets where the axes of the magnetic poles lie on that plane (concomitant with the description above with respect to FIG. 39). As seen, the magnetic fluxes are symmetric about the longitudinal axis 105. Conversely, FIG. 55 shows by way of example and not by way of limitation the paths of the magnetic field that results from the embodiment of FIG. 50, when the component 184 for example is used with the module/component 182. The field is presented as lying on a plane that is through the center of the magnets where the axes of the magnetic poles lie on that plane (concomitant with the description above with respect to FIG. 39). As seen, the magnetic fields are asymmetric about the longitudinal axis 105. Relative densities are shown (e.g., more lines indicate higher density). Only flux lines/field lines that are utilitarian to provide a sufficient teaching of the concept are presented.

In an exemplary embodiment, retention force can vary by less than, greater than and/or equal to 2, 3, 4, 5, 6, 7, 8, 9, 10, 11, 12, 13, 14, 15, 15, 17, 18, 19, 20, 21, 22, 23, 24, 25, 26, 27, 28, 29, or 30%, or any value or range of values therebetween in 0.1% increments with varying angle of magnetization, all other things being equal (e.g., same magnet mass, same distance of external component to implant, same magnet spacing, etc.), such as, for example, applying one of the magnetization angles detailed herein as compared to applying another of the magnetization angles detailed herein, where the above-noted variation is based on the lower force as the baseline.

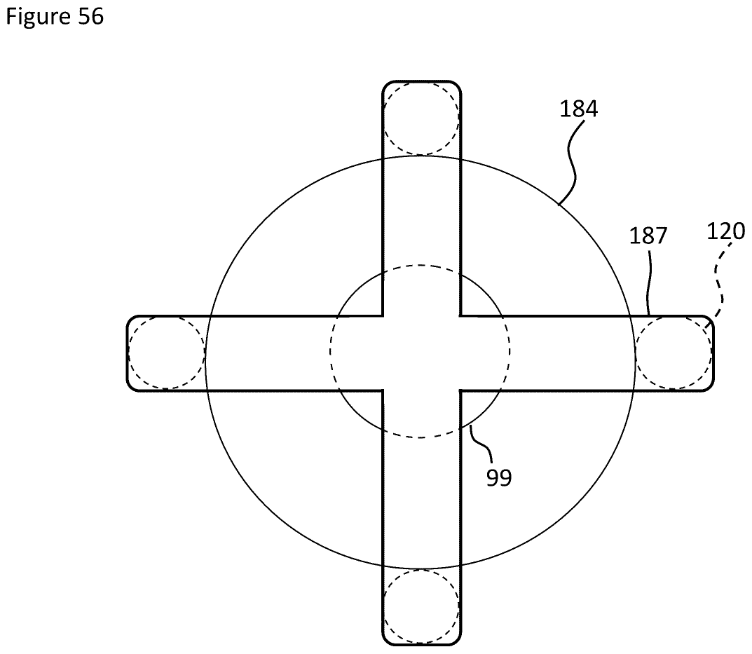

FIG. 56 shows an exemplary embodiment of a module 187 that includes four (4) magnets 120 supported by a cross structure as seen. Embodiments can include 2, 3, 4, 5, 6, 7, 8, 9, 10, 11, 12, 13, 14, 15, 16, 17, 18, 19, or 20, or more magnets 120, or any value or range of values therebetween in 1 increment. In an embodiment, the magnets are arranged symmetrically about the longitudinal axis 105, but in other embodiments, this is not the case.

In view of the above, in an embodiment, there is an off-the-ear (OTE) processor (sound processor and/or light processor, by way of example) by way of example only and not by way of limitation, there is an apparatus, such as by way of example, the external component assembly 113 of FIG. 13, with the combination of, by way of example, external component 89 of FIG. 6 when used with removable module 114 of FIG. 14 or the assembly 232 of FIG. 52 for example. But other removable components 114 can be utilized such as, by way of example only and not by way of limitation, the removable module 146 of FIG. 28 by way of example, or the removable component 148 of FIG. 29 by way of example. Consistent with the teachings herein, the OTE processor can include a first component including a first permanent magnet (e.g., magnet 99) and a second component including a second permanent magnet (e.g., magnet 120). Consistent with the teachings herein, the second component is configured to direct a magnetic field at least partially generated by the first permanent magnet differently from that which would exist in the absence of the second component via the second permanent magnet. In this embodiment, the second permanent magnet is a cylindrical magnet arrangement, but in other embodiments, this can be a prismed arrangement or a cube arrangement.

In an embodiment, the first permanent magnet is a straight four-pole magnet, but in other embodiments, it can be an angled four-pole magnet. In an embodiment, the second permanent magnet is an angled two-pole magnet, but in another embodiment, it is a straight poled magnet. in an embodiment, the second component includes a third permanent magnet that is an angled or straight two-pole magnet.

In an embodiment, with respect to a plane normal to a longitudinal axis of the OTE processor, a north polarity pole of the second permanent magnet is on a same side of the plane as a north polarity pole of the third permanent magnet. With reference to FIG. 24, there is a plane 140 that meets the normality requirements just detailed. As seen, the north pole of the left magnet is on one side of the plane 140, and the north pole of the right magnet is on the same side of the plane. In an embodiment, with respect to a plane normal to a longitudinal axis of the OTE processor, a north polarity pole of the second permanent magnet is on an opposite side of the plane from a north polarity pole of the third permanent magnet. With reference to FIG. 28, there is a plane 147 that meets the normality requirements just detailed. As seen, the north pole of the left magnet is on one side of the plane 147, and the north pole of the right magnet is on the opposite side of the plane. This as contrasted to, for example, the embodiment of FIG. 24, where the poles are on the same side of plane 140.

In an embodiment, the OTE processor includes only cylindrical magnet arrangements. In an embodiment, the OTE processor includes cylindrical magnet arrangement(s) and non-cylindrical magnet arrangement(s). In an embodiment, the OTE processor is devoid of cylindrical magnet arrangement(s). In some embodiments, the first permanent magnet is a straight four-pole magnet, and the second permanent magnet is a straight two-pole magnet and the second component includes a third permanent magnet that is a straight two-pole magnet. In an embodiment, the second permanent magnet is canted relative to a longitudinal axis of the OTE sound processor (see the embodiment of FIG. 28, as opposed to the embodiment of FIG. 29), and the third permanent magnet is canted relative to the longitudinal axis.

And consistent with the teachings above, where the OTE processor is used with an implantable component, there is a system, comprising an OTE processor as detailed herein by way of example, and an implantable component, wherein the implantable component includes a four-pole magnet arrangement (straight in some embodiments and angled in others).

In an embodiment, the second component includes a third permanent magnet and a fourth permanent magnet, the third permanent magnet and the fourth permanent magnet being cylindrical arrangements. In an embodiment, the second component includes a third permanent magnet and a fourth permanent magnet and a fifth permanent magnet, the third permanent magnet and the fourth permanent magnet and the fifth permanent magnet being cylindrical arrangements.

In an embodiment, there is a system, comprising an external component including a magnet arrangement and an implantable component including a magnet arrangement. See the embodiment of, for example, the assembly 235 when used with an implantable portion of the cochlear implant or retinal prosthesis, etc. In this exemplary embodiment, a resulting magnetic field path lying on a plane normal to a boundary between the magnet arrangement of the external component and passing through the magnet arrangement of the implantable component is asymmetric. This is seen, for example, with respect to FIG. 55, as noted above. In an embodiment, the magnet arrangement of the external component is a four pole magnet arrangement and the magnet arrangement of the implantable component is a four pole magnet arrangement. In an embodiment, the magnet arrangement of the external component is not a four pole magnet arrangement and the magnet arrangement of the implantable component is not a four pole magnet arrangement. In an embodiment, the four pole magnet arrangement of the external component is a straight four pole magnet arrangement and the four pole magnet arrangement of the implantable component is a straight four pole magnet arrangement.

In an embodiment, the four pole magnet arrangement of the external component is an angled four pole magnet arrangement and the four pole magnet arrangement of the implantable component is an angled four pole magnet arrangement. In an embodiment, the four pole magnet arrangement of the external component is an angled four pole magnet arrangement and the four pole magnet arrangement of the implantable component is a straight four pole magnet arrangement. In an embodiment, the four pole magnet arrangement of the external component is a straight four pole magnet arrangement and the four pole magnet arrangement of the implantable component is an angled four pole magnet arrangement.

By way of example only, the external component includes a first sub-component (e.g., element 234 of FIG. 51) and a second sub-component (e.g., module 182 of FIG. 51), the first sub-component including a first sub-magnet arrangement (e.g., magnet 99) of the magnet arrangement of the external component, and the second sub-component includes a second sub-magnet arrangement (e.g., magnet 120) of the magnet arrangement of the external component.

In an embodiment, the system is configured so that if the second sub-component is removed from the system, a resulting magnetic field path lying on the plane normal to the boundary between the magnet arrangement of the external component and passing through the magnet arrangement of the implantable component is symmetric. In an embodiment, a resulting magnetic field path lying on a plane normal to a boundary of the magnet arrangement of the external component that faces the magnet arrangement of the implantable component when the external component is used with the implantable component and passes through the magnet arrangement of the implantable component is asymmetric. In the interests of textual economy, any reference to a plane on which there is a magnetic field path can be this plane (or another plane), providing that the art enables such, unless otherwise noted. This feature on the plane is seen, by way of example, in FIG. 54, where only external component 89 is in magnetic communication with the implanted magnet 123. And when the removable module is added to the component 89, and placed into magnetic communication with magnet 123, the field path of FIG. 55 results in this exemplary embodiment, thus changing from a symmetrical path to an asymmetrical path.

By way of example and not by way of limitation, in an exemplary embodiment, the second sub-component includes a first magnet and a second magnet spaced away from the first magnet and the second sub-component includes a yoke extending from the first magnet to the second magnet (the yoke can be cross-bar 183 for example), and the second sub-component is configured so that the yoke extends across and over the first sub-magnet arrangement when the second sub-component is fitted onto the first sub-component. This is shown in FIG. 52 for example. And consistent with the embodiment of FIG. 52, the yoke directly contacts the first magnet and the second magnet and the first sub-magnet arrangement when the second sub-component is fitted onto the first sub-component. Conversely, consistent with the embodiment of FIG. 51, the yoke directly contacts the first magnet and the second magnet but not the first sub-magnet arrangement when the second sub-component is fitted onto the first sub-component.

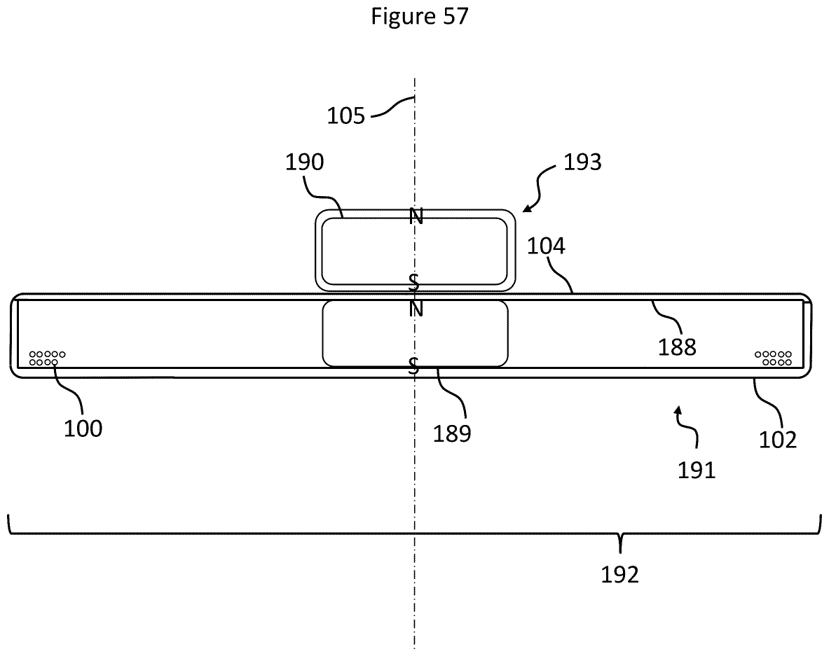

FIG. 57 depicts another exemplary embodiment of an external component assembly 192 that includes an external component 191 to which is attached a module 193 in which is located a magnet 190 located in a housing. Here, this second module that is attached to the first module in the form of the external component 191 is located on an opposite side of the first module from the skin interfacing side of the first module. As can be seen, the second module 193 is located on the top of the external component 191.

In the embodiment depicted in FIG. 57, the module 193 is attached to the removable component 191 via a magnetic attraction between the magnet 190 and the magnet 189. That said, in some alternate embodiments, in addition to this magnetic attraction, other types of connectors are utilized, such as a snap coupling or the like. Any arrangement that can enable the module 193 to be connected to the external component 191 can be utilized in at least some exemplary embodiments.

Briefly, it is noted that this is an exemplary embodiment where the magnet 189 is generally unremovable, as opposed to the embodiment of FIG. 6 above. That said, in an exemplary embodiment, the top of the housing in which the magnet 189 is located, housing wall 188 can be removed so that the magnet 189 can be replaced with a different size and/or strength magnet. (Some additional features of this will be described in greater detail below.) In any event, in some embodiments the housing wall 188 is welded to the rest of the housing, thus making the magnet 189 unremovable. The point is that FIG. 57 presents an embodiment that differs from the embodiment of FIG. 6 with respect to the removability and the changeability associated with the magnet inside the external component. That said, it is also noted that the embodiment of FIG. 6 differs from the embodiment of FIG. 57 in that with respect to embodiments where the magnet is removable, magnet 189 is removed from the side away from surface 102 (away from the skin interfacing side). Thus, the embodiments of the teachings detailed herein in at least some instances can be practiced with different types of configurations vis-à-vis the external component including the coil 100 and other portions thereof.

In an exemplary embodiment, the magnet 190 adds to the overall magnetic flux generated by the external components, and thus increases the retention force between the external component in the implanted component.

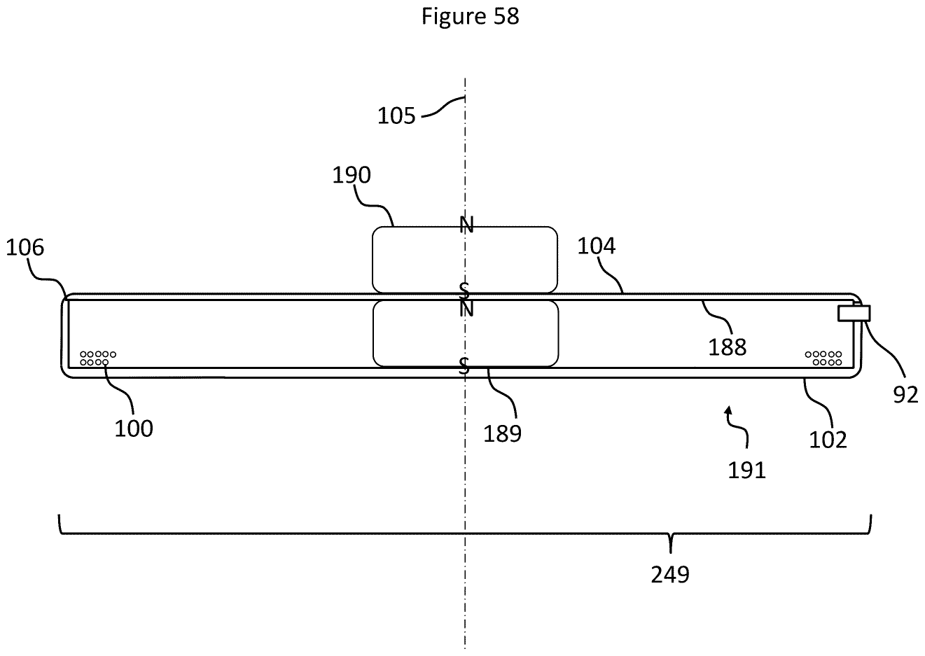

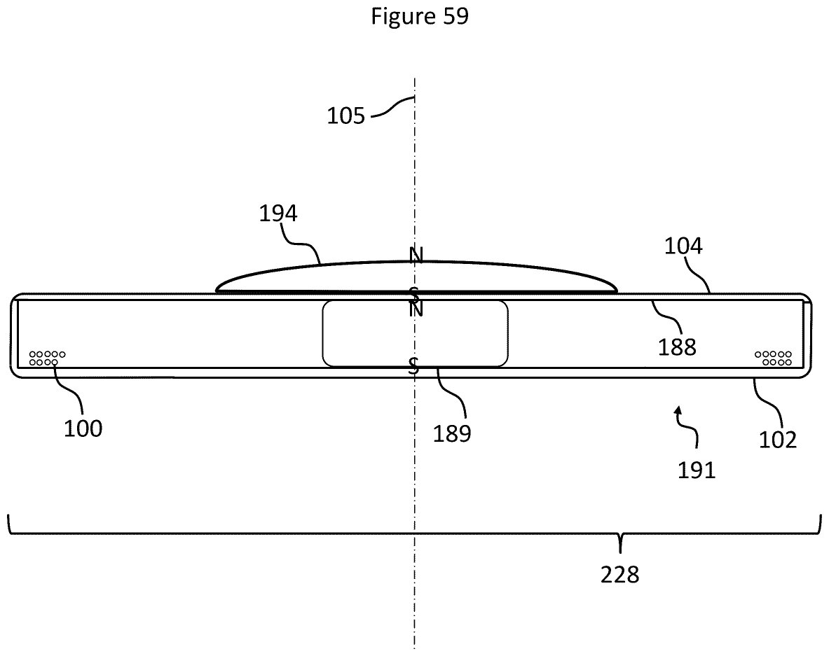

While the embodiment of FIG. 57 depicts a magnet 190 located in a housing, in an alternate embodiment, instead of a modular form, there is just magnet 190 that is attached to the upper surface 104 of the external component 191. This is seen in FIG. 58, where assembly 249 includes the external component 191 two which is attached magnet 190. Again, in an exemplary embodiment, simple magnetic attraction between the magnet 189 and the magnet 190 is utilized to hold magnet 190 and place. It is noted that in at least some exemplary embodiments, where a non-modular format is utilized, magnet 190 can be painted a color that is generally the same as if not the same as the top surface 104 so that the magnet 190 is not as distinct. It is also noted that while the embodiment of FIG. 57 depicts a circular magnet having an outer circumference that is generally constant along the length of the longitudinal axis 105, in alternative embodiments, a magnet that is more “streamlined” or “contoured” can be utilized, such as that seen in FIG. 59, where external component assembly 228 is established via the use of the external component 191 to which is attached magnet 194 which is rotationally symmetric about axis 105 and is less pronounced than the module of FIG. 57 or even the magnet of FIG. 58.

It is noted that the concept of attaching a magnet to the top of the external component, whether a magnet is in a modularized form or a simple magnet by itself, can also be applied to the embodiment of FIG. 6 and variations thereof.

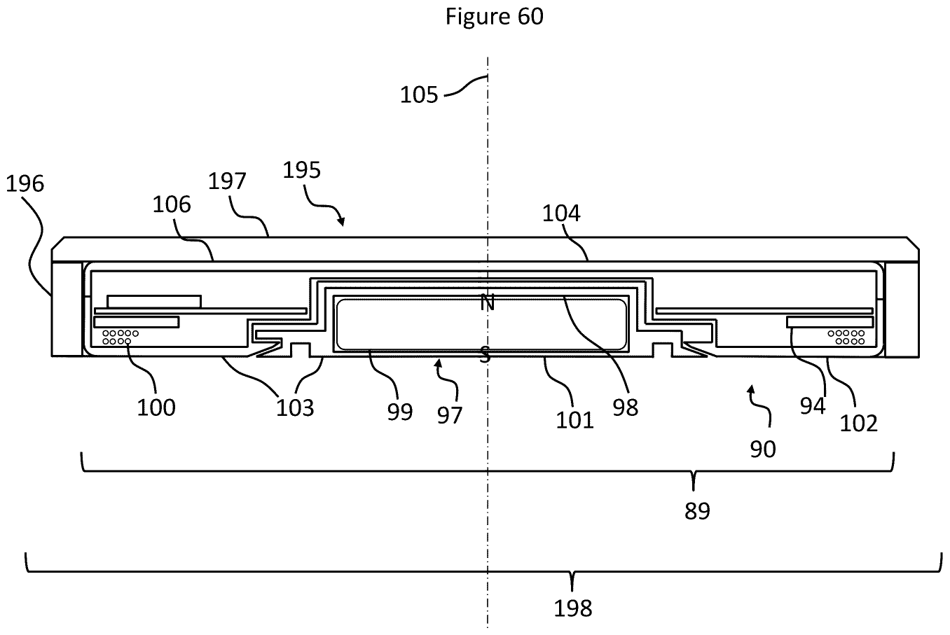

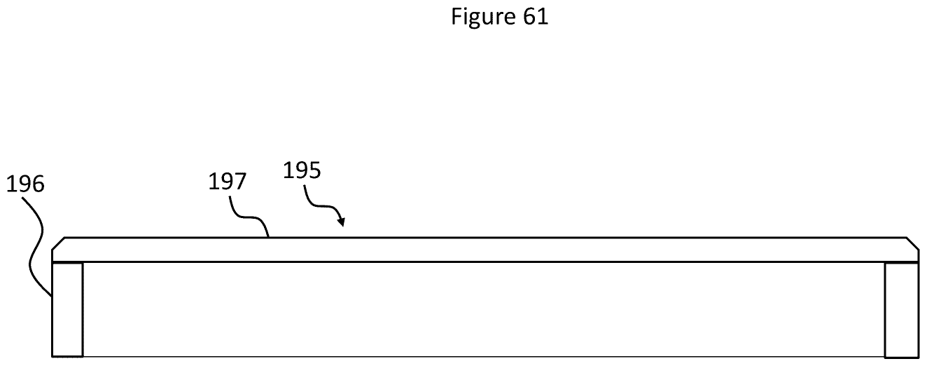

As noted above, in some embodiments, the module that is attached to the external component 89 does not necessarily include a permanent magnet. Instead, in an exemplary embodiment, the application of conductive magnetic material to conduct the flux generated by magnet 99 is the driver for utilizing an additional component with external component 89. To this end, FIGS. 61 and 60 depict an exemplary component 195 that includes a crossmember 197 made out of highly permeable magnetic material to which is attached ring 196 which is also made out of highly permeable magnetic material (the same material as crossmember 197 or a different material). While the embodiments of FIGS. 60 and 61 depict a ring and a plate respectively, as components of the sidewalls 196 and a crossmember 197, in an alternate embodiment, consistent with the different embodiments with respect to the outboard magnets, sidewall 196 can be in the form of segmented sections symmetrically arranged about the longitudinal axis 105, and crossmember 197 can be an elongate structure that extends from one side to the other side, as opposed to a circular plate. Any arrangement that can enable the channeling of the magnetic flux generated by the various magnets can be utilized in at least some exemplary embodiments. In an exemplary embodiment, because of the channeling of the magnetic flux achieved by the magnetic material of component 195, the resulting magnetic force between magnet 99 and the implanted magnet 123 can be increased relative to that which exists without the component 195, all other things being equal. Thus, in an exemplary embodiment, there is a component that attaches to the external component 89 resulting in an assembly 198, where the component that is attached to the external component 89 is devoid of any permanent magnets. In an exemplary embodiment, the component can be entirely made of the magnetic material that is utilized to channel the magnetic flux, while in an alternate embodiment, the component can be a magnetic material that is partially or completely housed in a covering of nonmagnetic material (e.g. plastic).

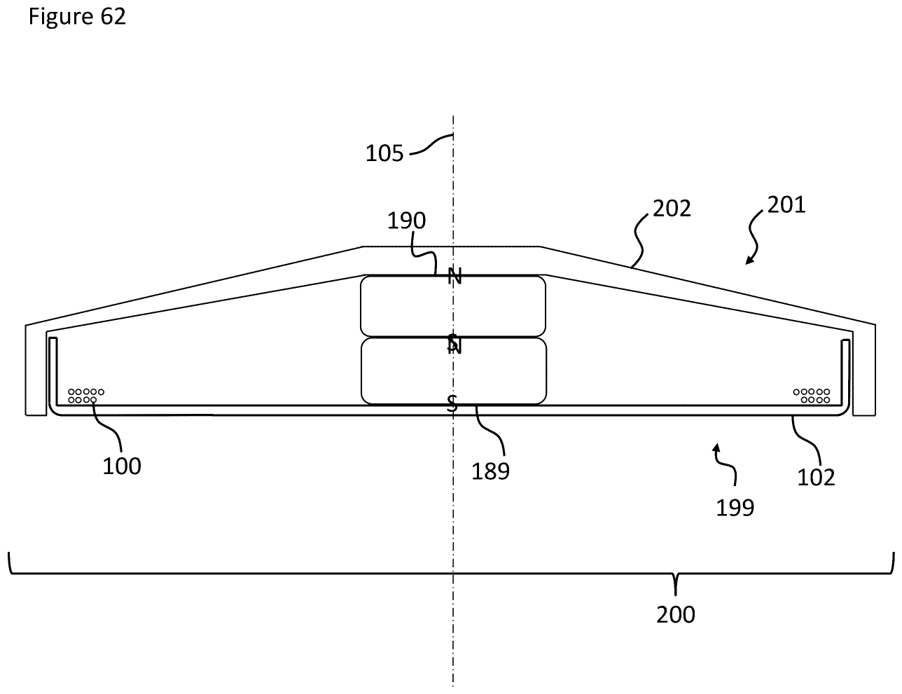

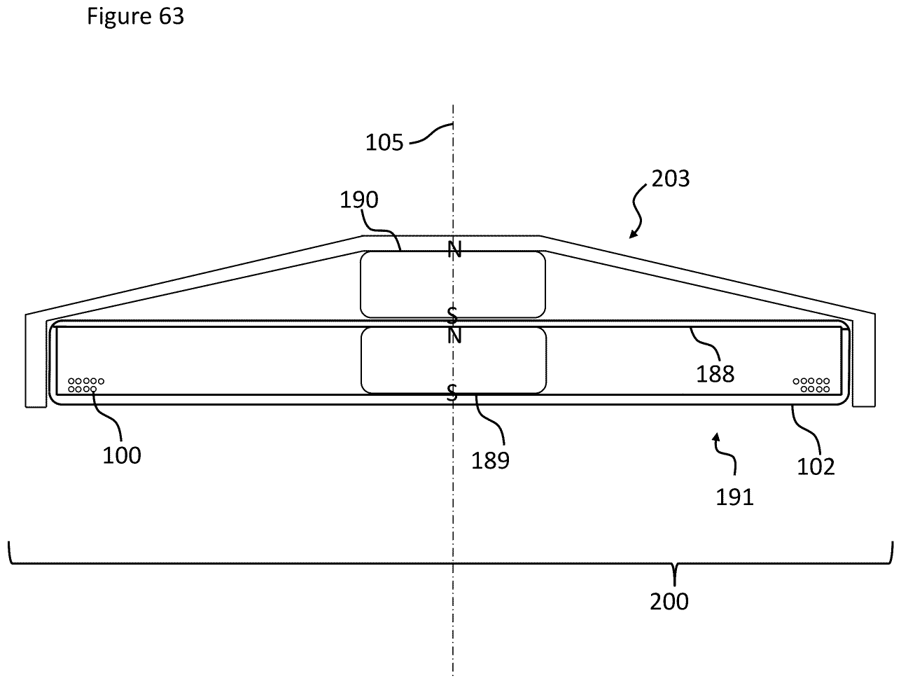

It is also noted that the embodiments of FIGS. 60 and 61 can be combined with a permanent magnet. FIG. 62 depicts an exemplary external component 200 that includes component 201 which includes a shell 202 made of a magnetic material along with a magnet 190 that is essentially permanently attached to shell 202. FIG. 62 also presents an exemplary embodiment where the component 201 forms part of a cover for the external component, here represented by component 199, which includes the coil 100 and magnet 189 along with in some embodiments additional circuitry for the button sound processor. Collectively, component 199 and component 201 form assembly 200. It is noted that in some embodiments, the magnet 190 can be replaced with a component made out of magnetic material but that is not a permanent magnet so as to channel the flux generated by magnet 189. It is also noted that the embodiment of FIG. 62can be practiced where there is a housing wall placed between magnet 190 and magnet 189, which housing wall extends to the sidewalls of the component 199 FIG. 63 depicts an alternate embodiment utilizing the concept of FIG. 62, except that module 203 is designed to accommodate the fact that there is a housing wall 188 located between magnet 189 and magnet 190. In this regard, in an exemplary embodiment, the module of FIG. 62 replaces the cover of the external component 191, while the embodiment of FIG. 63 creates a new cover that is utilized with the cover of external component 191.

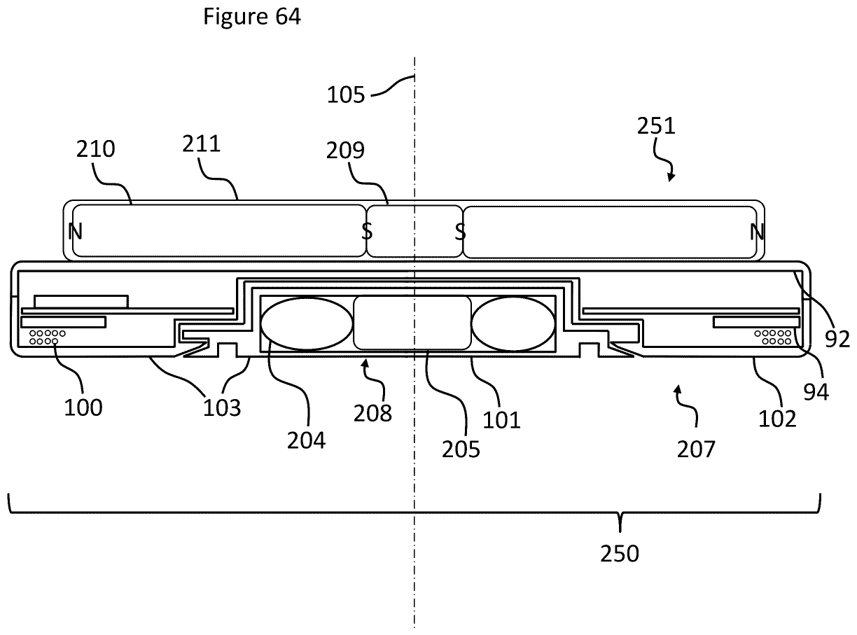

FIG. 64 depicts yet another exemplary embodiment of an external assembly, assembly 250, which includes a module 251 attached to the external component 207, which corresponds to external component 89 detailed above, except that the second sub-component 97 has been replaced with a new sub-component 208. Sub-component 208 includes a ferromagnetic material body 205 in the form of a circular piece of soft magnetic material located in the housing of sub-component 208. Spacers 204 are positioned to center component 205 along the longitudinal axis 105/in the center of sub-component 208. In an exemplary embodiment, the sub-component 97 including the magnet has been removed, and in its place, new sub-component 208 has been provided. (Briefly, while the embodiments detailed here are directed towards the elimination of a permanent magnet and the replacement thereof by a magnetic component that is not a permanent magnet, it is to be appreciated that in an alternate embodiment, the new sub-component 208 could also include a permanent magnet in place of component 205, which permanent magnet can be smaller than the permanent magnet previously present, so as to reduce the generated magnetic field generated by the external component.) The component 205 in the form of a circular piece of soft magnetic material is configured to channel the magnetic flux generated by the implanted magnet 123 and, in some embodiments, where the module 251 is utilized, the permanent magnet thereof in addition to the flux generated by magnet 123. In this regard, it can be seen that module 251 includes permanent magnet 210, which is a doughnut magnet, that includes a hole therethrough. In the embodiment of FIG. 64, a component 209 is located in the hole, which component can be a circular piece of soft magnetic material. Both the circular piece of soft magnetic material and the magnet 210 can be located in a housing 211. In an exemplary embodiment, the module 251 is held to the top housing wall 92 of the external component 207 via a magnetic attraction between the magnet 210 and the component 208. That said, in an alternate embodiment, the module 251 is coupled to the external component 207 via a snap coupling or the like.

In an exemplary embodiment, component 208 combined with component 209 channels the magnetic flux generated by the implanted magnet 123 and the magnet 210 so as to result in a retention force between the external component assembly 2141 and the implanted magnet 123 that is greater than that which would be the case if the component 205 and/or the component 209 was replaced with its equivalent weight with permanent magnet(s). In an exemplary embodiment, the increased retention force is more than about 1%, 2, 3, 4, 5, 6, 7, 8, 9, 10, 12, 14, 16, 18, 20, 22, 24, 26, 28, 30, 35, 40, 45, 50, 55, 60, 65, 70, 75, 80, 85, or 90% or more, or any value or range of values therebetween in 0.1% increments (e.g., 23.5% to 44.1%, more than 33.3%, etc.).

To be clear, in the exemplary embodiment of FIG. 64, the central magnet of the button sound processor has been replaced by a high saturation soft magnetic component, such as by way of example only cobalt-iron (which is an example of a soft magnetic material that can be utilized with respect to any of the non-permanent magnet magnetic materials detailed herein). Here, the magnetic flux from the magnets in the module 251 is concentrated so as to have a higher flux density below the button sound processor, which higher flux density interacts with the magnet implanted in the recipient, thus increasing the retention force. In an exemplary embodiment, the cobalt-iron component is a 50-50 combination of the two materials, and has a saturation flux density of 2.4 T. In an exemplary embodiment, the magnet 210 is a neodymium magnet, and has a flux density less than 1.4 T. It is also noted that while the embodiment of FIG. 64 has been presented in terms of utilizing a single doughnut magnet, in an alternative embodiment, two or more magnets can be utilized. Note also while the embodiment of FIG. 64 is presented in terms of using a single component 205 and a single component 209, in an alternative embodiment, multiple components can be respectively utilized.

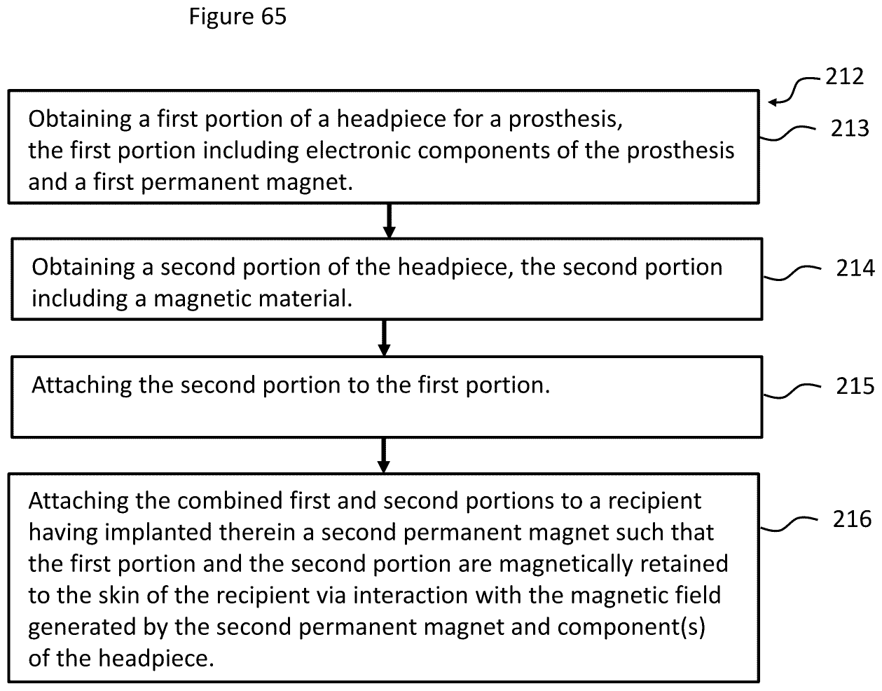

In view of the above, it is to be understood that there are methods associated with the teachings herein. In this regard, by way of example only and not by way of limitation, FIG. 65 presents an exemplary flowchart for an exemplary method, method 212. Method 212 includes method action 213, which includes obtaining a first portion of a headpiece for a prosthesis, the first portion including electronic components of the prosthesis and a first permanent magnet. By way of example only and not by way of limitation, this can correspond to obtaining the external component 89 detailed above. Method 212 further includes method action 214, which includes obtaining a second portion of the headpiece, the second portion including a magnetic material. By way of example only and not by way of limitation, this can include obtaining any of the second components that have been detailed herein as being attachable to the external component 89 or variations of the external component 89. Method 212 also includes method action 215, which includes attaching the second portion to the first portion. In an exemplary embodiment, this can entail obtaining the module 114 and screwing the module 114 onto the external component 89 where the external component 89 has outer threads that interact with the inner threads of the module 114. In an exemplary embodiment, this can entail snapping module 114 on to the housing of the external component 89. Still further, in an exemplary embodiment where there is a central magnet in or as part of the second component (or the second component is in its entirety a permanent magnet), this can entail placing the magnet against the external component 89 such that the magnetic fields of the magnet of the external component 89 and the magnet of the second component interact to hold the second component to the external component 89.

Method 212 further includes method action 216, which includes attaching the combined first and second portions to a recipient having implanted therein a second permanent magnet such that the first portion and the second portion are magnetically retained to the skin of the recipient via interaction with the magnetic field generated by the second permanent magnet and component(s) of the headpiece (where the components can include a permanent magnet and the second component or a piece of magnetic material that is not a permanent magnet in the second component). In an exemplary embodiment of method 212, the magnetic material of the second component alters the magnetic flux established by the second permanent magnet such that the magnetic flux is widened about a longitudinal axis between the second permanent magnet and the first portion relative to that which would be the case in the absence of the second portion. In this regard, in an exemplary embodiment, this feature can be achieved via the use of, for example, the module 114 as the second component, which has the magnets 120 outboard of the permanent magnet 99. Such can also be achieved by way of example by the utilization of module 195 as the second component, which has the magnetic components 196 outboard of the magnet 99. Note also that in an exemplary embodiment, the second component can be limited to component 197. That is, the embodiment of FIG. 60 can be practiced without the magnetic components 196 flanking the permanent magnet 99. Still further, in embodiments where the second component includes a permanent magnet, depending on the arrangement of the second component, even a centered magnet can result in the widening of the magnetic field. Such might be the case with respect to the embodiment of FIG. 59. The embodiments of FIGS. 24, 25 and 26 can also potentially achieve the aforementioned widening.

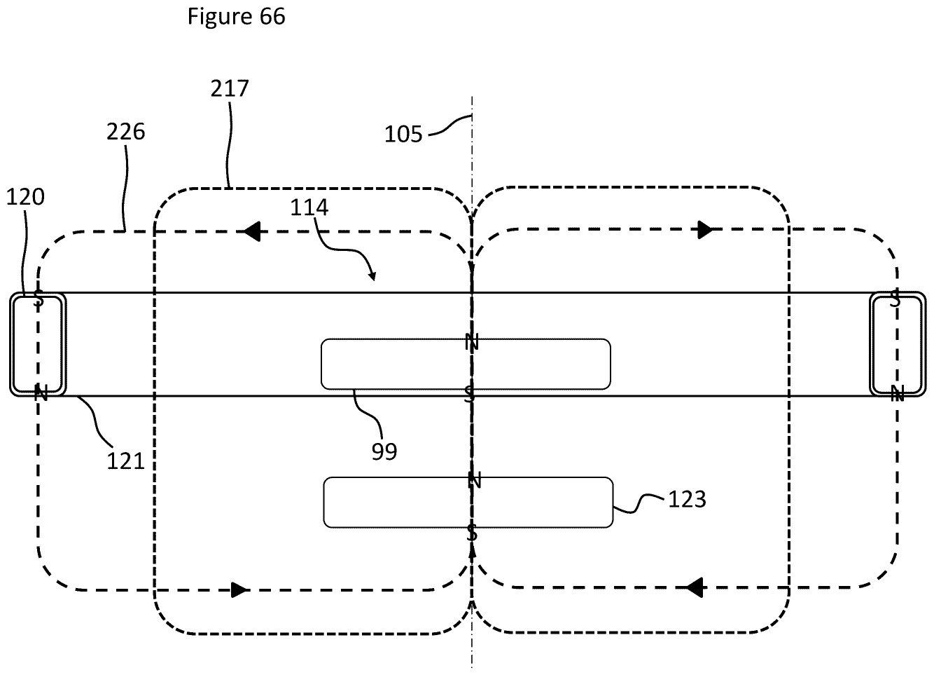

FIG. 66 depicts by way of conceptual schematic how the module 114 widens the magnetic flux. FIG. 66 is a duplication of the schematic of FIG. 16, with, superimposed thereon, the magnetic flux 217 that would exist in the absence of the module 114. As can be seen, the width of flux 226, the flux that results from the addition of magnet(s) 120, about the longitudinal axis of the magnetic flux, is now wider than that which was previously the case. The flux 226 is also shorter relative to flux 217, as can be seen. It is also noted that in an exemplary embodiment, the width of an imaginary cylinder centered about the longitudinal axis 105 in which X % of the magnetic flux of the total system lies is less than that which is the case without the module 114. In an exemplary embodiment, X is 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99%, or 100%. In an exemplary embodiment, the width is Y percent greater when the module 114 is present, where Y is 1%, 2%, 3%, 4%, 5%, 6%, 7%, 8%, 9%, 10%, 15%, 20%, 25%, 30%, 35%, 40%, 45%, 50%, 55%, 60%, 65%, 70%, or 75%.

As can be seen in FIG. 66, it is also noted that the magnetic flux is shortened with respect to the longitudinal axis 105. In this regard, in an exemplary embodiment, the magnetic material of the second component of the method 212 alters the magnetic flux established by the second permanent magnet such that the magnetic flux is shortened with respect to the longitudinal axis relative to that which would be the case in the absence of the second portion. In an exemplary embodiment, the distance between two imaginary planes normal to the longitudinal axis 105 between which X % of the magnetic flux of the total system lies greater than that which is the case when the module 114 is present. In an exemplary embodiment, the distance between the two imaginary planes is Y percent less when the module 114 is present.

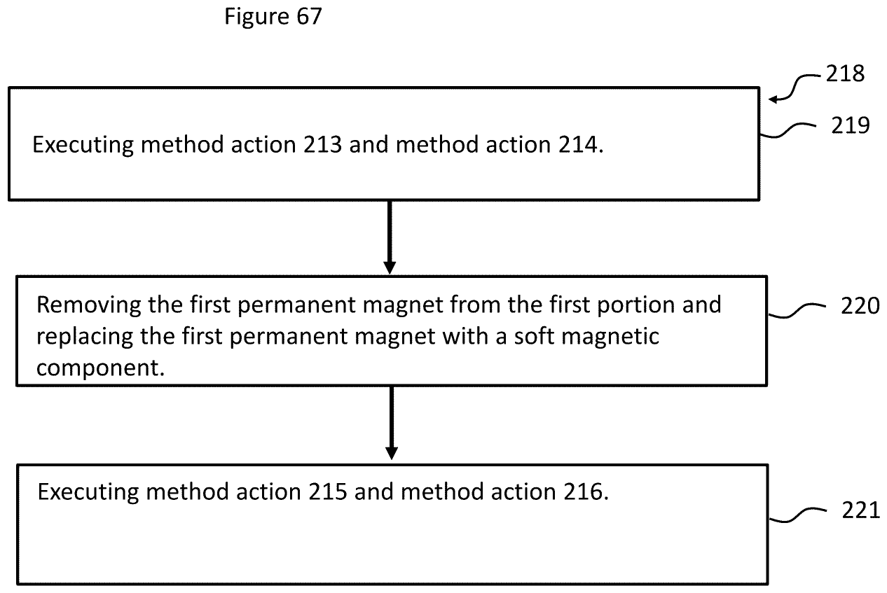

FIG. 67 presents an exemplary flowchart for another exemplary method, method 2500. Method 218 includes method action 219, which includes executing method action 213 and method action 214. Method 218 further includes method action 220, which includes removing the first permanent magnet from the first portion of the headpiece and replacing the first permanent magnet with a soft magnetic component. In an exemplary embodiment, this entails obtaining an external component 89 or a device similar thereto, and removing the second sub-component 97, and replacing that with a sub-component that does not include a permanent magnet, but instead includes a component made of soft magnetic material, such as the sub-component 251 of FIG. 64. Method 2500 further includes method 221, which includes executing method action 215 and method action 216.

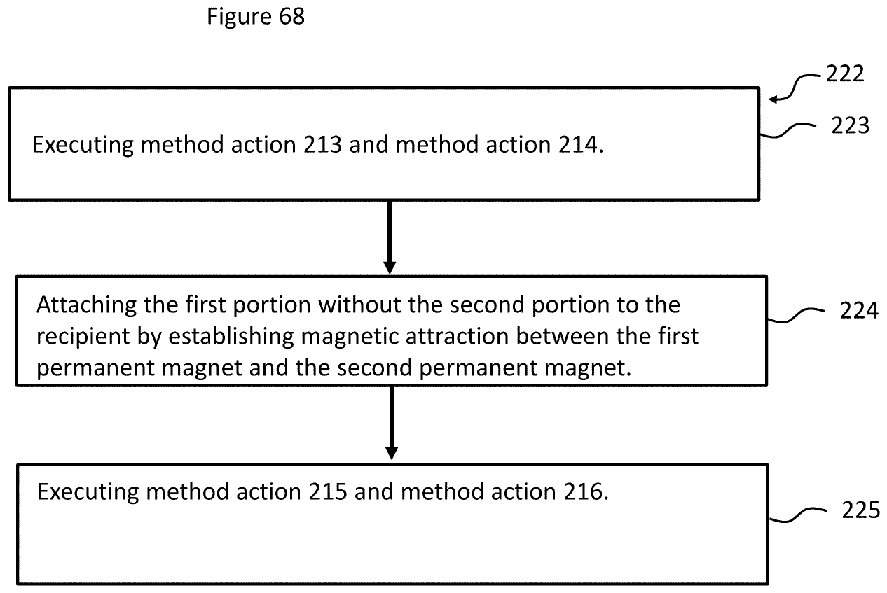

FIG. 68 presents a flowchart representing another exemplary method, method 222. Method 222 includes method action 223, which, as noted above, entails executing method action 213 and method action 214. Method 222 further includes method action 224, which includes attaching the first portion without the second portion to the recipient by establishing magnetic attraction between the first permanent magnet and the second permanent magnet. In an exemplary embodiment, method action 224 is executed to evaluate whether or not the first portion (e.g., external component 89 with permanent magnet 99), or more accurately, the magnet thereof, is sufficient to hold the first portion to the recipient, where a determination is made that additional retention force is utilitarian. In an exemplary embodiment, method action 224 represents the use of the button sound processor for a period of time by the recipient prior to the need for additional retention force (e.g., due to a physiological change of the recipient, due to a change in the habits of the recipient, etc.). Method 222 further includes method action 225, which, as noted above, entails executing method action 215 in method action 216.

In an exemplary embodiment, method action 213, the action of obtaining the first portion includes obtaining the first portion with a third portion attached thereto, the third portion being a cover of the headpiece covering a substantial portion of the first portion. In an exemplary embodiment, this can correspond to the housing wall 188 of FIG. 57 or FIG. 59. In this exemplary embodiment, any of the aforementioned methods or below methods further comprise removing the third portion from the first portion and replacing the third portion with the second portion, wherein the second portion covers a substantial portion of the first portion. This is the case with respect to the configuration of FIG. 63. Here, the magnetic material covers at least a portion of the substantial portion of the first portion covered by the second portion. In an exemplary embodiment, the magnetic material covers at least a substantial portion of the substantial portion of the first portion covered by the second portion. In FIG. 63, the magnetic material covers all of the portion of the first portion covered by the second portion. That said, in some embodiments, the magnetic material is such that it only partially covers the substantial portion of the first portion covered by the second portion, such as is the case when soft magnetic material is utilized as specific conduits to the outboard magnets. For example, in an exemplary embodiment where only two bar magnets are utilized, each located on opposite sides of the external component, the soft magnetic material that extends between the two magnets does not cover the entire opening of the housing, but instead constitutes an elongate body extending from one magnet to the other still, irrespective of the configuration of the soft magnetic material, in an exemplary embodiment, the second portion covers all of the first portion. In an exemplary embodiment, the second portion covers all that was covered by the removed third portion.

As noted above, in some embodiments, the module 114 or 125 is such that the permanent magnet thereof, when used with the external component 89, is configured such that the permanent magnet of the module is misaligned with the implanted magnet 123 when the external component interacts with the magnetic field of the implanted magnet. That is, the magnet of the module 114 or 125 does not mirror the implant magnet. In some embodiments, the base magnet 99 is angularly symmetric (symmetric about the longitudinal axis 105), and the implant magnet 123 is also angularly symmetric. In such embodiments, the symmetry axis for the implanted and external magnets would align (as shown in the figures-alignment with axis 105). If the module magnet, e.g. 120, is also angular symmetric, the symmetry axis of this magnet would also align with the symmetry axes of the other magnets and the external component 89 would stay on the same spot on the head when the module is attached. However, as noted above, in some exemplary embodiments, the retention module added to the external component 89 may not be angularly symmetric, or, more specifically, the magnet(s) thereof may not be angularly symmetric. For example, such might be the case with respect to a retention module that has an opening, such as that for a battery door or for a cable to another component of the prosthesis or an opening, e.g. to provide access to a battery door.

It is noted that consistent with the teachings detailed above, with respect to some of the aforementioned methods, the magnetic material alters the magnetic flux established by the second permanent magnet such that the magnetic flux is concentrated and channeled at an oblique angle away from the longitudinal axis at a skin interfacing location relative to that which would be the case in the absence of the second portion. By skin interfacing location, it is meant the location where the magnetic flux enters (or exits) the skin. It is also noted that in an exemplary embodiment, an increase in retention force between the combined first and second portions and the second permanent magnet above that which is the case between only the first portion and the second permanent magnet is higher than the weight of the second portion. By way of example only and not by way of limitation, if the retention force of the external component 89 to the skin of the recipient is A Newtons without the module 114, and with the module, it is A+B Newtons, B is greater than the weight of module 114. Note that this is just an example to illustrate the concept. It is quite possible that B will be less than the weight of module 114. However, this could be the case (B is greater than the weight of the second portion) with respect to at least some of the embodiments detailed herein (e.g., the embodiment of FIG. 60, where component 1860 weighs B Newtons, and the increase in retention force is B+C Newtons). In an exemplary embodiment, C is greater than 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 110%, 125%, 150%, or 200% or more of B.

The external component can be any of the external components described in U.S. patent application Ser. No. 15/166,628 filed on May 27, 2016, to inventor Tad Jurkiewicz, entitled Magnet Positioning System, as modified if such has utilitarian value to be practiced with the teachings detailed herein. In an exemplary embodiment, the external component's detailed herein and variations thereof have any or all of the features of the external component described in the aforementioned patent application. Accordingly, this application constitutes a disclosure of one or more embodiments where any one or more teachings herein is combined with any one or more teachings in that patent application.

It is briefly noted that in some embodiments that utilize the two modules, the first module includes a first permanent magnet and the second module includes a second permanent magnet, the second permanent magnet being a different configuration than the first permanent magnet. By different configuration, it is meant that, for example, one magnet is a disk magnet, and another magnet is a bar magnet, or one magnet is a disk magnet, and another magnet is a ring magnet, etc. This as opposed to merely a different size.

In an exemplary embodiment, the height of the external component assembly (distance along the longitudinal axis) is no more than 3, 4, 5, 6, 7, 8, 9, 10, 11, 12, 13, 14 or 15 cm or any value or range of values therebetween in 0.1 cm increments, and a retention force for a given scenario (e.g., given skin flap thickness and given implanted magnet) can be increased at least about 10%, 15%, 20%, 25%, 30%, 35%, 40%, 45%, 50%, 55%, 60%, 65%, 70%, 75%, 80%, 85%, 90%, 95%, or 100% or more or any value or range of values therebetween in 0.1% increments, via the addition of the second component, without increasing the height of the external component from that which was the case prior to the increase, all other things being equal. In an exemplary embodiment, the teachings detailed herein are used without the additional module/with the ordinary external component 89, with skin flap thicknesses of less than 5, 6, 7, 8, 9, 10, 11, 12, 13, 14, or 15 mm and the additional module is used/the external component 89 is modified according to the teachings herein for skin values greater than one or more of those values, such as values that are 10%, 15%, 20%, 25%, 30%, 35%, 40%, 45%, 50%, 55%, 60%, 65%, 70%, 75% greater than the baseline skin flap thickness (one of the aforementioned thicknesses).

In an exemplary embodiment, a retention force is increased from about 400 mN to about 700 mN utilizing the second component, or from about 450 mN to about 680 mN, or from about 480 mN to about 680 nM. The increase can be from 200 mN to any value thereabove to about 1.5 mN or any range of values therebetween in 0.1 mN increments.

It is noted that any disclosure of a device and/or system herein corresponds to a disclosure of a method of utilizing such device and/or system. It is further noted that any disclosure of a device and/or system herein corresponds to a disclosure of a method of manufacturing such device and/or system. It is further noted that any disclosure of a method action detailed herein corresponds to a disclosure of a device and/or system for executing that method action/a device and/or system having such functionality corresponding to the method action. It is also noted that any disclosure of a functionality of a device herein corresponds to a method including a method action corresponding to such functionality. Also, any disclosure of any manufacturing methods detailed herein corresponds to a disclosure of a device and/or system resulting from such manufacturing methods and/or a disclosure of a method of utilizing the resulting device and/or system.

In an exemplary embodiment, there is an external component of a prosthesis, comprising: a first module including a functional component and first structure including magnetic material, wherein the first module is configured to be retained against skin of a recipient via a magnetic field at least partially generated by a permanent magnet implanted in a recipient that interacts with the magnetic material of the first structure, the first module including a skin interfacing surface configured to interact with skin of the recipient when the first module is retained against the skin of the recipient; and a second module including a second structure including magnetic material configured to enhance magnetic retention of the external component to skin of a recipient, wherein the second module is removably attached to the first module and visible from an outside of the external component when the second module is attached to the first module and when viewed from a side opposite the skin interfacing side. In an exemplary embodiment, there is an external component of a prosthesis as detailed above and/or below, wherein the first module includes a first permanent magnet and the second module includes a second permanent magnet, the second permanent magnet being a different configuration than the first permanent magnet. In an exemplary embodiment, there is an external component of a prosthesis as detailed above and/or below, wherein the second module includes a second permanent magnet being made at least in part of the magnetic material, wherein the external component is configured such that the second permanent magnet is misaligned with an implanted magnet when the external component interacts with the magnetic field of the implanted magnet.

In an exemplary embodiment, there is a button sound processor, comprising: a first component including a first permanent magnet; and a second component including magnetic material, wherein the second component is configured to direct a magnetic flux at least partially generated by the first permanent magnet differently from that which would exist in the absence of the second component via the soft magnetic material. In an exemplary embodiment, there is a button sound processor as described above and/or below, wherein the magnetic material is in the form of a structure extending outboard from the first permanent magnet. In an exemplary embodiment, there is a button sound processor as described above and/or below, wherein the soft magnetic plate is a cover of the external component facing away from a skin interfacing side of the external component. In an exemplary embodiment, there is a button sound processor as described above and/or below, wherein the second component includes a second permanent magnet; and the longitudinal axis of the button sound processor extends through the first permanent magnet and not the second permanent magnet.

In an exemplary embodiment, there is a body piece configured for transcutaneous communication with an implanted component implanted in a recipient, comprising: an inductance coil; a first permanent magnet; and a second permanent magnet, wherein the first permanent magnet has a north-south polarity that is parallel to a longitudinal axis of the body piece, the second permanent magnet has a north-south polarity at an oblique angle relative to the north-south polarity of the first permanent magnet, and the body piece is configured such that the second permanent magnet is readily removably connected at least indirectly to the first permanent magnet. In an exemplary embodiment, there is a body piece configured for transcutaneous communication with an implanted component implanted in a recipient as described above and/or below wherein the body piece includes a structure made up of soft magnetic material extending between the first permanent magnet and the second permanent magnet. In an exemplary embodiment, there is a body piece configured for transcutaneous communication with an implanted component implanted in a recipient as described above and/or below wherein the portion of the structure between the first permanent magnet and the second permanent magnet being angled relative to the longitudinal axis at an oblique angle. In an exemplary embodiment, there is a body piece configured for transcutaneous communication with an implanted component implanted in a recipient as described above and/or below wherein an angle between (i) the portion of the structure between the first permanent magnet and the second permanent magnet and (ii) the north-south axis of the second permanent magnet is oblique.

Unless otherwise specified or otherwise not enabled by the art, any one or more teachings detailed herein with respect to one embodiment can be combined with one or more teachings of any other teaching detailed herein with respect to other embodiments.

While various embodiments have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An apparatus, comprising:
a first permanent magnet arrangement; and
a second permanent magnet arrangement, wherein
the first permanent magnet arrangement includes a first magnet and a second magnet abutting the first magnet,
the second permanent magnet arrangement is a permanent magnet that has a north-south axis that is parallel to a north-south axis of the first magnet and a north-south axis of the second magnet of the first permanent magnet arrangement and the permanent magnet of the second permanent arrangement is offset from the first magnet and the second magnet, the north-south axis of the first magnet and the north-south axis of the second magnet being fixed relative to one another, and
the apparatus is a medical device.

2. The apparatus of claim 1, further including a third permanent magnet arrangement that has a north-south axis that is parallel to the longitudinal axis.

3. The apparatus of claim 1, wherein the first permanent magnet and the second permanent magnet abut one another.

4. The apparatus of claim 1, wherein the first permanent magnet and the second permanent magnet are half circle magnets.

5. The apparatus of claim 1, wherein the north-south axis of the first permanent magnet arrangement is non-angled.

6. The system of claim 1, wherein:
the apparatus is a component of a hearing prosthesis.

7. A system, comprising the apparatus of claim 1, and an implantable component, wherein the implantable component includes two magnets.

8. The apparatus of claim 1, wherein the first permanent magnet is located directly above the second permanent magnet and abuts the second permanent magnet.

9. The system of claim 1, wherein:
the apparatus is an external component of a hearing prosthesis.

10. The apparatus of claim 9, wherein the second permanent magnet arrangement is a monolithic cylinder magnet, wherein the first permanent magnet arrangement is a cylinder magnet, and wherein the first permanent magnet arrangement is centrally located in the external component with respect to lateral location, and wherein the second permanent magnet arrangement is offset from the first permanent magnet with respect to lateral location.

11. An apparatus, comprising:
a first component including a first permanent magnet; and
a second component including a second permanent magnet, wherein
the second component is configured to direct a magnetic field at least partially generated by the first permanent magnet differently from that which would exist in the absence of the second component via the second permanent magnet,
the second permanent magnet is a cylindrical magnet arrangement,
the apparatus is a medical device, and
a longitudinal axis of the second permanent magnet is normal to a skin surface of a human recipient of the apparatus when the apparatus is used with the human recipient.

12. The apparatus of claim 11, wherein:
the first permanent magnet is a straight pole magnet;
the second permanent magnet is an angled pole magnet; and
the second component includes a third permanent magnet that is an angled pole magnet.

13. The apparatus of claim 11, wherein:
the second component includes a plate made at least in part of magnetic material.

14. The apparatus of claim 11, wherein:
the apparatus includes only cylindrical magnet arrangements.

15. The apparatus of claim 11, wherein:
the second component includes a third permanent magnet and a fourth permanent magnet, the third permanent magnet and the fourth permanent magnet being cylindrical arrangements.

16. The apparatus of claim 11, wherein:
the second component is devoid of any permanent magnets.

17. A system, comprising:
an external component including a magnet arrangement; and
an implantable component including a magnet arrangement, wherein
a resulting magnetic field path lying on a plane normal to a boundary of the magnet arrangement of the external component that faces the magnet arrangement of the implantable component when the external component is used with the implantable component and passes through the magnet arrangement of the implantable component is asymmetric, and
the magnet arrangement of the implantable component has a plurality of north-south polarities that are fixed relative to one another.

18. The system of claim 17, wherein:
the asymmetricalness of the magnetic field path is due at least in part to the use of angled poles of one or more magnets of the magnet arrangements.

19. The system of claim 17, wherein:
the external component includes a first sub-component and a second sub-component, the first sub-component including a first sub-magnet arrangement of the magnet arrangement of the external component, and the second sub-component includes a second sub-magnet arrangement of the magnet arrangement of the external component; and
the system is configured so that if the second sub-component is removed from the system, a resulting magnetic field path lying on the plane is symmetric.

20. The system of claim 19, wherein:
the second sub-component includes a first magnet and a second magnet spaced away from the first magnet;
the second sub-component includes a yoke extending from the first magnet to the second magnet; and
the second sub-component is configured so that the yoke extends across and over the first sub-magnet arrangement when the second sub-component is fitted onto the first sub-component.

21. The system of claim 20, wherein:
the yoke directly contacts the first magnet and the second magnet and the first sub-magnet arrangement when the second sub-component is fitted onto the first sub-component.

22. The system of claim 20, wherein:
the yoke directly contacts the first magnet and the second magnet but not the first sub-magnet arrangement when the second sub-component is fitted onto the first sub-component.
